(19) United States
(12) Patent Application Publication
(10) Pub. No.: US 2025/0296522 A1
(43) Pub. Date: Sep. 25, 2025

(54) SELECTIVELY CONFIGURABLE BLAST ATTENUATION AND PULLDOWN ARRANGEMENT FOR A MOTOR VEHICLE SEAT

(71) Applicant: Indiana Mills & Manufacturing, Inc., Westfield, IN (US)

(72) Inventors: Garrett James Leckliter, Noblesville, IN (US); Chris P. Jessup, Sheridan, IN (US); Douglas W. Bittner, Indianapolis, IN (US); Nathan Andrew BEADLE, Westfield, IN (US)

(21) Appl. No.: 19/088,262

(22) Filed: Mar. 24, 2025

Related U.S. Application Data
(60) Provisional application No. 63/568,917, filed on Mar. 22, 2024.

(51) Int. Cl. B60R 21/02; B60N 2/005; B60N 2/16

(52) U.S. Cl. CPC B60R 21/026; B60N 2/005; B60N 2/1665; B60R 2021/0266

(57) ABSTRACT

A seat base for mounting a vehicle seat to a floor of a motor vehicle includes a top member configured to be coupled to the vehicle seat, a bottom member configured to be coupled to the floor of the motor vehicle, at least one blast attenuation structure coupled to and between the top and bottom members and configured to be responsive to an under-vehicle explosion to deform and collapse at least one of the top and bottom members toward the other, a seat pulldown device configured to be responsive to an activation signal to apply a force to the top member in a direction toward the bottom member, and means responsive to the force applied by the seat pulldown device to disable or bypass the at least one blast attenuation structure so that the force applied by the seat pulldown device pulls the top member toward the bottom member.

### CROSS-REFERENCE TO RELATED APPLICATION

This patent application claims the benefit of, and priority to, U.S. Provisional Patent Application No. 63/568,917, filed Mar. 22, 2024, the disclosure of which is expressly incorporated herein by reference in its entirety.

### FIELD OF THE DISCLOSURE

This disclosure relates generally to arrangements for mounting occupant seats in motor vehicles, and more specifically to such arrangements which are configured to provide for blast attenuation during an explosion event and to be selectively reconfigured to provide for seat pulldown during rollover and/or other vehicle impact events.

### BACKGROUND

So-called “blast boxes” are typically mounted in motor vehicles between the vehicle floor and the vehicle seats, and are generally configured to absorb energy resulting from under-vehicle explosions to thereby attenuate and mitigate the effects of such explosions on the occupants of such seats. Conventional seat pulldown devices are typically used with motor vehicle suspension seats, and are generally configured to be responsive to a triggering event, such as a rollover and/or impact of the vehicle, to pull the seat downwardly to the floor of the motor vehicle.

### SUMMARY

The present invention may comprise one or more of the features recited in the attached claims, and/or one or more of the following features and combinations thereof. In a first aspect, a seat base for mounting a vehicle seat to a floor of a motor vehicle may comprise a top member or frame assembly configured to be coupled directly or indirectly to the vehicle seat, a bottom member or frame assembly configured to be coupled directly or indirectly to the floor of the motor vehicle, at least one blast attenuation structure coupled to and between the top and bottom members or frame assemblies, the at least one blast attenuation structure configured to be responsive to an under-vehicle explosion to deform and collapse at least one of the top and bottom members or frame assemblies toward the other, a seat pulldown device configured to be responsive to an activation signal to apply a force to the top member or frame assembly in a direction toward the bottom member or frame assembly, and means responsive to the force applied by the seat pulldown device to disable or bypass the at least one blast attenuation structure so that the force applied by the seat pulldown device pulls the top member or frame assembly toward the bottom member or frame assembly.

A second aspect includes the features of the first aspect, and wherein the at least one blast attenuation structure comprises two or more blast attenuation structures.

A third aspect includes the features of the first or the second aspect, and wherein the seat pulldown device comprises at least one actuator, and at least one web or tether having one end secured to the top member or frame assembly, and an opposite end secured to at least one of the at least one actuator and the bottom member or frame assembly, wherein the at least one actuator is responsive to the activation signal to cause the at least one web or tether to apply the force of the seat pulldown device.

A fourth aspect includes the features of any of the first through third aspects, and further comprising means for producing the activation signal.

A fifth aspect includes the features of the fourth aspect, and further comprising at least one sensor mounted to the motor vehicle, wherein the means for producing the activation signal is configured to responsive to a sensor signal produced by the at least one sensor to produce the activation signal.

A sixth aspect includes the features of any of the first through fifth aspects, and wherein the vehicle seat includes a height adjustment assembly configured to be responsive to manual actuation to fix a height of the top member or frame assembly relative to the bottom member or frame assembly, and wherein the means responsive to the force applied by the seat pulldown device to disable or bypass the at least one blast attenuation structure is applied to disengage the height adjustment assembly so that the top member or frame assembly is movable toward the bottom member or frame assembly.

In a seventh aspect, a seat base for mounting a vehicle seat to a floor of a motor vehicle may comprise a top frame assembly configured to be coupled directly or indirectly to the vehicle seat, a bottom frame assembly configured to be coupled directly or indirectly to the floor of the motor vehicle, at least one blast attenuation structure coupled to and between the top and bottom frame assemblies, the at least one blast attenuation structure configured to be responsive to an under-vehicle explosion to deform and collapse at least one of the top and bottom frame assemblies toward the other, at least one web or tether having one end secured to the top frame assembly and an opposite end secured to the bottom frame assembly, an actuator configured to be responsive to an activation signal to apply a force to the at least one web or tether between the one end and the opposite end of the at least one web or tether, and a control assembly responsive to the force applied by the actuator to disable or bypass the at least one blast attenuation structure so that the force applied by the actuator to the at least one web or tether pulls the top frame assembly toward the bottom frame assembly.

An eighth aspect includes the features of the seventh aspect, and further comprising means for producing the activation signal.

A ninth aspect includes the features of the seventh aspect or the eighth aspect, and further comprising at least one sensor mounted to the motor vehicle, wherein the means for producing the activation signal is configured to responsive to a sensor signal produced by the at least one sensor to produce the activation signal.

A tenth aspect includes the features of any of the seventh through ninth aspects, and wherein the actuator is a linear actuator.

An eleventh aspect includes the features of any of the seventh through tenth aspects, and wherein the actuator is a pyrotechnic actuator.

A twelfth aspect includes the features of any of the seventh through eleventh aspects, and wherein the actuator comprises a piston responsive to the activation signal to move along a linear path and apply the force to the at least one web or tether, and wherein control assembly comprises an actuator sleeve movable with the piston, and at least one movable frame component operatively coupled to the actuator sleeve, and wherein, in an absence of the activation signal, the actuator sleeve positions the at least one movable frame component to enable the at least one blast attenuation structure to be responsive to an under-vehicle explosion to deform and collapse at least one of the top and bottom frame assemblies toward the other, and wherein, upon movement of the piston in response to the activation signal, the actuator sleeve positions the at least one movable frame component to disable or bypass the at least one blast attenuation structure so that the force applied by the actuator to the at least one web or tether pulls the top frame assembly toward the bottom frame assembly.

A thirteenth aspect includes the features of the twelfth aspect, and wherein, in the absence of the activation signal, the actuator sleeve positions the at least one movable frame component to engage the at least one blast attenuation structure, and wherein, upon movement of the piston in response to the activation signal, the actuator sleeve disengages the at least one movable frame component from the at least one blast attenuation structure.

A fourteenth aspect includes the features of any of the seventh through thirteenth aspects, and further comprising scissor arms operatively coupled to and between the top frame assembly and the bottom frame assembly, the scissor arms actuatable to raise and lower the top frame assembly relative to the bottom frame assembly.

A fifteenth aspect includes the features of the fourteenth aspect, and wherein the seat base is operable in a blast attenuation mode in which the scissor arms engage the at least one blast attenuation structure to allow the at least one blast attenuation structure to be responsive to an under-vehicle explosion to deform and collapse at least one of the top and bottom frame assemblies toward the other, and wherein the seat base is operable in a seat pulldown mode in which the scissor arms disengage the at least one blast attenuation structure to disable or bypass the at least one blast attenuation structure so that the force applied by the actuator to the at least one web or tether pulls the top frame assembly toward the bottom frame assembly.

A sixteenth aspect includes the features of any of the seventh through eleventh aspects, and wherein the actuator comprises a piston responsive to the activation signal to move along a linear path and apply the force to the at least one web or tether, and wherein the vehicle seat includes a height adjustment assembly configured to be responsive to manual actuation to fix a height of the top frame assembly relative to the bottom frame assembly, and wherein control assembly comprises a height adjustment release lever movable with the piston, and wherein, in an absence of the activation signal, height adjustment assembly maintains the height of the top frame assembly fixed relative to the bottom frame assembly so as to enable the at least one blast attenuation structure to be responsive to an under-vehicle explosion to deform and collapse at least one of the top and bottom frame assemblies toward the other, and wherein, upon movement of the piston in response to the activation signal, the height adjustment release lever disengages the height adjustment assembly so that the top frame assembly is movable toward the bottom frame assembly under the force applied by the actuator to the at least one web or tether.

A seventeenth aspect includes the features of the sixteenth aspect, and wherein the actuator is a pyrotechnic actuator.

An eighteenth aspect includes the features of the sixteenth aspect or the seventeenth aspect, and further comprising scissor arms operatively coupled to and between the top frame assembly and the bottom frame assembly, the scissor arms actuatable to raise and lower the top frame assembly relative to the bottom frame assembly.

A nineteenth aspect includes the features of the eighteenth aspect, and wherein the at least one blast attenuation structure is incorporated into the scissor arms.

A twentieth aspect includes the features of the nineteenth aspect, and wherein the seat base is operable in a blast attenuation mode in which the height adjustment assembly fixes the height of the top frame assembly relative to the bottom frame assembly to allow the at least one blast attenuation structure incorporated into the scissor arms to be responsive to an under-vehicle explosion to deform and collapse at least one of the top and bottom frame assemblies toward the other, and wherein the seat base is operable in a seat pulldown mode in which the height adjustment assembly is disengaged to thereby disable or bypass the at least one blast attenuation structure incorporated into the scissor arms such that the force applied by the actuator to the at least one web or tether collapses the scissor arms and pulls the top frame assembly toward the bottom frame assembly.

### BRIEF DESCRIPTION OF THE DRAWINGS

FIG. 1 is a simplified diagram of an embodiment of an occupant restraint system for a motor vehicle seat including a seat mounting arrangement that is selectively operable in a blast attenuation mode or a seat pulldown mode.

FIG. 2 is a simplified diagram of another embodiment of an occupant restraint system for a motor vehicle seat also including a seat mounting arrangement that is selectively operable in a blast attenuation mode or a seat pulldown mode.

FIG. 3A is a front perspective view of an embodiment of the seat base illustrated in FIGS. 1 and 2, shown configured to operate in the blast attenuation mode.

FIG. 3B is a front elevational view of the seat base illustrated in FIG. 3A also shown configured to operate in the blast attenuation mode.

FIG. 3C is a cross-sectional view of the seat base of FIGS. 3A and 3B, as viewed along section lines A-A of FIG. 3B, also illustrating the seat base configured to operate in the blast attenuation mode.

FIG. 3D is a cross-sectional view of the seat base of FIGS. 3A-3C, as viewed along section lines B-B of FIG. 3B, also illustrating the seat base configured to operate in the blast attenuation mode.

FIG. 3E is a front elevational view of the seat base of FIGS. 3A-3D, illustrating the seat base configured to operate in the blast configuration mode and also illustrating by example two of the blast attenuators deformed and the seat base partially collapsed in response to an under-vehicle explosion.

FIG. 3F is a cross-sectional view similar to FIG. 3C and showing the seat base of FIGS. 3A-3E responsive to actuation of the seat pulldown device to reconfigure the seat base to operate in the seat pulldown mode.

FIG. 3G is a cross-sectional view similar to FIG. 3D and showing the seat base of FIGS. 3A-3F in the same state as FIG. 3F with the seat base reconfigured to operate in the seat pulldown mode.

FIG. 3H is a cross-sectional view similar to FIG. 3G and showing the seat base, operating in the seat pulldown mode, beginning to collapse in response to operation of the seat pulldown device.

FIG. 3I is a cross-sectional view similar to FIG. 3H and showing the seat base, operating in seat pulldown mode, fully collapsed in response to operation of the seat pulldown device.

FIG. 4A is a front elevational view of another embodiment of the seat base illustrated in FIGS. 1 and 2, shown configured to operate in the blast attenuation mode.

FIG. 4B is a cross-sectional view of the seat base of FIG. 4A, as viewed along section lines C-C of FIG. 4A, illustrating the seat base configured to operate in the blast attenuation mode.

FIG. 4C is a cross-sectional view of the seat base of FIGS. 4A and 4B, as viewed along section lines D-D of FIG. 4A, also illustrating the seat base configured to operate in the blast attenuation mode.

FIG. 4D is a cross-sectional view similar to FIG. 4C and showing the seat base of FIGS. 4A-4C responsive to actuation of the seat pulldown device to reconfigure the seat base to operate in the seat pulldown mode.

FIG. 4E is a cross-sectional view similar to FIG. 4B and showing the seat base, operating in the seat pulldown mode, beginning to collapse in response to operation of the seat pulldown device.

FIG. 5A is a front perspective view of yet another embodiment of the seat base of FIGS. 1 and 2, shown configured to operate in the blast attenuation mode.

FIG. 5B is a front elevational view of the seat base illustrated in FIG. 5A also shown configured to operate in the blast attenuation mode.

FIG. 5C is a front elevational view of the seat base of FIGS. 5A and 5B, illustrating the seat base configured to operate in the blast configuration mode and also illustrating by example the hinges deformed and the seat base partially collapsed in response to an under-vehicle explosion.

FIG. 5D is a front elevational view similar to FIG. 5B and showing the seat base of FIGS. 5A-5C responsive to actuation of the seat pulldown device to reconfigure the seat base to operate in the seat pulldown mode.

FIG. 5E is a front elevational view similar to FIG. 5D and showing the seat base, operating in seat pulldown mode, fully collapsed in response to operation of the seat pulldown device.

FIG. 6A is a is a front perspective view of a further embodiment of the seat base of FIGS. 1 and 2, shown configured to operate in the blast attenuation mode.

FIG. 6B is a top plan view of the seat base illustrated in FIG. 6A with the top plate removed to illustrate various features of the seat base as configured to operate in the blast attenuation mode.

FIG. 6C is a cross-sectional view of the seat base of FIGS. 6A and 6B, as viewed along section lines E-E of FIG. 6B, also illustrating the seat base configured to operate in the blast attenuation mode.

FIG. 6D is a cross-sectional view of the seat base of FIGS. 6A-6C, as viewed along section lines F-F of FIG. 6B, also illustrating the seat base configured to operate in the blast attenuation mode.

FIG. 6E is a cross-sectional view similar to FIG. 6D illustrating one of the blast attenuators deployed and the seat base collapsed in response to an under-vehicle explosion.

FIG. 6F is a cross-sectional view similar to FIG. 6E illustrating another embodiment of the blast attenuator shown deployed with the seat base collapsed in response to an under-vehicle explosion.

FIG. 6G is a top plan view similar to FIG. 6B with the top plate removed to illustrate various features of the seat base as reconfigured to operate in the seat pull down mode.

FIG. 6H is a cross-sectional view similar to FIG. 6C illustrating the seat base reconfigured to operate in the seat pull down mode.

FIG. 6I is a cross-sectional view similar to FIG. 6H illustrating the seat base collapsed by the seat pull down device operating in the seat pull down mode.

FIG. 6J is a cross-sectional view similar to FIG. 6I but with a portion of the guide rail cut away to show advancement of the guide rod along the channel formed in the ear of the top plate.

FIG. 7A is a front perspective view of yet another embodiment of the seat base illustrated in FIGS. 1 and 2, shown configured to operate in the blast attenuation mode.

FIG. 7B is a side elevational view of the seat base illustrated in FIG. 7A also shown configured to operate in the blast attenuation mode.

FIG. 7C is a front elevational view of the seat base illustrated in FIGS. 7A and 7B, shown in partial exploded view to show an embodiment of one of the blast attenuators.

FIG. 7D is a top, rear perspective view of the seat base illustrated in FIGS. 7A-7C, further illustrating the seat base configured to operate in the blast attenuation mode.

FIG. 7E is a cross-sectional view of the seat base of FIGS. 7A-7D, as viewed along section lines 7E,F-7E,F of FIG. 7C, also illustrating the seat base configured to operate in the blast attenuation mode and further illustrating an embodiment of a seat pulldown actuator for reconfiguring the seat base to operate in the seat pulldown mode.

FIG. 7F is a cross-sectional view of the seat base of FIGS. 7A-7E, as viewed along section lines 7E,F-7E,F of FIG. 7C, showing the seat base responsive to actuation of the seat pulldown device to reconfigure the seat base to operate in the seat pulldown mode, and showing the seat base fully collapsed in the seat pulldown mode.

FIG. 7G is a cross-sectional view of the seat base of FIGS. 7A-7F, as viewed along the section lines 7G-7G of FIG. 7C, illustrating the seat base fully collapsed as in FIG. 7F, and also illustrating reconfiguration of the seat base by the seat pulldown device to operate in the seat pulldown mode.

FIG. 7H is a magnified view of the circled portion 7H of FIG. 7G, illustrating a magnified view of reconfiguration of the seat base by the seat pulldown device to operate in the seat pulldown mode.

FIG. 7I is a top, rear perspective view of the seat base of FIGS. 7A-7H, further illustrating the seat base reconfigured to operate in the seat pulldown mode and illustrating the seat base fully collapsed as in FIGS. 7F-7H.

FIG. 7J is a side elevational and partial cutaway view of the seat base of FIGS. 7A-7I, illustrating deformation of the one of the blast attenuators and illustrating the seat base collapsed in response to an under-vehicle explosion.

FIG. 8A is a front perspective view of yet another embodiment of the seat base illustrated in FIGS. 1 and 2, shown configured to operate in the blast attenuation mode and shown with a seat pan and vehicle seat mounted thereto.

FIG. 8B is a front perspective view of the seat base of FIG. 8A shown without the seat pan and the vehicle seat.

FIG. 8C is a cross-sectional view of the seat base of FIGS. 8A and 8B as viewed along section lines 8C-8D-8C-8D of FIG. 8B, shown configured to operate in the blast attenuation mode.

FIG. 8D is a cross-sectional view of the seat base of FIGS. 8A-8C as viewed along section lines 8C-8D-8C-8D of FIG. 8B, shown being reconfigured to operate in the seat pulldown mode.

FIG. 8E is a cross-sectional view of the seat base of FIGS. 8A-8C as viewed along section lines 8E-8E of FIG. 8B, shown reconfigured to operate in seat pulldown mode and with the top seat frame assembly pulled down to the bottom seat frame assembly.

FIG. 8F is a side elevational view illustrating deformation of one of the scissor arms of the seat base of FIGS. 8A-8E in response to an under-vehicle explosion.

FIG. 8G is a side elevational view of the seat pan illustrated in FIG. 8A.

FIG. 8H is a side elevational view of the seat pan of FIG. 8G illustrating deformation of the seat pan in response to an under-vehicle explosion.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases may or may not necessarily refer to the same embodiment. Further, when a particular feature, structure or characteristic is described in connection with an embodiment, it is submitted that it is within the knowledge of one skilled in the art to effect such feature, structure or characteristic in connection with other embodiments whether or not explicitly described. Further still, it is contemplated that any single feature, structure or characteristic disclosed herein may be combined with any one or more other disclosed feature, structure or characteristic, whether or not explicitly described, and that no limitations on the types and/or number of such combinations should therefore be inferred.

This disclosure relates to devices and techniques for mounting occupant seats in motor vehicles which include a blast attenuation or mitigation mode, in which a blast attenuation structure positioned between the seat and the floor or frame of the motor vehicle is configured to absorb energy resulting from an under-vehicle explosion, and a seat pulldown mode, in which a seat pulldown device is configured to bypass or disable the blast attenuation structure and pull the occupant seat down to the floor or frame of the motor vehicle in response to a detected rollover and/or impact event of the motor vehicle. Referring now to FIG. 1, a simplified diagram is shown of an embodiment of an occupant restraint system 10 for a motor vehicle seat 12 including a seat mounting arrangement that is selectively operable in a blast attenuation mode or a seat pulldown mode. The motor vehicle seat 12 is illustratively conventional and includes a seat bottom 14 mounted to a seat frame 15, and a seat back 16 attached to and extending upwardly away from the seat bottom 14. The seat back 16 may be movably or non-movably mounted to the seat frame 15. In any case, a conventional web-based occupant restraint system 18 is operatively mounted to the vehicle seat 12, the seat frame 15, to a floor F of the motor vehicle and/or to one or more frame components or other structures of or within the motor vehicle. The seat bottom 14 and seat back 16 are together configured to support an occupant seated in the vehicle seat 12, and the vehicle seat 12 may therefore be referred to herein as an “occupant seat.” Illustratively, the motor vehicle is a joint light tactical vehicle (JLTV), although this disclosure contemplates embodiments in which the motor vehicle may be any conventional motor vehicle.

The vehicle seat mounting arrangement is illustratively provided in the form of a seat base 20 positioned between the seat frame 15 and the floor F of the motor vehicle, and mounted in a conventional manner to each of the seat frame 15 and the floor F to thereby secure the vehicle seat bottom 14 and seat back 16 to the motor vehicle. The seat base 20 illustratively includes a blast attenuation structure, operable in a blast attenuation or mitigation mode of the seat base 20 to absorb energy resulting from an under-vehicle explosion, and one or more mechanisms which may be selectively triggered or activated in a seat pulldown mode of the seat base 20 to bypass or disable the blast attenuation structure and allow the seat base 20 to collapse to, or otherwise be lowered to, the floor F of the motor vehicle in response to a detected vehicle rollover and/or impact event. Example embodiments of the seat base 20 are illustrated in the attached figures, and will be described in detail below.

The occupant restraint system 10 further illustratively includes a conventional seat pulldown device 22 operatively mounted to the seat frame 15 and configured to be responsive to an activation signal to pull the seat 12 down toward the floor F of the motor vehicle. In the illustrated embodiment, the seat pulldown device 22 is operatively coupled to the floor F of the motor vehicle via any number, N, of flexible webs or tethers 24, wherein N may be any positive integer, and the seat pulldown device 22 illustratively includes at least one actuator responsive to the activation signal to cause the device 22 to pull the vehicle seat 12 downwardly toward and to the floor F by exerting a force on the web(s) or tether(s) 24 to reduce the length of the web(s) or tether(s) 24 between the seat pulldown device 22 and the floor F. One non-limiting example of the seat pulldown device 22 which may be used in the system 10 is illustrated and described in U.S. Pat. No. 9,896,006, the disclosure of which is expressly incorporated herein by reference in its entirety.

The occupant restraint system 10 further includes a control circuit 26 having an output electrically or wirelessly coupled to the at least one actuator of the seat pulldown device 22, and a memory unit 28 configured to store therein instructions executable by the control circuit 26 to selectively produce the activation signal for the seat pulldown device. The control circuit 26 may be conventional and may include one or more control circuits, some of which is/are provided in the form of one or more conventional microprocessors, controllers and/or other processor circuits, and the memory unit 28 may likewise be conventional and may include one or more memory circuits configured to store information therein including instructions executable by the control circuit 26 to control operation of the occupant restraint system 10 as described herein. The system 10 further illustratively includes at least one sensor 30 configured to be mounted to the motor vehicle in a conventional manner and to be electrically or wirelessly coupled to a signal input of the control circuit 26. In one embodiment, the at least one sensor 30 illustratively includes one or more conventional sensors configured to produce one or more corresponding sensor signals indicative of the position of the motor vehicle relative to one or more respective axes of the motor vehicle, e.g., yaw, pitch and/or roll, and from which a rollover status of the motor vehicle may be determined in a conventional manner so that an imminent vehicle rollover event may be detected and acted upon as described herein. Alternatively or additionally, the at least one sensor 30 may illustratively include one or more conventional sensors configured to produce one or more corresponding sensor signals indicative of acceleration of the motor vehicle in one or more directions from which a collision status of the motor vehicle may be determined in a conventional manner so that an imminent crash or collision of the motor vehicle with another object may be detected and acted upon as described herein.

In some embodiments, as illustrated by example in FIG. 1, the system 10 may include at least one actuator 32 electrically or wirelessly coupled to a signal output of the control circuit 26. In such embodiments, the at least one actuator 32 may be conventional and configured to be responsive to a control or activation signal produced by the control circuit 26 to bypass or disable the blast attenuation structure of the seat base 20 and/or to decouple the blast attenuation structure from the seat base 20, so as to disable the blast attenuation or mitigation mode of the seat base 20 and enable the seat pulldown mode of the seat base 20.

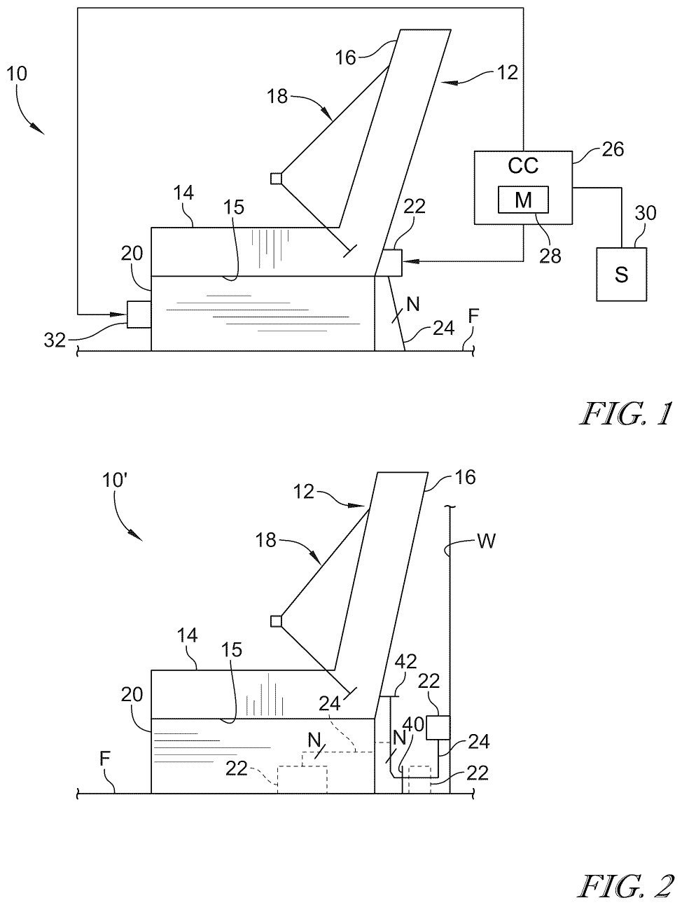

Referring now to FIG. 2, another embodiment is shown of an occupant restraint system 10′ for a motor vehicle seat 12. The occupant restraint system 10′ is illustratively identical in many respects to the occupant restraint system 10 illustrated in FIG. 1 and described above, and like reference numbers are therefore used to identify like structures. Although not shown in FIG. 2, it will be understood that the occupant restraint system 10′ includes the control circuit 26, memory unit 28 and sensor(s) 30 all operable as described above. Some embodiments of the system 10′ may include the at least one actuator 32 whereas other embodiments may not. The occupant restraint system 10′ depicted by example in FIG. 2 illustratively differs from the occupant restraint system 10 shown in FIG. 1 and described above primarily in the mounting location, and in some cases, the function of the seat pulldown device 22. In some embodiments of the system 10′, for example, the seat pulldown device 22 may be mounted to a wall or wall frame, W, of the motor vehicle, and in some such embodiments at least one flexible web or tether 24 may be routed through a conventional floor-mounted web guide 40 and affixed to a conventional web anchor 42 mounted to the seat bottom 14, seat back 16 and/or seat frame 15. Alternatively, the seat pulldown device 22 may be mounted to the floor F and affixed to the web anchor 42 as illustrated in dashed-line representation in FIG. 2. In such embodiments, the seat pulldown device 22 may be operable as described above, when activated, to pull the vehicle seat 12 downwardly toward the floor F. Such embodiments may further include the at least one actuator 32 operable as described above.

In other embodiments of the system 10′, the wall-mounted or floor-mounted seat pulldown device 22 may be operatively coupled, via the one or more webs or tethers 24, to the seat base 20. Alternatively, the seat pulldown device 22 may be mounted to the floor F within the seat base 20 or be affixed to a portion of the seat base 20 that is affixed to the floor F, and may be operatively coupled to the seat base 20 via one or more flexible webs or tethers 24, as illustrated in dashed-line representation in FIG. 2, or directly to the seat base 20 in which case the one or more webs or tethers 24 may be omitted. In any case, in some such embodiments the at least one actuator 32 may be included and be operable as described above to disable the blast attenuation or mitigation mode of the seat base 20, and the seat pulldown device 22 may be operable, in the seat pulldown mode, to cause the one or more webs or tethers 24 to pull a top portion of the seat base 20 downwardly toward a bottom portion of the seat base 20. In alternate embodiments, the at least one actuator 32 may be omitted, and in such embodiments the seat base 20 illustratively includes one or more releasable locking mechanisms configured to normally lock the seat base 20 in the blast attenuation or mitigation mode, i.e., to enable operation of the blast attenuation structure of the seat base 20, and to be responsive to operation of the seat pulldown device 22, either directly or via the one or more webs or tethers 24, to release or decouple from the blast attenuation structure and thereby cause the remaining structure of the seat base 20 to collapse such that the vehicle seat 12 will move downwardly to the floor F under the weight of the occupant of the vehicle seat 12. In such embodiments, the one or more webs or tethers 24 may enter the seat base 20 via one of the sides, top or bottom of the seat base.

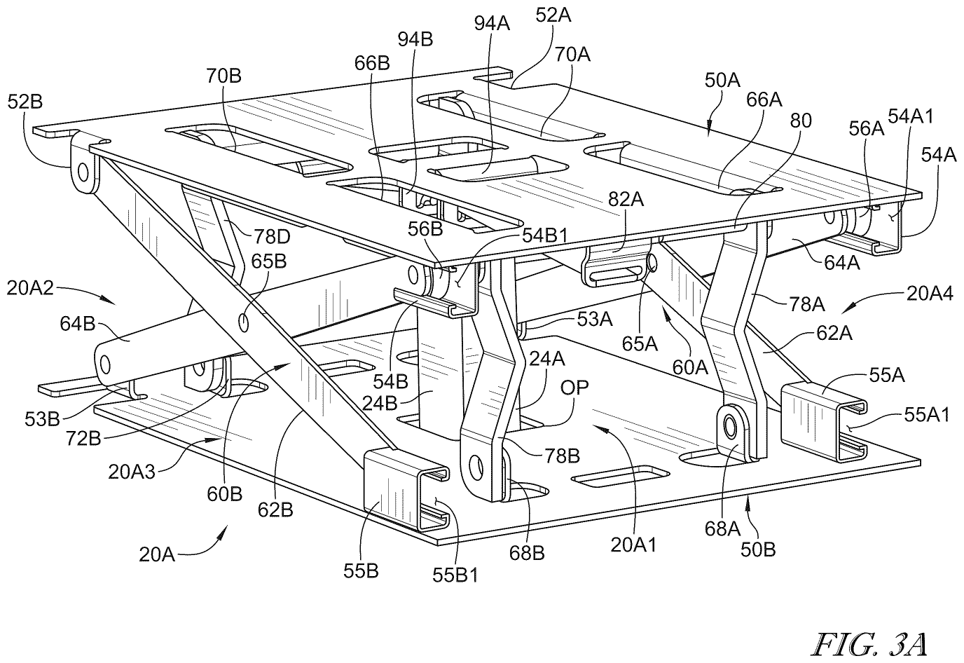

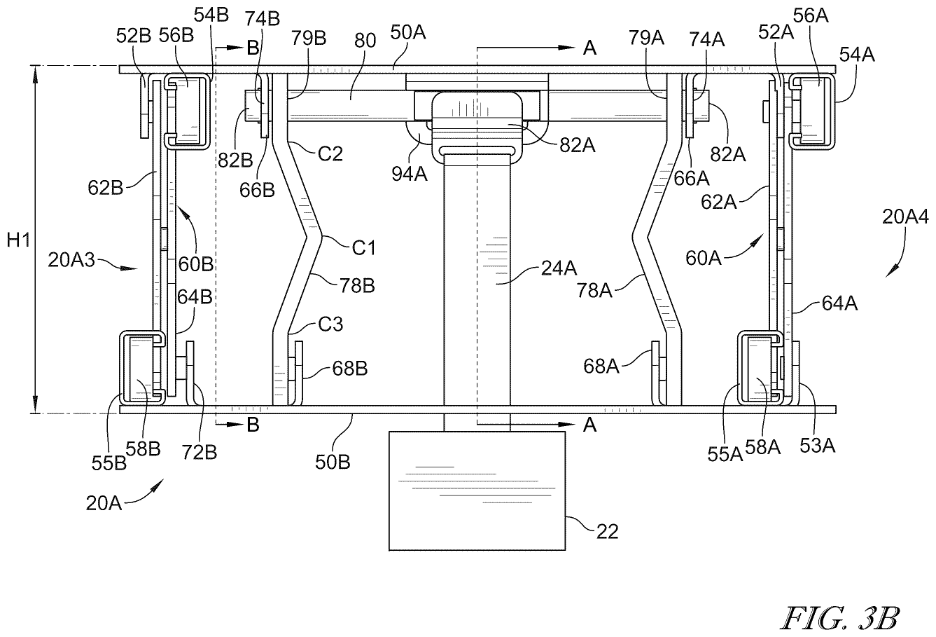

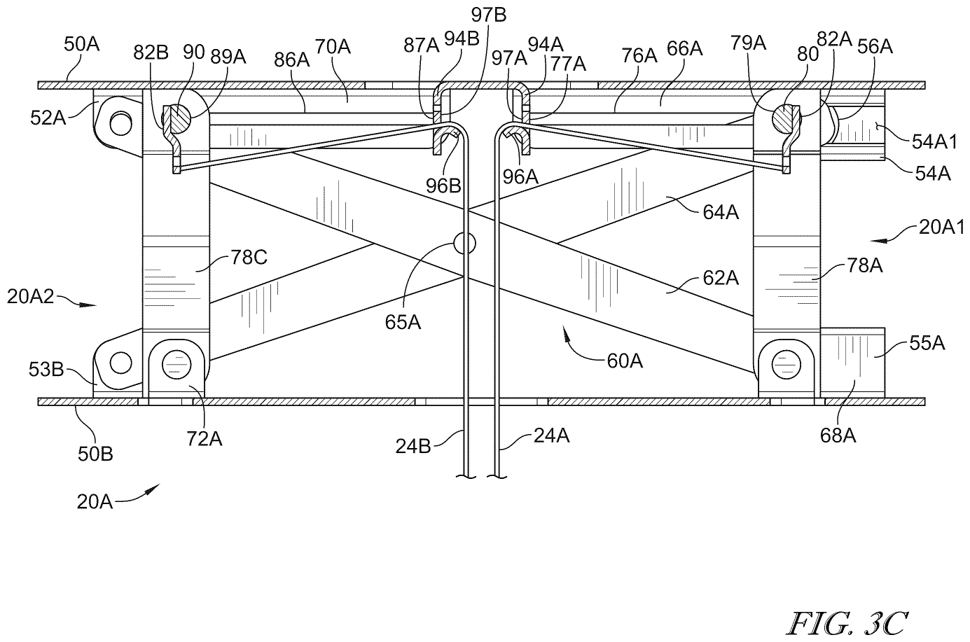

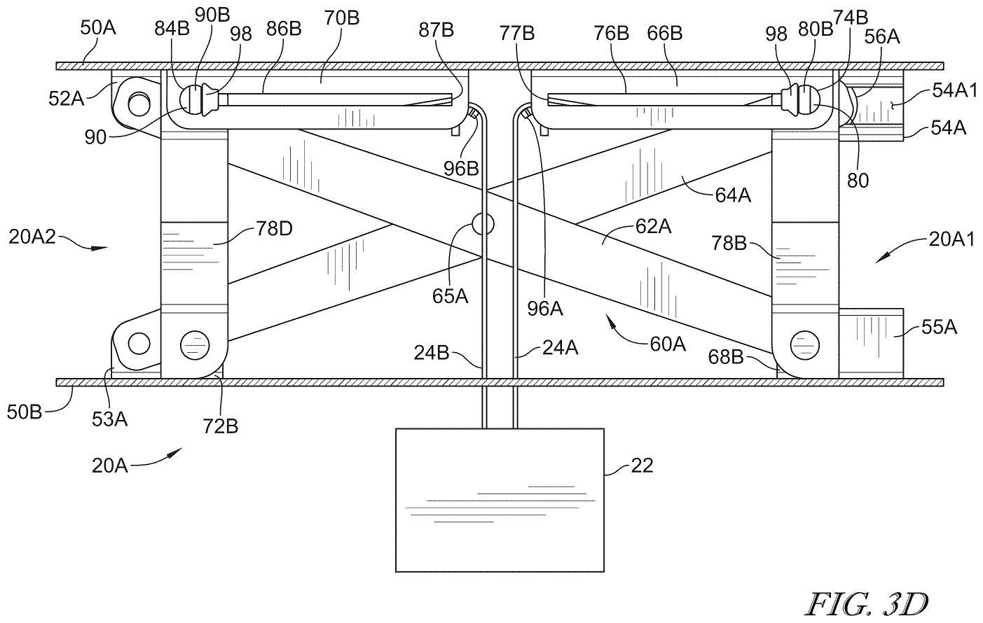

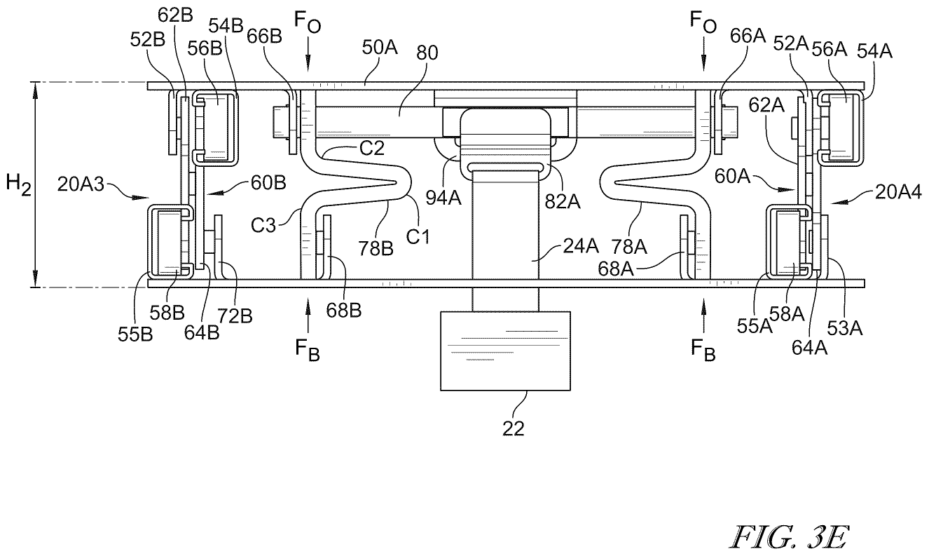

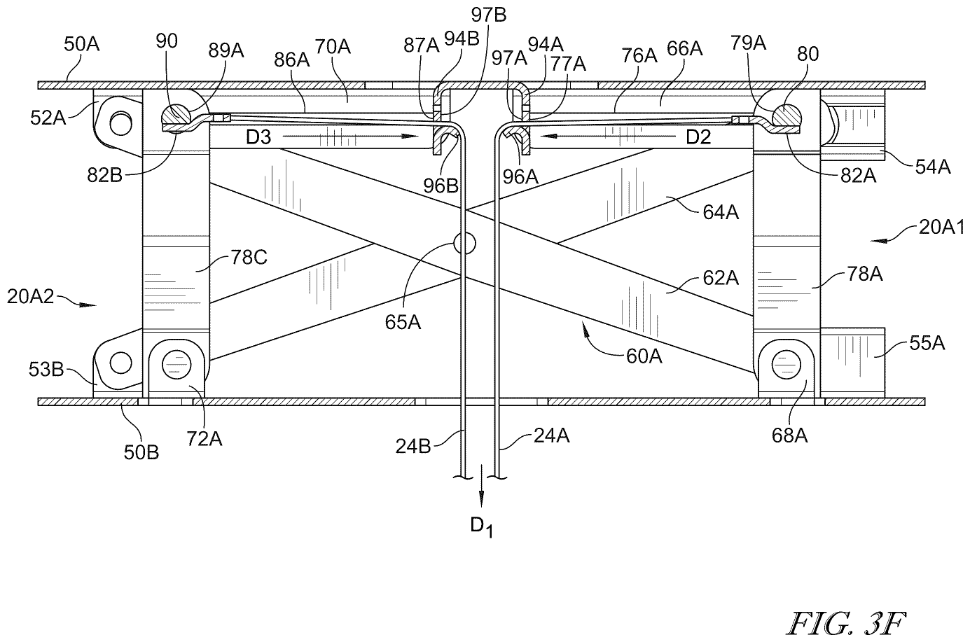

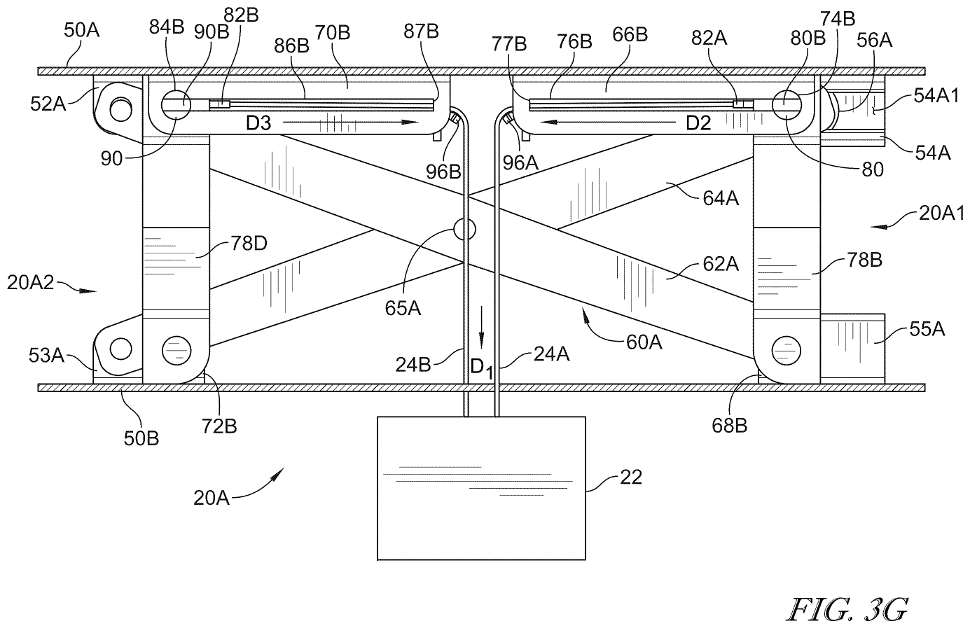

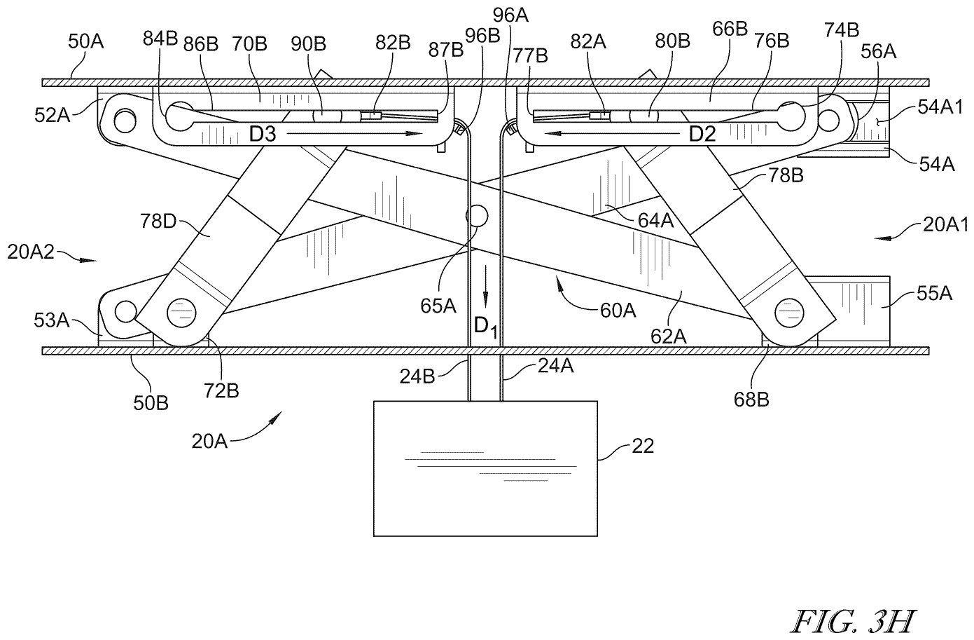

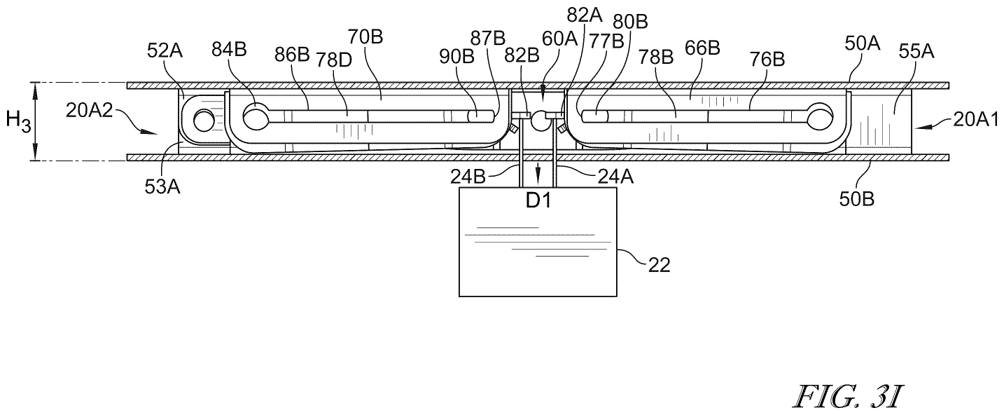

Referring now to FIGS. 3A-3I, an example embodiment 20A of the seat base 20 of FIGS. 1 and 2 is shown. In the illustrated embodiment, the seat base 20A includes a top plate 50A configured to be coupled directly to the seat frame 15 beneath the seat bottom 14, or to the seat bottom 14 in embodiments in which the seat frame 15 is integral with the seat bottom 14. In some alternate embodiments, the top plate 50A may be indirectly coupled to the seat frame 15 and/or seat bottom 14 via one or more intermediate structures, e.g., one or more additional seat bases, a seat height adjustment structure, a seat pivoting or other structure, and/or the like. In any case, it will be understood that the top plate 50A is shown only by way of example, and that in alternate embodiments the top plate 50A may take the form of any conventional top member 50A configured to operatively couple to one or more blast attenuation structures and to operatively couple to a seat pulldown structure as described below.

A bottom plate 50B is vertically spaced apart from the top plate 50A, and the bottom plate 50B is configured to be coupled directly to the floor F of the motor vehicle. In the embodiment illustrated in FIGS. 3A-3I, two webs or tethers 24A, 24B are shown exiting the bottom plate 50B through an opening OP disposed centrally through the bottom plate 50B, and in such embodiments an offset structure will be positioned between the plate 50B and the floor F to provide for movement of the webs or tethers 24A, 24B between the bottom plate 50B and the floor F of the motor vehicle, and in such embodiments the bottom plate 50B may thus be coupled to the floor indirectly via the offset structure or other intermediate seat structure such as a seat height and/or position adjustment structure. In embodiments which do not include such an offset or other intermediate structure, the bottom plate 50B may be mounted directly to the floor F and the opening OP may be replaced with one or more conventional web guides, mounted to or integral with the inwardly-facing surface of the bottom plate 50B, and configured in a conventional manner to guide the webs or tethers 24A, 24B through the front 56A or rear 56B of the seat base 20A. It will be understood that the bottom plate 50B is shown only by way of example, and that in alternate embodiments the bottom plate 50B may take the form of any conventional bottom member 50B configured to operatively couple to one or more blast attenuation structures and to operatively couple to a seat pulldown structure as described below.

In the illustrated embodiment, the top and bottom plates 50A, 50B are substantially parallel with one another, although in alternate embodiments the plates 50A, 50B may not be parallel with one another. The seat base 20A formed by the top and bottom plates 50A, 50B together have a front 20A1, a rear 20A2 opposite the front 20A1, a right side 20A3 extending between the front 20A1 and rear 20A2 and a left side 20A4, opposite the right side 20A3, and also extending between the front 20A1 and the rear 20A2 of the seat base 20A.

The top plate 50A and the bottom plate 50B each illustratively include a number of ears or tabs to and/or between various structures are attached to the plates 50A, 50B; the ears or tabs of the top plate 50A extending downwardly from an inwardly-facing surface of the top plate 50A toward the bottom plate 50B and the ears or tabs of the bottom plate 50B extending upwardly from an inwardly-facing surface of the bottom plate 50B toward the top plate 50A. In the illustrated embodiment, all such ears or tabs are formed in and by respective portions of the top and bottom plates 50A, 50B in which portions of the top and bottom plates 50A, 50B are cut, etched or otherwise removed in patterns, and respective sections of the top and bottom plates 50A, 50B formed by such patterns are inwardly to form the respective ears or tabs. In alternate embodiments, one or more of the ears or tabs extending downwardly from the top plate 50A and/or extending upwardly from the plate 50B may be separate from the top and/or bottom plates 50A, 50B and attached or affixed thereto in a conventional manner.

In the illustrated embodiment, an ear or tab 52A extends downwardly from the top plate 50A along the left side 20A4 of the seat base 20A at or spaced apart from the rear 20A2 of the seat base 20A, and another ear or tab 53A extends upwardly from the bottom plate 50B also along the left side 20A4 of the seat base 20A at or spaced apart from the rear 20A2 of the seat base 20A. The ears or tabs 52A, 53A are illustratively positioned such that, upon full collapse of the seat base 20A as illustrated by example in FIG. 3H, the ear or tab 52A is inward of the ear or tab 53A, although alternate embodiments the ears or tabs 52A, 53A may be positioned such that the ear or tab 53A is inward of the ear or tab 52A. Another ear or tab 52B extends downwardly from the top plate 50A along the right side 20A3 of the seat base 20A directly opposite the ear or tab 52A, and another ear or tab 53B extends upwardly from the bottom plate 50B also along the right side 20A3 of the seat base 20A directly opposite the ear or tab 53A. The ears or tabs 52B, 53B are illustratively positioned such that, upon full collapse of the seat base 20A as illustrated by example in FIG. 3H, the ear or tab 52B is outward of the ear or tab 53B, although alternate embodiments the ears or tabs 52B, 53B may be positioned such that the ear or tab 53B is outward of the ear or tab 52B.

A guide rail 54A is mounted in a conventional manner to the inwardly-facing surface of the top plate 50A and extends downwardly from the top plate 50A along the left side 20A4 of the seat base 20A at or spaced apart from the front 20A1 of the seat base 20A, and another guide rail 55A is mounted in a conventional manner to the inwardly-facing surface of the bottom plate 50B and extends upwardly from the bottom plate 50B also along the left side 20A4 of the seat base 20A at or spaced apart from the front 20A2 of the seat base 20A. The guide rails 54A, 55A each define a respective elongated track or channel 54A1, 55A1 therein sized and configured to receive a respective roller 56A, 58A movable along the track or channel 54A1, 55A1. The guide rails 54A, 55A are illustratively positioned relative to the top and bottom plates 50A, 50B such that, upon full collapse of the seat base 20A as illustrated by example in FIG. 3H, the guide rail 54A is outward of the guide rail 55A, although alternate embodiments the guide rails 54A, 55A may be positioned such that the guide rail 55A is outward of the guide rail 54A. The guide rails 54A, 55A are further illustratively positioned relative to the top and bottom plates 50A, 50B such that the channels or tracks 54A1, 55A1 extend in directions parallel with the left side 20A4 of the seat base 20A, i.e., from front 20A1 to rear 20A2 and vice versa of the seat base 20A.

Another guide rail 54B is mounted in a conventional manner to the inwardly-facing surface of the top plate 50A and extends downwardly from the top plate 50A along the right side 20A3 of the seat base 20A at or spaced apart from the front 20A1 of the seat base 20A, and yet another guide rail 55B is mounted in a conventional manner to the inwardly-facing surface of the bottom plate 50B and extends upwardly from the bottom plate 50B also along the right side 20A3 of the seat base 20A at or spaced apart from the front 20A2 of the seat base 20A. The guide rails 54B, 55B each define a respective elongated track or channel 54B1, 55B1 therein sized and configured to receive a respective roller 56B, 58B movable along the track or channel 54B1, 55B1. The guide rails 54B, 55B are illustratively positioned relative to the top and bottom plates 50A, 50B such that, upon full collapse of the seat base 20A as illustrated by example in FIG. 3H, the guide rail 55B is outward of the guide rail 54B, although alternate embodiments the guide rails 54B, 55B may be positioned such that the guide rail 54B is outward of the guide rail 55B. The guide rails 54B, 55B are further illustratively positioned relative to the top and bottom plates 50A, 50B such that the channels or tracks 54B1, 55B1 extend in directions parallel with the channels or tracks 54A1, 55A1 of the guide rails 54A, 55A.

A pair of scissor structures 60A, 60B are operatively coupled between the top and bottom plates 50A, 58B along a respective side 20A4, 20A3 of the seat base 20A, and are configured to guide relative movement of the top and bottom plates 50A, 50B toward one another in each of the blast attenuation and seat pulldown operating modes of the seat base 20A. The scissor structure 60A illustratively includes a scissor arm 62A rotatably mounted at one end to the ear or tab 52A, and rotatably mounted at an opposite end to the roller 58A disposed in the channel or track 55A1 of the guide rail 55A. Another scissor arm 64A is rotatably mounted at one end to the ear or tab 53A, and is rotatably mounted at an opposite end to the roller 56A disposed in the channel or track 54A1 of the guide rail 54A. A pin or axle 65A engages each of the scissor arms 62A, 64A at approximately their midpoints, and each of the scissor arms 62A, 64A is rotatable about the pin or axle 65A such that height of the scissor structure 60A changes in a conventional manner with the pivoting of the scissor arms 62A, 64A about the pin or axle 65A. In the illustrated embodiment, the scissor arm 62A is inboard of the scissor arm 64A along the left side 20A4 of the seat base 20A, although in alternate embodiments the scissor arm 62A may be outboard of the scissor arm 64A. The scissor structure 60B similarly includes a scissor arm 62B rotatably mounted at one end to the ear or tab 52B, and rotatably mounted at an opposite end to the roller 58B disposed in the channel or track 55B1 of the guide rail 55B. Another scissor arm 64B is rotatably mounted at one end to the ear or tab 53B, and is rotatably mounted at an opposite end to the roller 56B disposed in the channel or track 54B1 of the guide rail 54B. A pin or axle 65B engages each of the scissor arms 62B, 64B at approximately their midpoints, and each of the scissor arms 62B, 64B is rotatable about the pin or axle 65B such that height of the scissor structure 60B changes in a conventional manner with the pivoting of the scissor arms 62B, 64B about the pin or axle 65B. In the illustrated embodiment, the scissor arm 62B is outboard of the scissor arm 64B along the right side 20A3 of the seat base 20A, although in alternate embodiments the scissor arm 62B may be inboard of the scissor arm 64B. The scissor structures 60A, 60B are otherwise illustratively identical to one another such that movement of the scissor structures 60A, 60B track one another during movement of the top and bottoms plates 50A, 50B toward one another in both of the blast attenuation and seat pulldown operating modes of the seat base 20A as will be described in detail below.

An elongated ear or tab 66A extends downwardly from the top plate 50A between a center line of the top plate 50A, extending from front 20A1 to rear 20A2 of the seat base 20A, and the left side 20A4 of the seat base 20A and spaced apart from the front 20A1 of the seat base 20A, and another elongated ear or tab 66B extends downwardly from the top plate 50A between the center line of the plate 50A and the right side 20A4 of the seat base 20A and also spaced apart from the front 20A1 of the seat base 20A. Illustratively, the ears or tabs 66A, 66B are elongated in the same direction from front 20A1 to rear 20A2 and vice versa of the seat base 20A, and are also aligned with one another in the direction from side 20A3 to side 20A4 and vice versa of the seat base 20A. Yet another ear or tab 68A extends upwardly from the bottom plate 50B between a center line of the bottom plate 50B, which is aligned with and co-planar with the center line of the top plate 50A, and the left side 20A4 of the seat base 20A and spaced apart from the front 20A1 of the seat base 20A, and still another ear or tab 68B extends upwardly from the bottom plate 50B between the center of the plate 50A and the right side 20A4 of the seat base 20A and also spaced apart from the front 20A1 of the seat base 20A. Illustratively a mounting portion of the elongated ear or tab 66A is aligned with the ear or tab 68A, and a mounting portion of the ear or tab 66B is aligned with the ear or tab 68B.

Another elongated ear or tab 70A extends downwardly from the top plate 50A between the center line of the top plate 50A and the left side 20A4 of the seat base 20A and spaced apart from the rear 20A2 of the seat base 20A, and still another elongated ear or tab 70B extends downwardly from the top plate 50A between the center line of the top plate 50A and the right side 20A4 of the seat base 20A and also spaced apart from the front 20A1 of the seat base 20A. Illustratively, the ears or tabs 70A, 70B are elongated in the same direction from front 20A1 to rear 20A2 and vice versa of the seat base 20A, and are also aligned with one another in the direction from side 20A3 to side 20A4 and vice versa of the seat base 20A. Yet another ear or tab 72A extends upwardly from the bottom plate 50B between the center line of the bottom plate 50B and the left side 20A4 of the seat base 20A and spaced apart from the rear 20A2 of the seat base 20A, and still another ear or tab 72B extends upwardly from the bottom plate 50B between the center line of the plate 50A and the right side 20A4 of the seat base 20A and also spaced apart from the rear 20A2 of the seat base 20A. Illustratively a mounting portion of the elongated ear or tab 70A is aligned with the ear or tab 72A, and a mounting portion of the ear or tab 70B is aligned with the ear or tab 72B. Further illustratively, the elongated ears or tabs 66A and 70A are aligned, i.e., collinear or co-planar, with one another from front 20A1 to rear 20A2 of the seat base, as are the ears or tabs 68A, 72A, and the elongated ears or tabs 66B and 70B are aligned, i.e., collinear or co-planar, with one another from front 20A1 to rear 20A2 of the seat base, as are the ears or tabs 68B, 72B.

As best shown in FIG. 3H, the elongated ear or tab 66B illustratively defines an opening 74B therethrough near an end of the ear or tab 66B closest to the front 20A1 of the seat base 20A, and an elongated channel 76B open to the opening 74B and extending rearwardly from the opening 74B to a terminal end 77B of the channel 76B. The elongated ear or tab 66A is illustratively identical to the elongated ear or tab 66B, and includes an opening 74A (see FIG. 3B) and a channel 76A extending rearwardly therefrom to a terminal end 77A of the channel 76A, wherein such openings 74A, 74B and channels 76A, 76B are aligned with one another from side 20A3 to side 20A4 and vice versa of the seat base 20A. In the illustrated embodiment, the openings 74A, 74B are circular in cross-section and have diameters greater than the widths of the channels 76A, 76B.

An elongated and deformable blast attenuation structure 78A extends between the inwardly-facing surfaces of the top and bottom plates 50A, 50B with one end rotatably mounted to the ear or tab 68A and an opposite end defining a circular opening 79A therethrough which is aligned with and has the same diameter as the opening 74A defined through the ear or tab 66A. Another elongated and deformable blast attenuation structure 78B also extends between the inwardly-facing surfaces of the top and bottom plates 50A, 50B with one end rotatably mounted to the ear or tab 68B and an opposite end defining a circular opening 79B therethrough which is aligned with and has the same diameter as the opening 74B defined through the ear or tab 66B. A rotatable shaft 80 extends between the blast attenuation structures 78A, 78B with one end extending through the opening 79A defined through the blast attenuation structure 78A and an opposite end extending through the opening 79B defined through the blast attenuation structure 78B. Illustratively, the shaft 80 is circular in cross-section and has a diameter slightly less than that of the openings 79A, 79B such that the shaft 80 is rotatable relative to each of the blast attenuation structures 78A, 78B.

The opposite ends of the rotatable shaft each define a tab 80A, 80B each of which extends axially away from the shaft 80 and is illustratively rectangular in shape such that the long sides of the rectangles are substantially equal to the diameter of the shaft 80 and the short sides of the rectangles each define therebetween a width of the rectangle that is slightly less than the width of the channels 76A, 76B. The tab 80A illustratively extends into and through the opening 74A defined through the elongated ear or tab 66A, and the tab 80B extends into and through the opening 74B defined through the elongate ear or tab 66B. The shaft 80 is thus rotatable relative to the blast attenuation structures 78A, 78B and also relative to the elongated ears or tabs 66A, 66B. The shaft 80 is prevented from moving along the channels 76A, 76B between the openings 74A, 74B and the terminal ends 77A, 77B of the channels 76A, 76B unless the widths of the tabs 80A, 80B are aligned with the channels 76A, 76B in which case the shaft 80 may move along the channels 76A, 76B relative to the elongated ears or tabs 66A, 66B and thus relative to the seat base 20A.

An actuator bracket 82A is illustratively attached to the shaft 80, e.g., approximately midway along its length as best illustrated by example in FIGS. 3A, 3B and 3E. The actuator bracket 82A is illustratively fixed to the shaft 80 such that the shaft 80 and the bracket 82A rotate together. One end of the web or tether 24A extending upwardly into the seat base 20A through the opening OP in the bottom plate 50B is attached to the actuator bracket 82A such that a downward force applied to the web or tether 24A causes the shaft 80 to rotate as will be described in greater detail below.

The elongated ears or tabs 70A and 70B are illustratively identical to the elongated ears or tabs 66A, 66B, and the various features 84B, 86A, 86B, 87A and 87B are identical to the corresponding features 74B, 76A, 76B, 77A, 77B of the elongated ears or tabs 66A, 66B, and detailed descriptions of these features will not be repeated here for brevity. Elongated blast attenuation structures 78C, 78D are illustratively identical to the blast attenuation structures 78A, 78B, and one end of the blast attenuation structure is rotatably mounted to the ear or tab 72A and one end of the blast attenuation structure is rotatably mounted to the ear or tab 72B. Openings defined at opposite ends of the blast attenuation structures 78C, 78D, e.g., opening 89A illustrated by example in FIGS. 3C and 3F, align with the respective openings defined through the elongated ears or tabs 70A, 70B, e.g., opening 84B illustrated by example in FIGS. 3D and 3G-3I. A rotatable shaft 90, illustratively identical to the rotatable shaft 80, extends through the openings defined through the blast attenuation structures 78C, 78D, and tabs extending radially away from respective ends of the rotatable shaft 90, e.g., tab 90B illustrated by example in FIGS. 3D and 3G-3I, are illustratively identical to the tabs 82A, 82B and extend into the openings defined through the elongated ears 70A, 70B as described above with respect to the tabs 82A, 82B. As also described above, the shaft 90 is prevented from moving along the channels 86A, 86B of the elongated ears or tabs 70A, 70B unless the tabs, e.g., the tab 90B illustrated in FIGS. 3D and 3G-3I, align with the channels 86A, 86B as described above with respect to the tabs 82A, 82B and channels 76A, 76B. An actuator bracket 82B, illustratively identical to the actuator bracket 82A, is affixed to the shaft 90 such that the bracket 82B and the shaft 90 rotate together, and one end of the web or tether 24B extending upwardly into the seat base 20A through the opening OP in the bottom plate 50B is attached to the actuator bracket 82B such that a downward force applied to the web or tether 24B causes the shaft 90 to rotate as will be described in greater detail below.

As best shown in FIGS. 3C-3D and 3F-3I, the elongated ears or tabs 70A, 70B are configured such that the openings defined therethrough, e.g., the opening 84B illustrated by example in FIGS. 3D and 3G-3I, are closest to the rear 20A2 and the channels 86A, 86B extend forwardly from such openings toward the front 20A1 of the seat base 20A. The orientations of the features of the elongated ears or tabs 66A, 66B and 70A, 70B are configured such that when properly aligned with the respective sets of channels 76A, 76B and 86A, 86B, the shafts 80, 90 are both transversely movable by a respective one of the webs or tethers 24A, 24B away from the respective front 20A1 and rear 20A2 of the seat base 20A toward the center of the seat base 20A.

A pair of ears or tabs 94A, 94B extend downwardly, and approximately centrally, from the top plate 50A with the ear or tab 94A positioned forwardly toward the front 20A1 and the ear or tab 94B positioned rearwardly toward the rear 20A2. Illustratively, each ear or tab 94A, 94B includes a respective web guide surface 96A, 96B formed at a lower end of a respective opening 97A, 97B, wherein the web guide surfaces 96A, 96B are positioned adjacent to respective terminal ends 77A, 77B and 87A, 87B of respective pairs of the channels 76A, 76B and 86A, 86B. The end of the web or tether 24A extending upwardly from the opening OP in the bottom plate 50B, illustratively extends through the opening 97A of the ear or tab 94A and is then attached to the actuator bracket 82A in a conventional manner such that the web or tether 24A is supported on the web guide 96A between the opening OP and the actuator bracket 82A. The end of the web or tether 24B extending upwardly from the opening OP in the bottom plate 50B, similarly extends through the opening 97B of the ear or tab 94B and is then attached to the actuator bracket 82B in a conventional manner such that the web or tether 24B is supported on the web guide 96B between the opening OP and the actuator bracket 82B.

Referring specifically to FIGS. 3A-3D, the seat base 20A is shown in a configuration in which it is operable in the blast attenuation or mitigation mode. Illustratively, this is the normal or default operating mode of the seat base 20A during normal operating conditions of the motor vehicle in which the seat base 20A and the seat 12 are mounted; i.e., during conditions in which no under-vehicle explosion is present, in which a rollover and/or impact of the motor vehicle is not occurring or imminent, wherein the latter two conditions are illustratively determined by the control circuit 26 based on signals produced by the sensor 30 as described above. In the blast attenuation or mitigation mode, the blast attenuation structures 78A-78D are fully extended (i.e., not deformed) between the top and bottom plates 50A, 50B, and as a result the seat base 20A has a maximum height H1 as depicted in FIG. 3B. It will be understood that whereas the seat base 20A is illustrated and described as having four blast attenuation structures, alternate embodiments may include more or fewer such blast attenuation structures; e.g., alternate embodiments may include one or more blast attenuation structures.

In the blast attenuation or mitigation operating mode, the seat pulldown device 22 is in a normal (e.g., default) and unactuated state in which the device 22 is not actively applying tension to the webs or tethers 24A, 24B, and the webs or tethers 24A, 24B are thus at their maximum lengths between the seat pulldown device 22 and the respective actuator brackets 82A, 82B. With the webs or tethers 24A, 24B at maximum length, the arms of the actuator brackets 82A, 82B are illustratively positioned vertically downward, i.e., approximately 90 degrees downward, as illustrated by example in FIG. 3C, and the rotatable shafts 80 and 90 are both oriented such that the long sides of the tabs 80A, 80B and 90A, 90B are approximately perpendicular to the respective channels 76A, 76B and 86A, 86B of the respective elongated ears or tabs 66A, 66B and 70A, 70B, i.e., approximately 90 degrees rotated away from the orientation which would allow the tabs 80A, 80B and 90A, 90B to move through the respective channels 76A, 76B and 86A, 86B, as illustrated by example in FIG. 3D. In alternate embodiments, the arms of the actuator brackets 82A, 82B may be positioned vertically upward, i.e., approximately 90 degrees upward. In any case, the position of the shafts 80, 90 illustrated in FIG. 3D represents the locked position of the shafts 80, 90 in which the shafts 80, 90 cannot move along longitudinally along the channels 76A, 76B and 86A, 86B of the respective elongated ears or tabs 66A, 66B and 70A, 70B. In some embodiments, as illustrated by example in FIG. 3D, retention members 98, e.g., retention clips or other retention structures, may illustratively be inserted into one or more of the channels 76A, 76B and 86A, 86B adjacent to the respective openings 74A, 74B and 84A, 84B, wherein such one or more retention clips 98 is/are configured to maintain the locked position of the shafts 80, 90 as illustrated by example in FIGS. 3C and 3D and described above.

With the shafts 80, 90 in their locked positions as described above, the rollers 56A, 56B and 58A, 58B are prevented from moving relative to the respective tracks or channels 54A1, 54B1 and 55A1, 55B1 of the respective guide rails 54A, 54B and 55A, 55B, and the positions of the top and bottom plates 50A, 50B are thus locked in the blast attenuation or mitigation operating mode at the height H1 depicted by example in FIG. 3B. In the event of an under-vehicle explosion, the blast attenuation structures 78A-78D are configured to deform in a manner which absorbs energy from the explosion. In one embodiment, the blast attenuation structures 78A-78D are illustratively provided in the form of elongated bars having a number of deformable hinge sections which inelastically deform in a folding manner, thereby resulting in relative movement between the top and bottom plates 50A, 50B in a manner which reduces the distance between the top and bottom plates 50A, 50B. In the illustrated embodiment, for example, the blast attenuation structures 78A-78D include three such hinge sections C1, C2 and C3 as depicted by example in FIG. 3B. In response to an under-vehicle explosion, the blast attenuation structures 78A-78D will deform along the hinge sections C1-C3 which, in turn, will draw the scissor support structures downwardly and result in compression of the seat base 20B as illustrated by example in FIG. 3E.

As also illustrated by example in FIG. 3E, the amount or degree of deformation of the blast attenuation structures 78A-78D and resultant compression of the seat base 20A will generally depend on, and thus be a function of, a number of factors including, but not limited to, the magnitude and direction of upward force, F_{B}, applied by the blast or explosion to the bottom plate 50B, the magnitude and direction of downward force, F_{O}, applied by the occupant of the seat 12 to the top plate 50A during the explosion (which will generally be a function of a number of occupant metrics including, for example, the weight of the occupant), the number of blast attenuation structures 78A-78D disposed between the top and bottom plates 50A, 50B (four in the illustrated embodiment), and the deformation rate and/or other physical deformation-determining characteristics of the blast attenuation structures 78A-78D. In the example depicted in FIG. 3E, the under-vehicle explosion resulted in compression of the seat base 20A by an amount which reduced the distance between the top and bottom plates 50A, 50B from the original height H1 to a reduced height of H2, although it will be understood that other under-vehicle explosions may result in a reduced height greater or less than H2. It will be understood that whereas the example of FIG. 3E depicts uniform compression of the seat base 20A, this depiction is provided only by way of example, and some under-vehicle explosions, depending on their distance from and angle relative to the seat base 20A, may non-uniformly compress plates 50A, 50B. The nature and operation of the scissor support structures 60A, 60B, on the other hand, will illustratively mitigate any such non-uniform compression by forcing the two sides 20A3, 20A4 of the seat base 20A to compress somewhat more uniformly.

Referring specifically to FIGS. 3F-3I, reconfiguration of the seat base 20A from the blast attenuation or mitigation operating mode to the seat pulldown operating mode and subsequent operation of the seat base 20A during the seat pulldown operating mode is shown. With the seat base 20A in the blast attenuation or mitigation operating mode as illustrated by example in FIGS. 3D and 3F and described above, the control circuit 26 is continually operable to execute instructions stored in the memory unit 28 to monitor the signal(s) produced by the sensor 30. Upon detection of a sufficiently imminent rollover and/or vehicle impact event, the instructions stored in the memory unit 28 include instructions executable by the control circuit 26 to produce an activation signal to activate the seat pulldown device 22. The seat pulldown device 22 is responsive to the activation signal to simultaneously (or near simultaneously) draw the webs or tethers 24A, 24B downwardly away from the top plate 50A in the direction D1 which, in turn, causes the portion of the web or tether 24A between the actuator bracket 82A and the web guide 96A to move in the direction D2 away from the actuator bracket 82A, and causes the portion of the web or tether 24B between the actuator bracket 82B and the web guide 96B to move in the direction D3 away from the actuator bracket 82B, as depicted by example in FIGS. 3F-3H. Initially, the movement of the webs or tethers 24A, 24B in the respective directions D2, D3 causes the arms of each of the actuator brackets 82A, 82B to rotate, e.g., approximately 90 degrees, into alignment with the respective channels 76A, 76B and 86A, 86B of the elongated ears or tabs 66A, 66B and 70A, 70B as illustrated by example in FIG. 3F. Such rotation of the arms of the actuator brackets 82A, 82B, in turn, rotates the respective shafts 80, 90, e.g., also approximately 90 degrees, so as to align the tabs 80A, 80B and 90A, 90B of the shafts 80, 90 with the respective channels 76A, 76B and 86A, 86B as illustrated by example in FIG. 3G. In embodiments which include one or more retention members 98, rotation of the actuator brackets 82A, 82B as just described illustratively dislodges or breaks away the one or more retention members 98 as further depicted by example in FIG. 3F.

With the tabs 80A, 80B and 90A, 90B of the shafts 80, 90 aligned with the respective channels 76A, 76B and 86A, 86B of the respective elongated ears or tabs 66A, 66B and 70A, 70B as illustrated by example in FIG. 3G, continued movement of the webs or tethers 24A, 24B in the respective directions D2, D3 pulls the tabs 80A, 80B and 90A, 90B along the respective channels 76A, 76B and 86A, 86B which, in turn, pulls the shafts 80, 90 laterally or transversely along the respective elongated ears or tabs 66A, 66B and 70A, 70B toward the center of the top plate 50A, as illustrated by example in FIG. 3H. Because the blast attenuation structures 78A-78B are rotatably coupled to respective ones of the shafts 80, 90 and to respective ones of the ears or tabs 68A, 68B, 72A, 72B, the lateral movement of the shafts 80, 80 toward the center of the top plate 50A causes the blast attenuations structures 78A-78B to rotate and collapse downwardly toward the bottom plate 50B as also illustrated in FIG. 3H. With the blast attenuation structures 78A-78D collapsing inwardly and toward the bottom plate 50B by the downward force applied by the seat pulldown device 22 to the webs or tethers 24A, 24B in the direction D1, the rollers 56A, 56B and 58A, 58B of the respective scissor structures 60A, 60B are likewise forced to move along the channels of the respective guide rails 54A, 54B and 55A, 55B in the forward direction (toward the front 20A1 of the seat base 20A) so as to simultaneously collapse the scissor structures 60A, 60B as further depicted by example in FIG. 3H. As the downward force applied to the webs or tethers 24A, 24B in the direction D1 continues, the blast attenuation structures 78A-78D and the scissor structures 60A, 60B fully collapse as illustrated by example in FIG. 3I. The seat pulldown operation illustratively ends when the tabs 80A, 80B and 90A, 90B reach the respective terminal ends 77A, 77B and 87A, 87B of the respective channels 76A, 76B and 86A, 86B. In the fully collapsed state depicted by example in FIG. 3I, the distance between the top and bottom plates 50A, 50B is reduced from the original height H1 to a minimum height H3. The rotatable shafts 80, 90, the activation brackets 82A, 82B, the elongated ears or tabs 66A, 66B and 70A, 70B and the webs or tethers 24A, 24B are thus together responsive to the downward force applied by the seat pulldown device 22 in the direction D1 to disable or bypass the blast attenuation structure(s) 78A-78D and to pull the top plate 50A downwardly toward and to the bottom plate 50B.

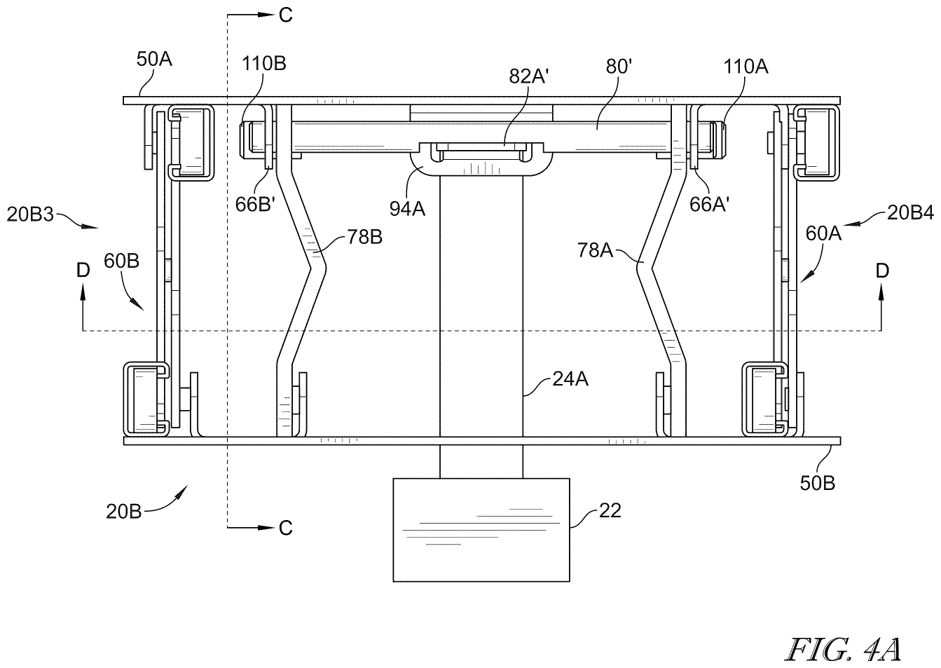

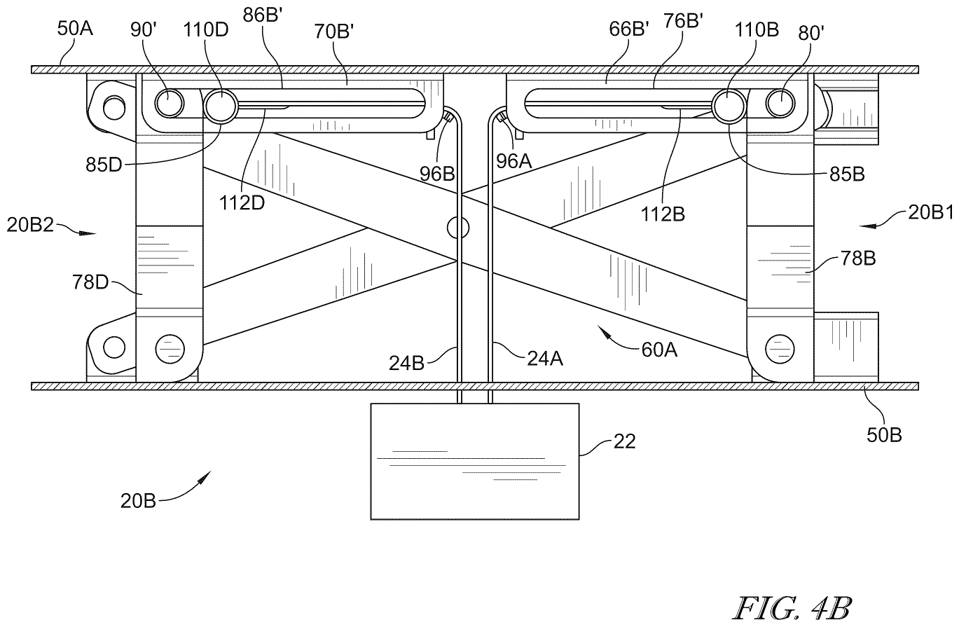

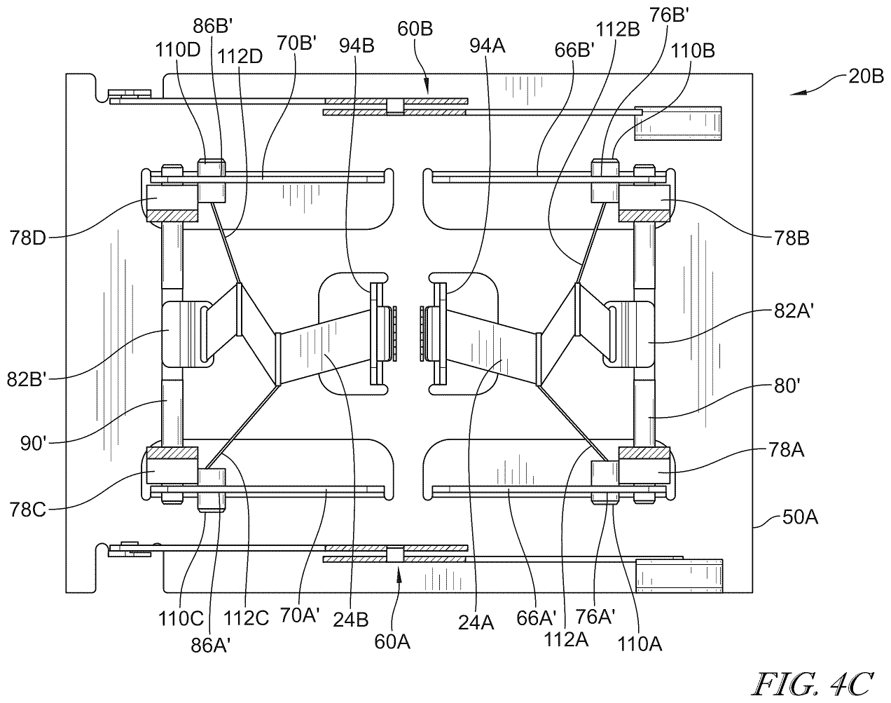

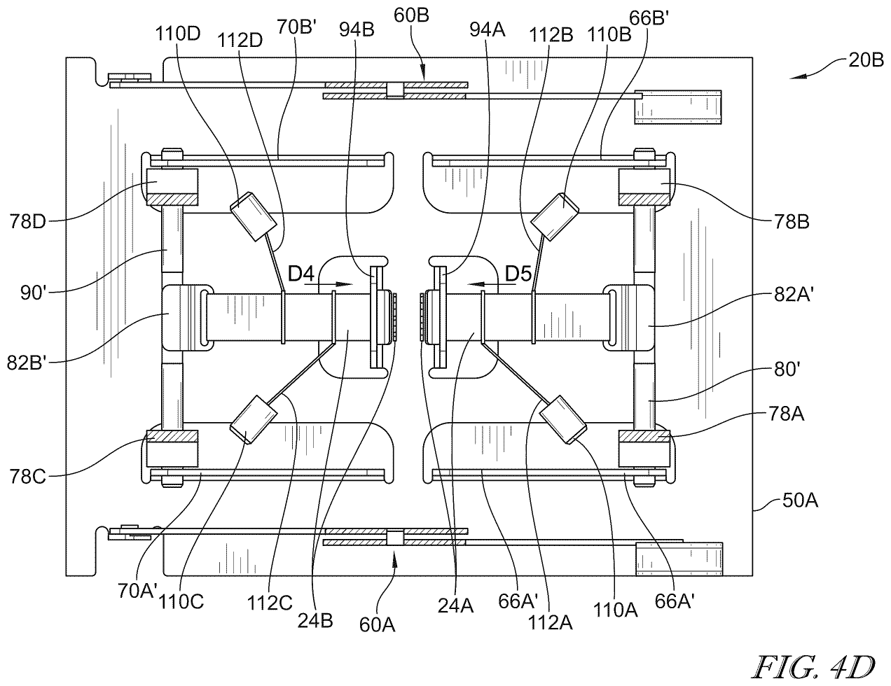

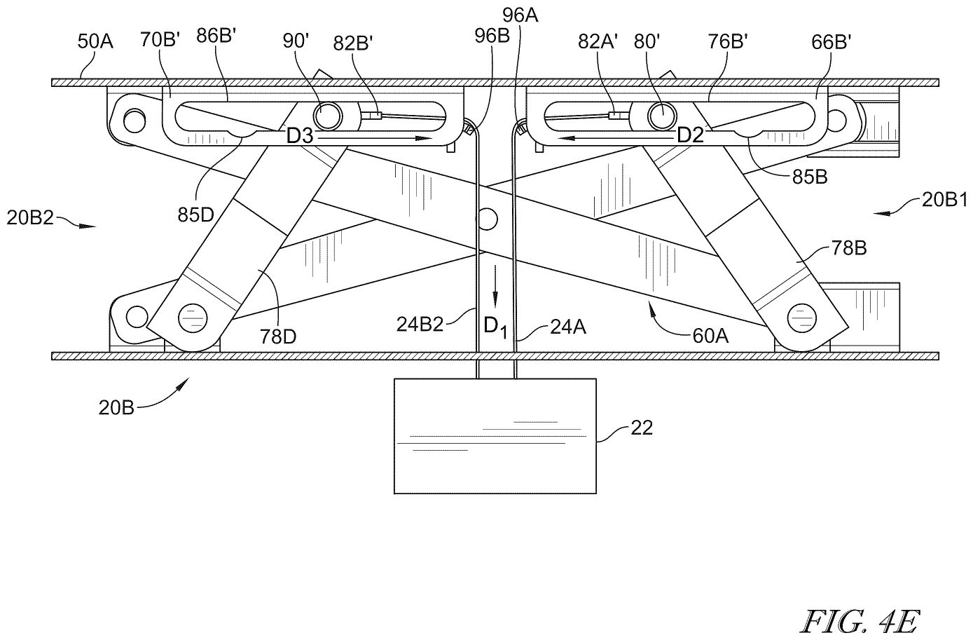

Referring now to FIGS. 4A-4E, another example embodiment 20B of the seat base 20 of FIGS. 1 and 2 is shown. The seat base 20B is identical in many respects to the seat base 20A illustrated by example in FIGS. 3A-3I, and like numbers are therefore used to identify like components. Such like components are the same in structure and function as described above. For example, the seat base 20B includes a top plate 50A, bottom plate 50B, scissor structures 60A, 60B and blast attenuation structures 78A-78D all identical in structure and operation to the corresponding structures of the embodiment illustrated in FIGS. 3A-3I.

Other features of the seat base 20B are similar in structure and operation to features of the seat base 20A, and such similar features are identified in FIGS. 4A-2E with like numbers but differentiated from the corresponding features of FIGS. 3A-3I by an apostrophe. For example, the top plate 50A defines elongated tabs or ears 66A′, 66B′, 70A′ and 70B′ defining elongated channels 76A′, 76B′, 86A′ and 86B′ configured to guide respective shafts 80′, 90′ transversely or laterally along the tabs or ears 66A′, 66B′ and 70A′, 70B′ so as to collapse the blast attenuation structures 78A-78D during the seat pulldown operating mode as described above.

The seat base 20B illustratively differs from the seat base 20A primarily in the mechanisms by which the blast attenuation structures 78A-78D are maintained in place in the blast attenuation or mitigation operating mode of the seat base 20B and are then released to collapse during the seat pulldown operating mode. With specific reference to FIG. 4E, for example, the channels 76A′, 76B′ and 86A′, 86B′ are each configured with a respective pocket 85A, 85B and 85C, 85D along a bottom edge thereof. As best illustrated in FIGS. 4A-4C, the pockets 85A, 85B and 85C, 85D are shaped and sized so as to receive a respective pin 110A, 110B and 110C, 110D within the combination of the respective pocket 85A, 85B and 85C, 85D and the respective channel 76A′, 76B′ and 86A′, 86B′, and are positioned such that the received respective pin 110A, 110B and 110C, 110D abuts or is positioned adjacent to an inwardly-facing edge or side of a respective one of the blast attenuation structures 78A-78D. Illustratively, the pockets 85A-85D and the pins 110A-110D are sized and configured to block and prevent transverse or lateral movement of the shafts 80′, 90′ along the respective channels 76A′, 76B′ and 86A′, 86B′ during the blast attenuation or mitigation operating mode of the seat base 20B so as to maintain the blast attenuation structures 78A-78D upright and positioned between the top and bottom plates 50A, 50B, as best shown in FIGS. 4A and 4B. The actuator brackets 82A′, 82B′ are illustratively attached to the respective shafts 80′, 90′ such that, when actuated by movement of the webs or tethers 24A, 24B as described above, the actuator brackets 82A′, 82B′ do not rotate the shafts 80′, 90′ but rather simply pull the shafts 80′, 90′ laterally or transversely along the respective channels 76A′, 76B′ and 86A′, 86B′ of the respective elongated tabs or ears 66A′, 66B′, 70A′ and 70B′. It will be understood that the shafts 80′, 90′ are not necessarily prohibited from rotating within and relative to the respective channels 76A′, 76B′ and 86A′, 86B′, but are not purposely rotated as described with respect to the seat base 20A of FIGS. 3A-3I.

Referring now specifically to FIGS. 4C and 4D, the portion of the web or tether 24A between the actuator bracket 82A′ and the ear or tab 94A of the top plate 50A is illustratively attached to each of the pins 110A, 110B by a respective tether 112A, 112B, and the portion of the web or tether 24B between the actuator bracket 82B′ and the ear or tab 94B of the top plate 50A is illustratively attached to each of the pins 110C, 110D by a respective tether 112C, 112D. The portions of the web or tethers 24A, 24B between the respective actuator bracket 82A′, 82B′ and the respective ear or tab 94A, 94B are illustratively biased as illustrated by example in FIG. 4C such that, as the webs or tethers 24A, 24B move in the directions D4 and D5 in response to activation of the seat pulldown device 22 at the onset of the seat pulldown operating mode as illustrated by example in FIG. 4D, the tethers 112A-112D pull the pins 110A-110D from the respective channels 76A′, 76B′ and 86A′, 86B′ just prior to the webs or tethers 24A, 24B pulling the shafts 80′, 90′ transversely or laterally along the channels 76A′, 76B′ and 86A′, 86B to collapse the seat base 20B, as illustrated by example in FIG. 4E.

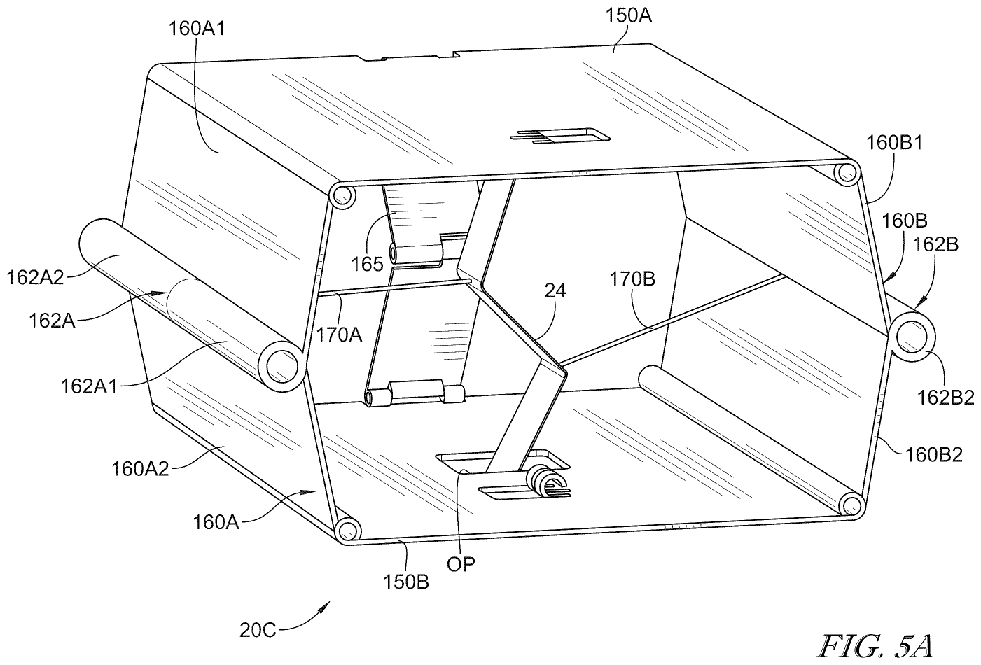

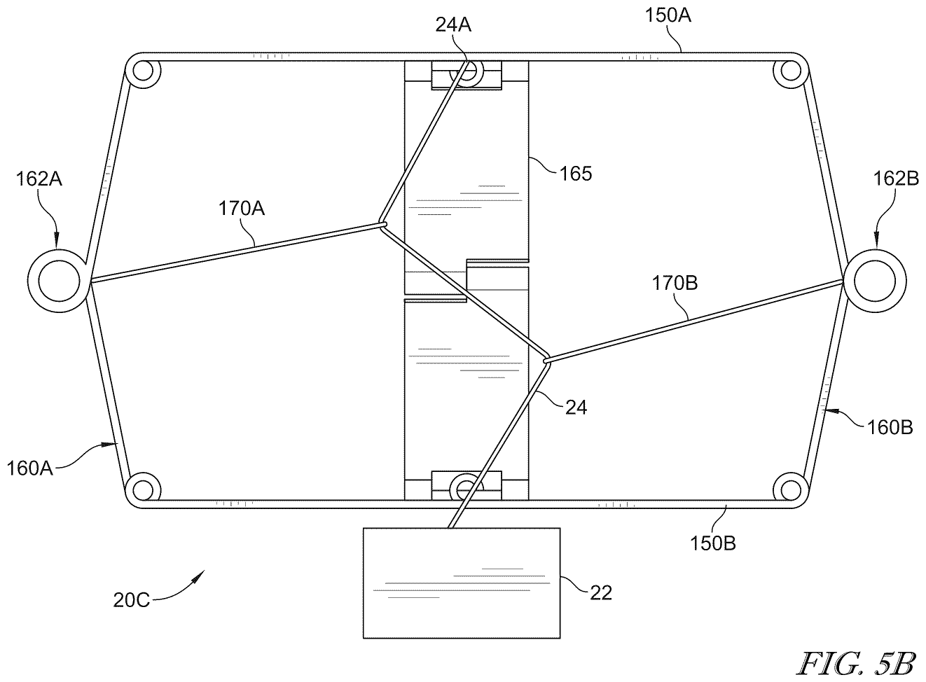

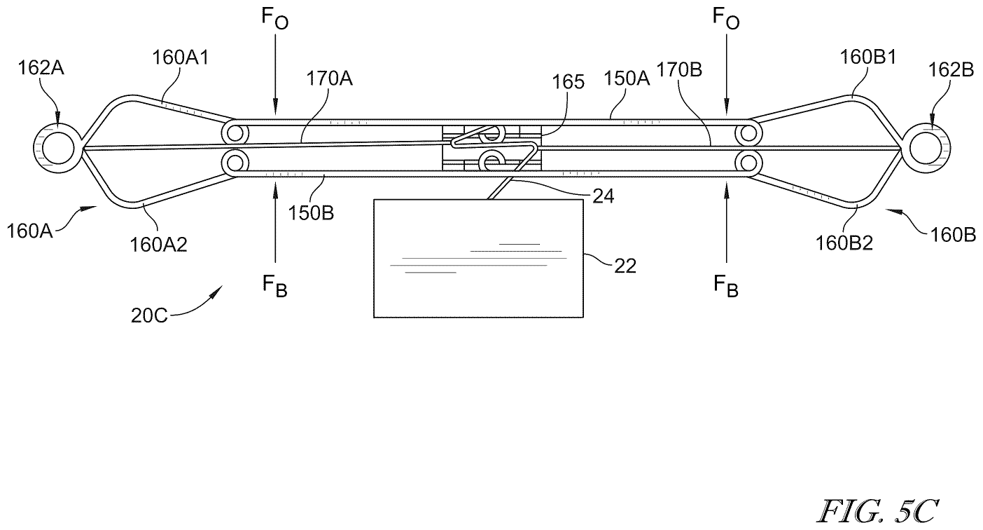

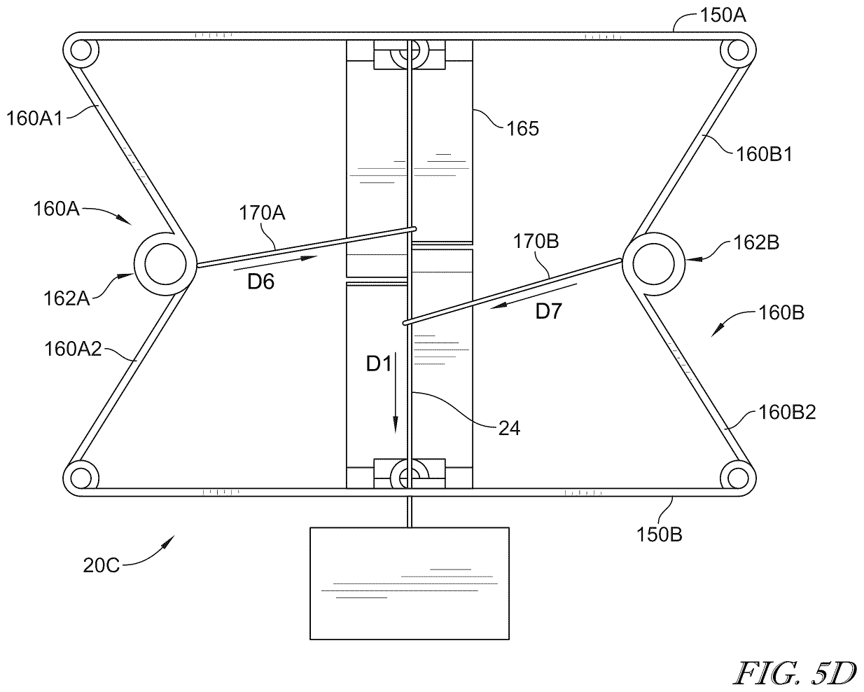

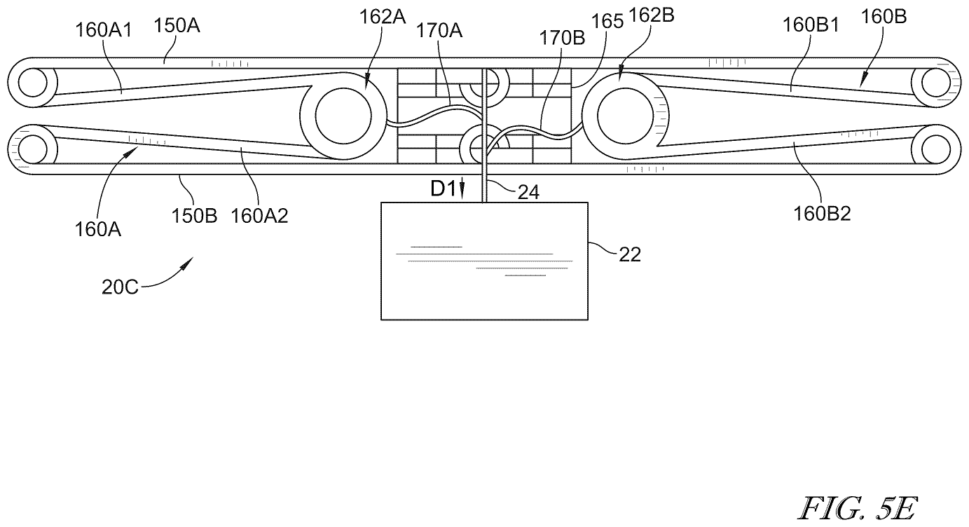

Referring now to FIGS. 5A-5E, yet another example embodiment 20C of the seat base 20 of FIGS. 1 and 2 is shown. In the illustrated embodiment, the seat base 20C includes a top plate 150A, a bottom plate 150B opposite and spaced apart from the top plate 150A, and a pair of one-way hinges 160A, 160B forming respective sides of the seat base 20C. In the illustrated embodiment, a third hinge 165 is coupled to and between the top and bottom plates 150A, 150B along a rear of the seat base 20C. It will be understood that the hinge 165 is included only to provide stability to the seat base 20C, and generally does not play an active role in the blast attenuation or mitigation operating mode or in the seat pulldown operating mode of the seat base 20C. In the illustrated embodiment, the hinges 160A, 160B form the sides of the seat base 20C, the hinge 165 is coupled to and between the top and bottom plates 150A, 150B along the rear of the seat base 20C, and the open section between the hinges 160A, 160B forms the front of the seat base 20C. In alternate embodiments, the hinge 160A or 160B or the hinge 165 may form the font of the seat base 20C.

The top plate 150A is illustratively configured to be coupled directly to the seat frame 15 beneath the seat bottom 14, or to the seat bottom 14 in embodiments in which the seat frame 15 is integral with the seat bottom 14. In some alternate embodiments, the top plate 150A may be indirectly coupled to the seat frame 15 and/or seat bottom 14 via one or more intermediate structures, e.g., one or more additional seat bases, a seat height adjustment structure, a seat pivoting or other structure, and/or the like. In any case, it will be understood that the top plate 150A is shown only by way of example, and that in alternate embodiments the top plate 150A may take the form of any conventional top member 150A configured to operatively couple to one or more blast attenuation structures and to operatively couple to a seat pulldown structure as described below.

The bottom plate 150B is vertically spaced apart from the top plate 150A, and in the illustrated embodiment the top and bottom plates 150A, 150B are substantially parallel with one another, although in alternate embodiments the plates 150A, 150B may not be parallel with one another. The bottom plate 150B is illustratively configured to be coupled directly to the floor F of the motor vehicle. As illustrated by example in FIG. 5A, a single web or tether 24 is shown exiting the bottom plate 150B through an opening OP disposed centrally through the bottom plate 150B, and in such embodiments an offset structure will be positioned between the plate 150B and the floor F to provide for movement of the web or tether 24 between the bottom plate 150B and the floor F of the motor vehicle, and in such embodiments the bottom plate 150B may thus be coupled to the floor indirectly via the offset structure or other intermediate seat structure such as a seat height and/or position adjustment structure. In embodiments which do not include such an offset or other intermediate structure, the bottom plate 150B may be mounted directly to the floor F and the opening OP may be replaced with one or more conventional web guides, mounted to or integral with the inwardly-facing surface of the bottom plate 150B, and configured in a conventional manner to guide the web or tether 24 through the front or rear of the seat base 20C. It will be understood that the bottom plate 150B is shown only by way of example, and that in alternate embodiments the bottom plate 150B may take the form of any conventional bottom member 150B configured to operatively couple to one or more blast attenuation structures and to operatively couple to a seat pulldown structure as described below.

In the illustrated embodiment, the hinge 160A includes a leaf 160A1 rotatably coupled to one side of the top plate 150A, and another leaf 160A2 rotatably coupled to a corresponding side of the bottom plate 150B. In the illustrated embodiment a hinge knuckle 162A includes a hinge knuckle 162A1 coupled to or integral with the leaf 160A1, and another hinge knuckle 162A2 coupled to or integral with the other leaf 160A2. Alternatively, the hinge knuckle 162A1 may be coupled to or integral with the leaf 160A2, and the hinge knuckle 162A2 may be coupled to or integral with the leaf 160A1. In any case, the hinge knuckles 162A1, 162A2 are coupled together via a conventional pin. The hinge 160B includes a leaf 160B1 rotatably coupled to the opposite side of the top plate 150A, and another leaf 160B2 rotatably coupled to a corresponding side of the bottom plate 150B. In the illustrated embodiment a hinge knuckle 162B includes a hinge knuckle 162B1 coupled to or integral with the leaf 160B1, and another hinge knuckle 162B2 coupled to or integral with the other leaf 160B2. Alternatively, the hinge knuckle 162B1 may be coupled to or integral with the leaf 160B2, and the hinge knuckle 162B2 may be coupled to or integral with the leaf 160B1. In any case, the hinge knuckles 162B1, 162B2 are coupled together via a conventional pin.

The hinges 160A, 160B are both one-way hinges configured such that the leaves 160A1, 160A2 and 160B1, 160B2 rotate about the respective knuckles 162A, 162B only in the direction in which the knuckles 162A, 162B pivot inwardly toward one another, and do not rotate in the opposite direction. The normal, static position of the hinges 160A, 160B, in which the seat base 20C is operating in the blast attenuation or mitigation operating mode, is illustrated by example in FIGS. 5A and 5B in which the hinge knuckles 162A, 162B are biased slightly outwardly. The hinges 160A, 160B are illustratively designed such that the leafs 160A1, 160A2 and 160B1, 160B2 will buckle and deform about the respective knuckles 162A, 162B only in response to a sufficient force applied to the top and/or bottom plate(s) 150A, 150B. In the event of an under-vehicle explosion, for example, such buckling and deformation of the hinges 160A, 160B will absorb energy from the explosion, thereby resulting in compression of the seat base 20C as illustrated by example in FIG. 5C.

As also illustrated by example in FIG. 50, the amount or degree of deformation of the hinges 160A, 160B and resultant compression of the seat base 20C will generally depend on, and thus be a function of, a number of factors including, but not limited to, the magnitude and direction of upward force, FB, applied by the blast or explosion to the bottom plate 150B, the magnitude and direction of downward force, FO, applied by the occupant of the seat 12 to the top plate 150A during the explosion (which will generally be a function of a number of occupant metrics including, for example, the weight of the occupant), and the deformation rate and/or other physical deformation-determining characteristics of the hinges 160A, 160B.

Referring specifically to FIGS. 5B and 5D-5E, reconfiguration of the seat base 20C from the blast attenuation or mitigation operating mode, illustrated by example in FIGS. 5A and 5C, to the seat pulldown operating mode and subsequent operation of the seat base 20C during the seat pulldown operating mode is shown. With the seat base 20C in the blast attenuation or mitigation operating mode as illustrated by example in FIG. 5B and described above, the control circuit 26 is continually operable to execute instructions stored in the memory unit 28 to monitor the signal(s) produced by the sensor 30. Upon detection of a sufficiently imminent rollover and/or vehicle impact event, the instructions stored in the memory unit 28 include instructions executable by the control circuit 26 to produce an activation signal to activate the seat pulldown device 22. The seat pulldown device 22 is responsive to the activation signal to draw the web or tether 24 downwardly away from the top plate 150A in the direction D1 which, in turn, causes the portion of the web or tether 24 between the top and bottom plates 150A, 150B to draw the tethers 170A, 170B in the respective directions D6, D7, thereby drawing the hinge knuckles 162A, 162B inwardly as depicted by example in FIG. 5D. Illustratively, the lengths of the tethers 170A, 170B are designed to be responsive to the downward movement of the web or tether 24 (in the direction D1) to pull the hinge knuckles 162A, 162B sufficiently inwardly so as to reconfigure the hinges 160A, 160B to operate as normally pivoting hinges. Thus, as the downward movement of the web or tether 24 in the direction D1 continues under force of the pulldown device 22, the one-way hinges 160A, 160B will pivot inwardly, i.e., the knuckles 162A, 162B will move toward one another, thus causing the top plate 150A to move downwardly toward the bottom plate 150B as illustrated by example in FIG. 5E. The seat pulldown operation illustratively ends when the respective leaves 160A1, 160A2 and 160B1, 160B2 are fully pivoted toward one another. The one-way hinges 160A, 160B are thus normally configured in the blast attenuation or mitigation operating mode of the seat base 20C to act as the blast attenuation structures, and can be transformed or reconfigured by the seat pulldown web or tether 24 to act as pivoting hinges which, in the seat pulldown operating mode of the seat base 20C, assist in the collapse of the seat base 20C by guiding the top plate 150A toward, and to, the bottom plate 250B.

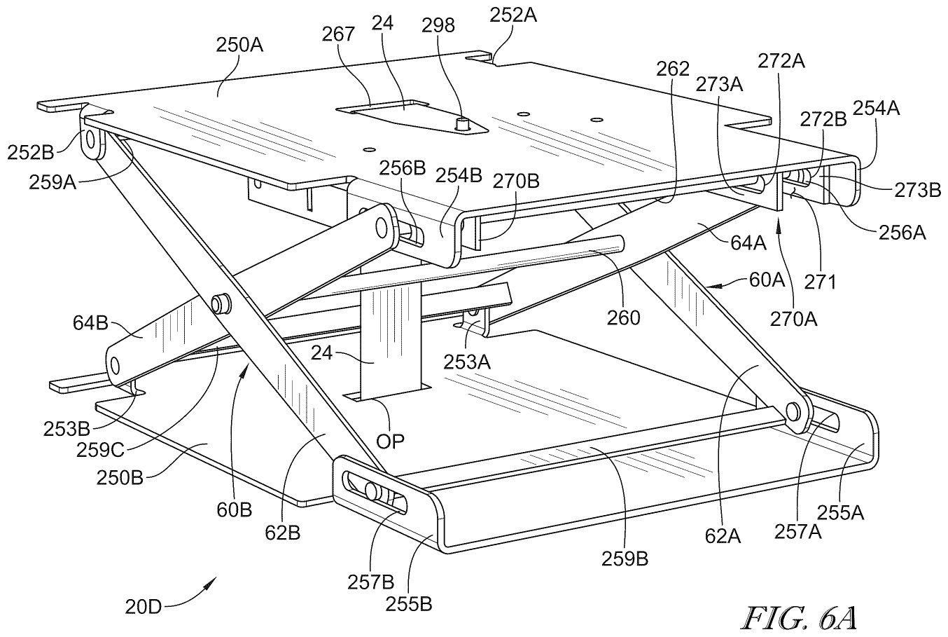

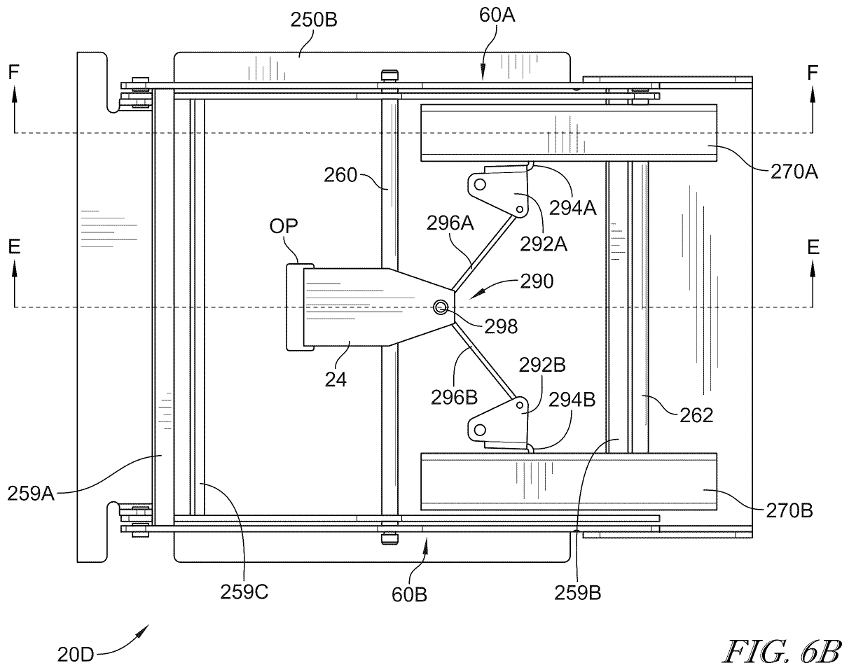

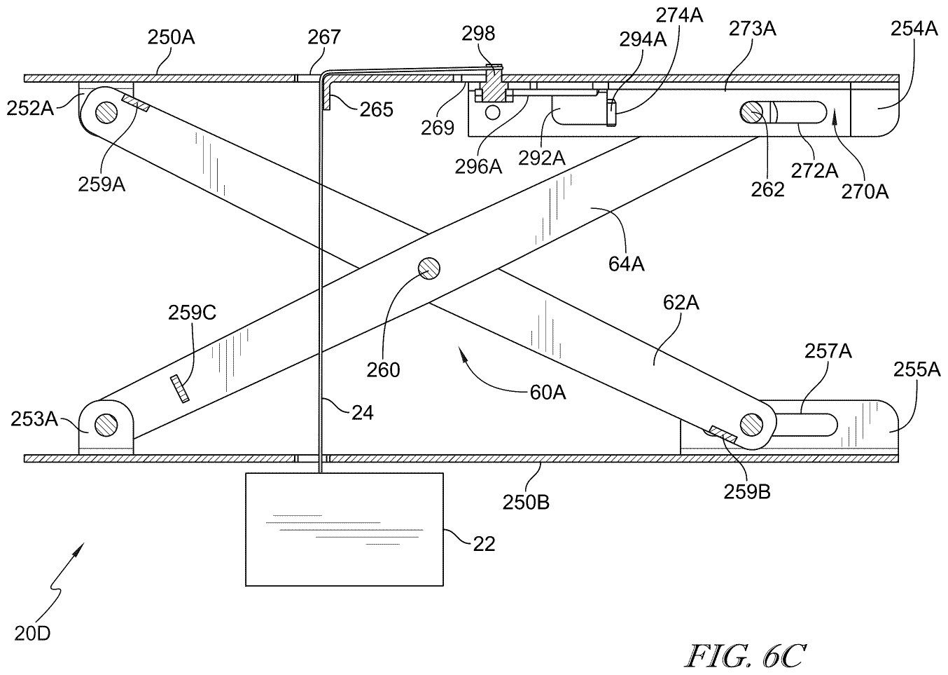

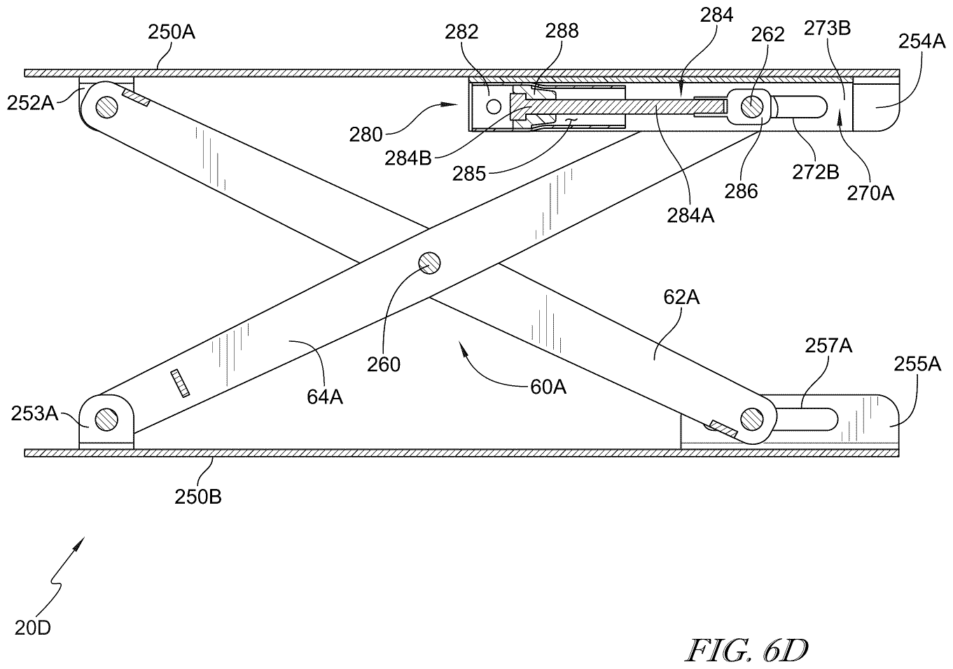

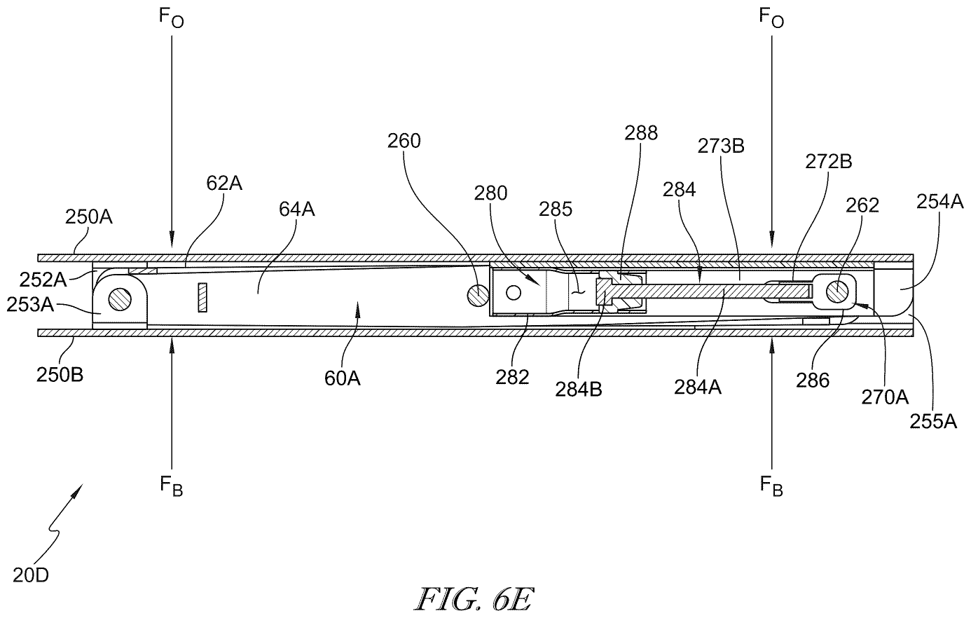

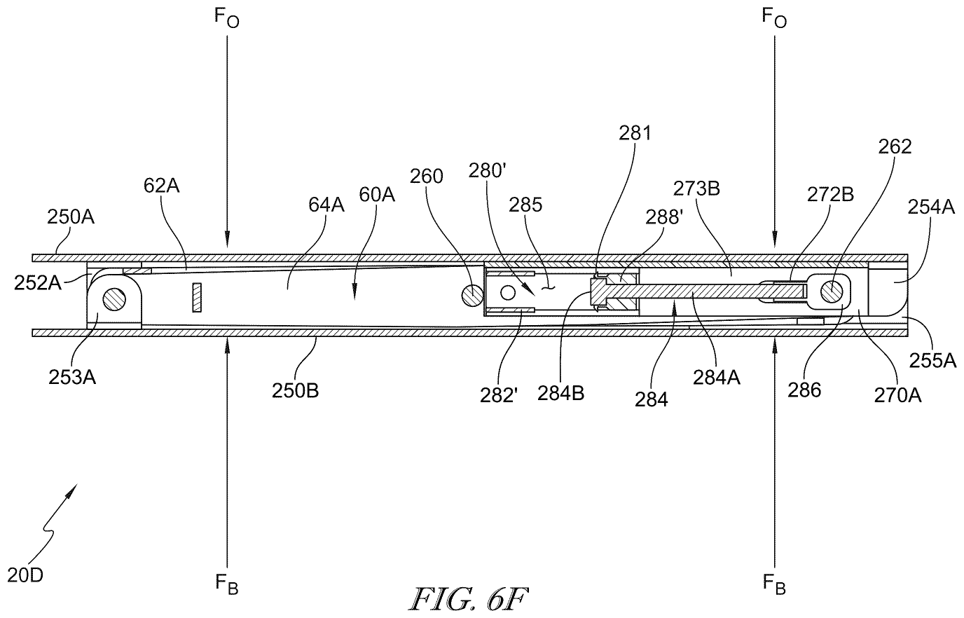

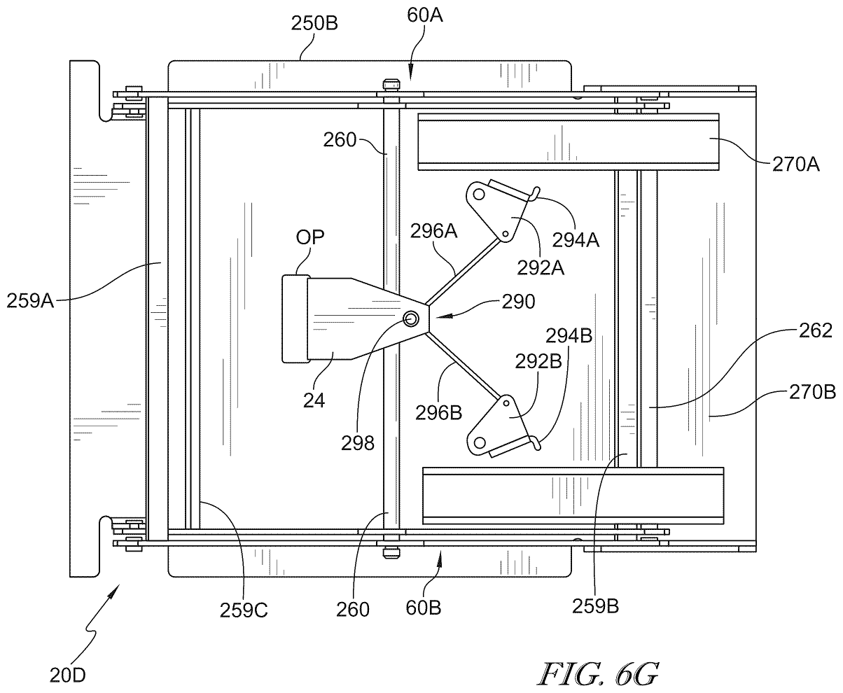

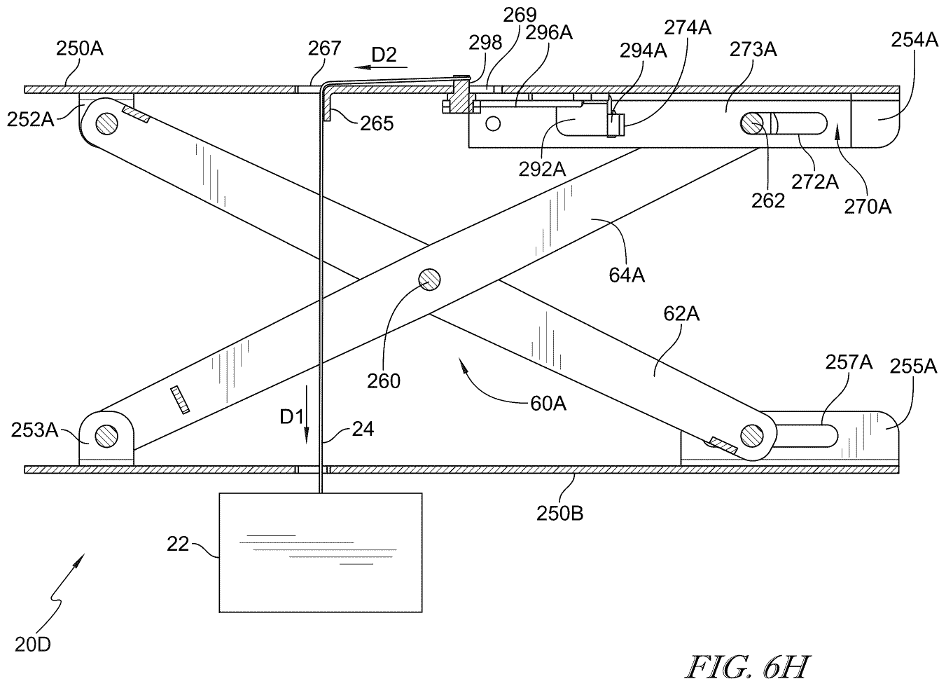

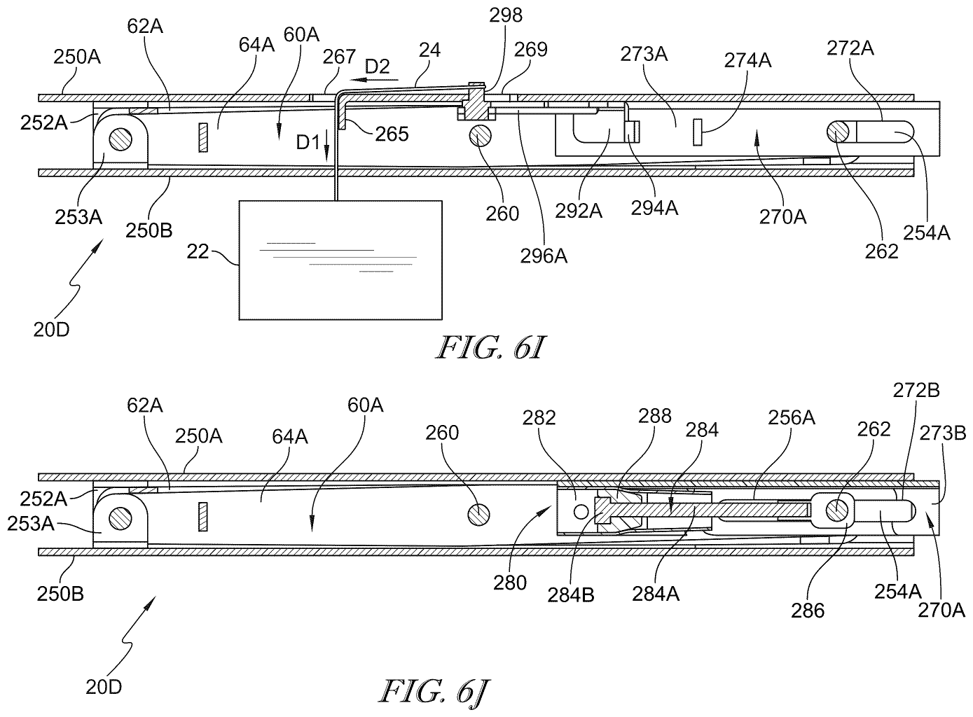

Referring now to FIGS. 6A-6I, a further example embodiment 20D of the seat base 20 of FIGS. 1 and 2 is shown. In the illustrated embodiment, the seat base 20D includes a top plate 250A configured to be coupled directly to the seat frame 15 beneath the seat bottom 14, or to the seat bottom 14 in embodiments in which the seat frame 15 is integral with the seat bottom 14. In some alternate embodiments, the top plate 250A may be indirectly coupled to the seat frame 15 and/or seat bottom 14 via one or more intermediate structures, e.g., one or more additional seat bases, a seat height adjustment structure, a seat pivoting or other structure, and/or the like. In any case, it will be understood that the top plate 250A is shown only by way of example, and that in alternate embodiments the top plate 250A may take the form of any conventional top member 250A configured to operatively couple to one or more blast attenuation structures and to operatively couple to a seat pulldown structure as described below.

A bottom plate 250B is vertically spaced apart from the top plate 250A, and the bottom plate 250B is configured to be coupled directly to the floor F of the motor vehicle (see, e.g., FIGS. 1 and 2). In the embodiment illustrated in FIGS. 6A-6I, a single web or tether 24 is shown exiting the bottom plate 250B through an opening OP disposed centrally through the bottom plate 250B, and in such embodiments an offset structure will be positioned between the plate 250B and the floor F to provide for movement of the web or tether 24 between the bottom plate 250B and the floor F of the motor vehicle, and in such embodiments the bottom plate 250B may thus be coupled to the floor indirectly via the offset structure or other intermediate seat structure such as a seat height and/or position adjustment structure. In embodiments which do not include such an offset or other intermediate structure, the bottom plate 250B may be mounted directly to the floor F and the opening OP may be replaced with one or more conventional web guides, mounted to or integral with the inwardly-facing surface of the bottom plate 250B, and configured in a conventional manner to guide the web or tether 24 through the front or rear of the seat base 20D. It will be understood that the bottom plate 250B is shown only by way of example, and that in alternate embodiments the bottom plate 250B may take the form of any conventional bottom member 250B configured to operatively couple to one or more blast attenuation structures and to operatively couple to a seat pulldown structure as described below.

In the illustrated embodiment, the top and bottom plates 250A, 250B are substantially parallel with one another, although in alternate embodiments the plates 250A, 250B may not be parallel with one another. The seat base 20D formed by the top and bottom plates 250A, 250B together have a front, rear left side and right side as illustrated and described above with respect to FIGS. 3A-3I. Like the top and bottom plates 50A, 50B of FIGS. 3A-3I and 4A-4E, the top plate 250A and the bottom plate 250B each illustratively include a number of ears or tabs to and/or between various structures are attached to the plates 250A, 250B; the ears or tabs of the top plate 250A extending downwardly from an inwardly-facing surface of the top plate 250A toward the bottom plate 250B and the ears or tabs of the bottom plate 250B extending upwardly from an inwardly-facing surface of the bottom plate 250B toward the top plate 250A. In the illustrated embodiment, all such ears or tabs are sized and configured to accommodate operative engagement with respective scissor structures 60A, 60B illustrated in FIGS. 3A-3I and described in detail above. The scissor arm 62A, for example, is rotationally coupled at one end to the ear or tab 252A formed in and by the top plate 250A, and is slidably coupled to and within a channel 257A formed in and by another ear or tab 255A formed in and by the bottom plate 250B. The scissor arm 64A is likewise rotationally coupled at one end to the ear or tab 253A formed in and by the bottom plate 250B, and is slidably coupled to and within a channel 256A formed in and by another ear or tab 254A formed in and by the top plate 250A. The arms 62B, 64B of the scissor structure 60B are similarly coupled to and between ears or tabs 253B, 254B and 252B, 255B respectively, wherein the ears or tabs 254B, 255B defined respective channels 256B, 257B along which respective ends of the arms 64B, 64A respectively move.

In the illustrated embodiment, a pivot rod 260 extends between the scissor structures 60A, 60B and acts as the pivot structure about which the respective scissor arms 62A, 64A and 62B, 64B pivot. A guide rod 262 extends between the forward ends of the respective scissor arms 64A, 64B, and is coupled to each scissor arm 64A, 64B so as to guide the respective ends of the scissor arms 64A, 64B along the respective channels 256A, 256B formed in the respective ears or tabs 254A, 254B of the top plate 250A. The rods 260, 262 thus extend laterally across the seat base 20D between the respective components of the scissor structures 60A, 60B. Also in the illustrated embodiment, lateral support members 259A, 259B and 259C are coupled to and between respective arms of the scissor structures 60A, 60B such that the support members 259A, 259B and 259C each extend laterally across the seat base 20D between the respective components of the scissor structures 60A, 60B. In the illustrated embodiment, such rods 260, 262 and support members 259A-259C operate to simultaneously guide movement of the scissor structures 60A, 60B between the fully deployed state illustrated by example in FIGS. 6A, 6C, 6D and 6H to the collapsed state illustrated by example in FIGS. 6E, 6F and 6I. In some alternate embodiments, the rod 260 and/or the rod 262 may be replaced by two pins each coupled to a respective one of the arms of the scissor structures 60A, 60B, and/or one or more of the support members 259A-259C may be omitted.

The seat base 20D illustratively includes a pair of guide rails 270A, 270B adjacent to a respective ear or tab 254A, 254B. The guide rails are illustratively “U” or “C” shaped with hard corners, and are mounted such that generally parallel and spaced apart side walls extend along, i.e., parallel with, the ears or tabs 254A, 254B, and such that the generally parallel and spaced apart side walls define a space 271 therebetween. The guide rails 270A, 270B are illustratively identical to one another, and therefore it will be understood that the structures described with respect to the guide rail 270A apply equally to the guide rail 270B. As best shown in FIG. 6A, the side walls 273A, 273B of the guide rail 270A each define a respective channel 272A, 272B therein, wherein each channel 272A, 272B extends parallel to, and are thus aligned with, the channel 256A formed through the ear or tab 254A such that the rod 262 extends through each of the channels 272A, 272B, 256A and into rotational engagement with the scissor arm 64A adjacent to a respective end thereof. The opposite end of the rod 262 likewise extends through two corresponding channels formed through the guide rail 270B, through the channel 256B formed through the ear or tab 254B and into rotational engagement with the scissor arm 64B adjacent to a respective end thereof. Movement of the rod 262 is thus guided by and along all such channels as the seat base 20D transitions from the fully deployed state to the collapsed state.

As best shown in FIG. 6D, an embodiment of a blast attenuation structure 280 is mounted to the guide rail 270A in the space 271 defined between the side walls 273A, 273B of the guide rail 270A. In some embodiments, an identical blast attenuation structure 280 is operatively mounted to and within the guide rail 270B. It will be understood that the structure and operation of the blast attenuation structure 280 mounted to and within the guide rail 270A applies equally to the blast attenuation structure 280 mounted to and within the guide rail 270B. In some alternate embodiments, only a single guide rail 270A or 270B and blast attenuation structure 280 may be mounted to the top plate 250A, e.g., centrally between the respective ears or tabs 254A, 254B.

In the illustrated embodiment, the blast attenuation structure 280 includes an elongated housing 282 mounted to, i.e., attached or affixed to, the guide rail 270A within the space 271 defined between the side walls 273A, 273B. The housing 282 is illustratively mounted within the space 271 to either or both of the side walls 273A, 273B and/or to the top wall of the guide rail 270A which extends between the side walls 273A, 273B. A piston 284 includes a piston rod 284A having one end coupled to, or integral with, a piston head 284B which is housed within a channel 285 formed in and by the housing 282. An opposite end of the piston rod 284A extends outwardly away from the housing 282, and is coupled, i.e., attached, to a guide block 286. The guide block 286 defines a bore therethrough sized to receive the guide rod 262 such that the guide rod 262 passes through the guide block 286 within the space 271 defined between the side walls 273A, 273B of the guide rail 270A. In the illustrated embodiment, a mass 288 is formed at least partially about at least a portion of the piston head 284B and at least a portion of the piston rod 284A adjacent to the piston head 284B. In the blast attenuation mode of the seat base 20D and prior to any under-vehicle explosion, the piston 284 is illustratively positioned within the housing 282 such that the guide block 286 is positioned at or near rear terminal ends of the channels 272A, 272B and 256A. The blast attenuation structure 280 thus positions the scissor structures 60A, 60B in their fully deployed positions to maintain maximum spacing between the top and bottom plates 250A, 250B as described above with respect to the embodiments 20A, 20B and 20C of the seat base 20D. In the illustrated embodiment, the housing 282 and the mass 288 are together configured so as to deform the housing 282, thereby absorbing energy, under forces applied to the seat base 20D during an under-vehicle explosion event which causes the scissor structures 60A, 60B to pull the guide rod 262, and thus the guide block 286, forwardly along the channels 256A, 272A, 272B which, in turn pulls the piston 284 forwardly to cause the deformation, as will be described in greater detail below.

Referring now specifically to FIGS. 6B and 6C, a mode control assembly 290 is configured to control reconfiguration of the seat base 20D from the blast mitigation operating mode to the seat pull down operating mode. In the illustrated embodiment, the mode control assembly 290 includes a pair of brackets 292A, 292B each coupled, i.e., attached, to a latch 294A, 294B, wherein the latch 294A, 294B is configured to selectively engage/disengage a respective one of the guide rails 270A, 270B. As best shown in FIGS. 6B and 6G, the latches 294A, 294B are illustratively provided in the form of tabs, each being generally square or rectangular in cross-section, and configured to extend into correspondingly configured slots formed into or through the inwardly-facing side wall 273A of the guide rails 270A, 270 as best shown in FIGS. 6C, 6H and 6I. Control arms 296A, 296B, e.g., in the form of guide rods, cables or tethers, are coupled to and between the brackets 292A, 292B respectively and a guide pin 298. As best shown in FIGS. 6C, 6H and 6I, the top plate 250A defines a slot 269 approximately centrally therethrough, and the guide pin 298 extends upwardly through the slot 269 to a top side of the top plate 250A. Another ear or tab 265 is formed by the top plate 250A, and illustratively extends downwardly to form an opening 267 adjacent thereto. Illustratively, the opening 267 and the ear or tab 265 are aligned with the slot 269, e.g., formed approximately centrally through the top plate 250A, and the end of the web or tether 24 extending upwardly through the opening OP in the bottom plate 250B further extends upwardly through the opening 267 and into engagement with the guide pin 298 along the top surface of the top plate 250A. In the blast attenuation or mitigation operating mode of the seat base 20D, the guide pin 98 is positioned forwardly within the slot 269, e.g., to the front terminal end of the slot 269, as best shown in FIG. 6C, and in this position the latches 294A, 294B extend into the slots 274A of the guide rails 270A, 270B respectively to lock the position of the guide rails 270A, 270B relative to the top plate 250A (i.e., due to engagement of the guide pin 298 with the forward terminal end of the slot 269) so as to maintain the top plate 250A suspended by the scissor structures 60A, 60B above the bottom plate 250B. In some embodiments, one or more biasing members may be included to bias the brackets 292A, 292B and/or the control arms 296A, 296B to the locked position in which the latches 294A, 294B extend into the slots 274A formed in the side wall 273A of the guide rails 270A, 270B.

Referring specifically to FIGS. 6A-6D, the seat base 20D is shown in a configuration in which it is operable in the blast attenuation or mitigation mode. Illustratively, this is the normal or default operating mode of the seat base 20D during normal operating conditions of the motor vehicle in which the seat base 20D and the seat 12 are mounted; i.e., during conditions in which no under-vehicle explosion is present, in which a rollover and/or impact of the motor vehicle is not occurring or imminent, wherein the latter two conditions are illustratively determined by the control circuit 26 based on signals produced by the sensor 30 as described above. In the blast attenuation or mitigation mode, the blast attenuation structures 280 are fully retracted (i.e., not deformed) such that guide blocks 286, and thus the guide rod 262, are maintained rearwardly in, e.g., at or adjacent to the rearward terminal ends of, the slots 272A, 272B formed in the walls 273A, 273B of the guide rails 270A, 270B, and the latches 294A, 294B extend into the slots 274A of the guide rails 270A, 270B respectively to lock the position of the guide rails 270A, 270B relative to the top plate 250A so as to maintain the guide rod 262 rearwardly in, e.g., at or adjacent to the rearward terminal ends of, the slots 256A, 256B formed in the ears or tabs 254A, 254B of the top plate 250A. As a result, the seat base 20B is maintained at its maximum height, e.g., the height H1 depicted by example in FIG. 3B. It will be understood that whereas the seat base 20B is illustrated and described as having two blast attenuation structures 280, alternate embodiments may include more or fewer such blast attenuation structures 280.

In the blast attenuation or mitigation operating mode, the seat pulldown device 22 is in a normal (e.g., default) and unactuated state in which the device 22 is not actively applying tension to the web or tether 24, and the web or tether 24 is thus at its maximum length between the seat pulldown device 22 and the guide pin 298 so as to maintain the latches 294A, 294B engaged with the guide rails 270A, 270B as described above. In the event of an under-vehicle explosion, the blast attenuation structures 280 are configured to deform in a manner which absorbs energy from the explosion. In the embodiment illustrated by example in FIGS. 6D and 6E, the blast attenuation structures 280 illustratively include the mass 288 and deformable housing 282 as described above. In response to an under-vehicle explosion, blast forces F_{B} acting upwardly against the bottom plate 250B and occupant forces acting downwardly against the top plate 250A will force the top and bottom plates 250A, 250B toward one another, thereby causing the scissor structures 60A, 60B to likewise compress and, in turn, move the guide rod 262 forwardly along the slots 256A, 256B and 272A, 272B. Such forward movement of the guide rod 262 pulls the guide blocks 86, and thus the piston rod 284A, forwardly along the channels 272A, 272B formed in the side walls 273A, 273B of the guide rails 270A, 270B, thereby causing the masses 288 to deform the housings 282 as the piston heads 284B move forwardly along, and relative to, the guide rails 270A, 270B, as illustrated by example in FIG. 6E.

The amount or degree of deformation of the blast attenuation structures 280 and resultant compression of the seat base 20D will generally depend on, and thus be a function of, a number of factors including, but not limited to, the magnitude and direction of upward force, F_{B}, applied by the blast or explosion to the bottom plate 250B, the magnitude and direction of downward force, F_{O}, applied by the occupant of the seat 12 to the top plate 250A during the explosion (which will generally be a function of a number of occupant metrics including, for example, the weight of the occupant), the number of blast attenuation structures 280 implemented (two in the illustrated embodiment), and the deformation rate and/or other physical deformation-determining characteristics of the blast attenuation structures 280. In the example depicted in FIG. 6E, the under-vehicle explosion resulted in full and complete compression of the seat base 20D, although it will be understood that other under-vehicle explosions may result a lesser amount of compression of the seat base 20D. It will be understood that whereas the example of FIG. 6E depicts uniform compression of the seat base 20D, this depiction is provided only by way of example, and some under-vehicle explosions, depending on their distance from and angle relative to the seat base 20D, may non-uniformly compress plates 250A, 250B. The structure and operation of the scissor structures 60A, 60B with the inclusion of the single scissor rod 260, the inclusion of the lateral support structures 259A-259C along with the single guide rod 262, on the other hand, will illustratively mitigate any such non-uniform compression by forcing the two plates 250A, 250B of the seat base 20D to compress somewhat more uniformly.

Referring to FIG. 6F, an alternate embodiment of the blast attenuation structures 280′ is shown in the same post-deployment state shown in FIG. 6E. The blast attenuation structure 280′ is identical in many respects to the blast attenuation structure 280 illustrated in FIGS. 6D-6E and described above, and like numbers are therefore used to identify like components. The blast attenuation structure(s) 280′ differ from the blast attenuation structure(s) 280 primarily in the deformation structure(s). In the embodiment illustrated in FIG. 6F, for example, the mass 288 is replaced with a mass 288′ of uniform circumference sized to move along and relative to the channel 285 of the housing 282 without deforming the housing 282, including a cutting structure 281 configured to cut into and/or cut through the housing 282 as the piston 284 is pulled along the channels 272A, 272B as described above. In this embodiment, the material used for the housing 282 and the cutting structure 281, as well as the sharpness of the cutting structure 281, will be selected to achieve a desired energy absorption by the blast attenuation structure(s) 280′ during an under-vehicle explosion.

Referring now specifically to FIGS. 6G-6J, reconfiguration of the seat base 20D from the blast attenuation or mitigation operating mode to the seat pulldown operating mode and subsequent operation of the seat base 20D during the seat pulldown operating mode is shown. With the seat base 20D in the blast attenuation or mitigation operating mode as illustrated by example in FIGS. 6A-6D and described above, the control circuit 26 is continually operable to execute instructions stored in the memory unit 28 to monitor the signal(s) produced by the sensor 30. Upon detection of a sufficiently imminent rollover and/or vehicle impact event, the instructions stored in the memory unit 28 include instructions executable by the control circuit 26 to produce an activation signal to activate the seat pulldown device 22. The seat pulldown device 22 is responsive to the activation signal to draw the web or tether 24 downwardly away from the top plate 250A in the direction D1 which, in turn, causes the portion of the web or tether 24 between the ear or tab 265 and the guide pin 298 to move in the direction D2 away from the guide pin 298, thereby drawing the guide pin 298 rearwardly along the channel 269 until the guide pin reaches the rear terminal end of the channel 269, as depicted by example in FIG. 6H. Such rearward movement of the guide pin 298 is translated through the control arms 296A, 296B so as to draw the brackets 292A, 292B away from the wide walls 273A of the guide rails 270A, 270B, and thus draw the latches 294A, 294B out of the slots 274A formed in the side walls 273A of the guide rails 270A, 270B, as depicted by example in FIGS. 6G and 6H.

With the guide pin 98 positioned against the rear terminal end of the channel 269 and the latches 294A, 294B released from the slot 274A formed in the side wall 273A of the guide rails 270A, 270B as illustrated by example in FIGS. 6G and 6H, continued movement of the web or tether 24 in the downward direction D1 forces the guide shaft 262 to move forwardly along the channels 256A, 256B defined through the ears or tabs 254A, 254B of the top plate 250A. Because the blast attenuation structures 280 remain undeformed, the guide rod 262 remains against the rear terminal ends of the channels 272A, 272B formed in the side walls 273A, 273B of the guide rails 270A, 270B, and thus the guide rails 270A, 270B are forced forwardly relative to the top plate 250A by the guide rod 262 moving along the channels 256A, 256B as the top plate 250A collapses downwardly to the bottom plate 250B in response to the collapsing scissor structures 60A, 60B, as illustrated by example in FIGS. 6I and 6J.

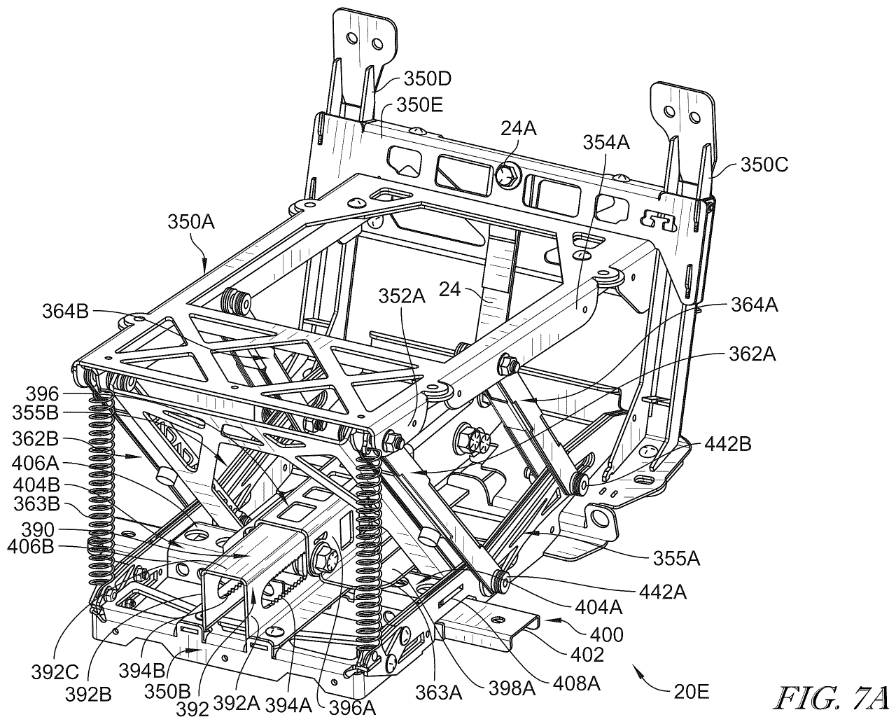

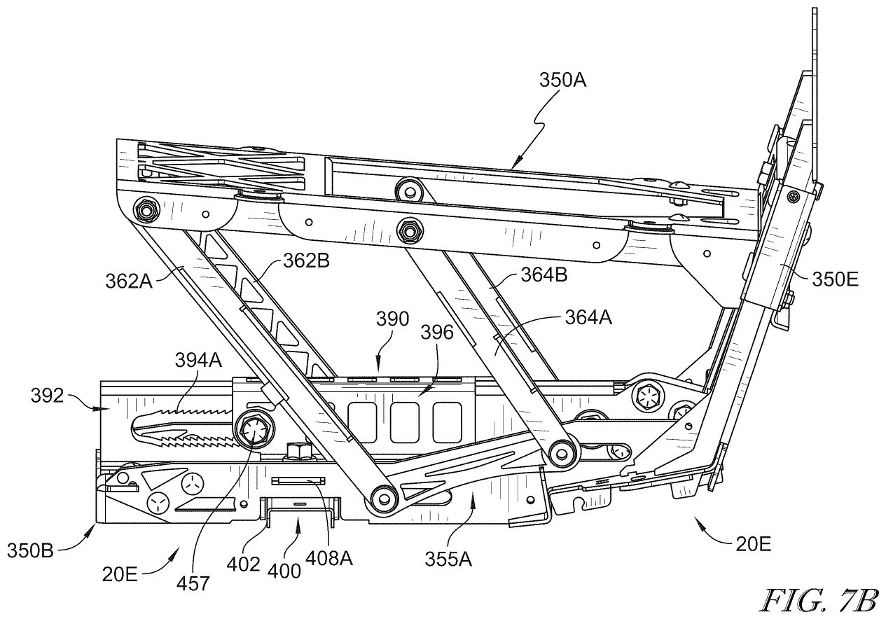

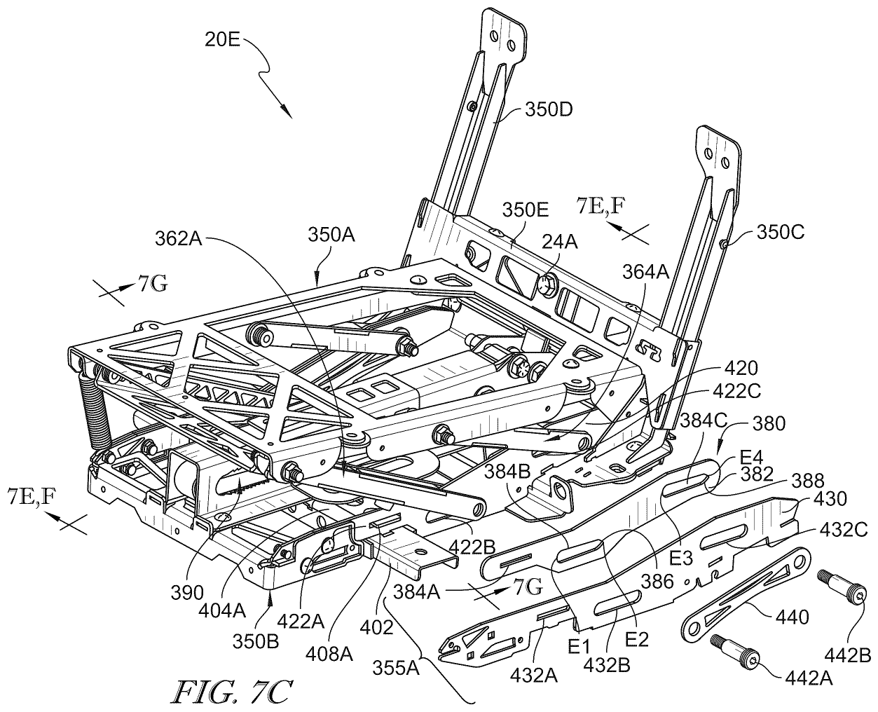

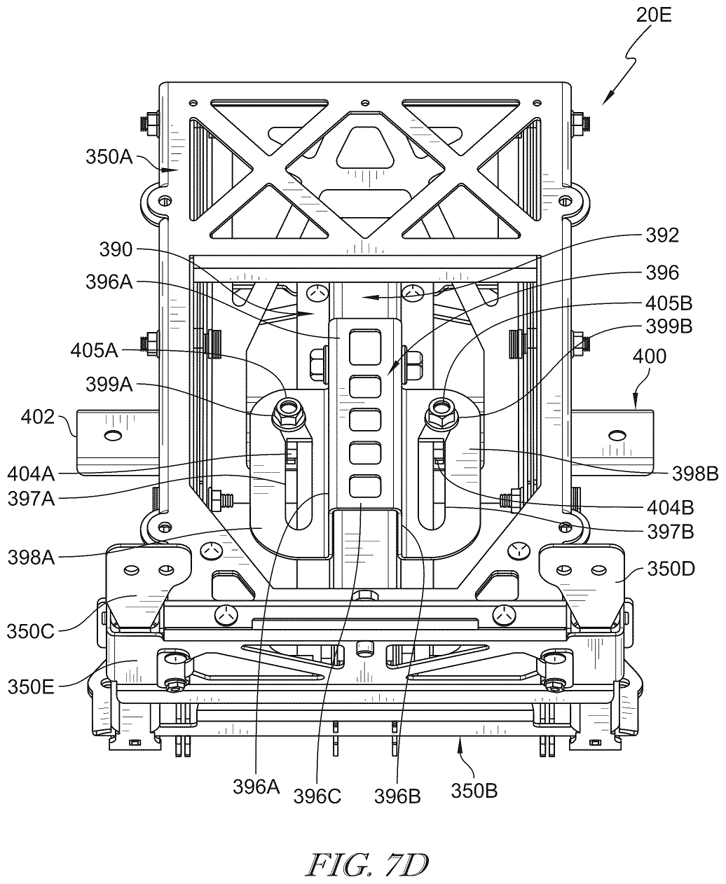

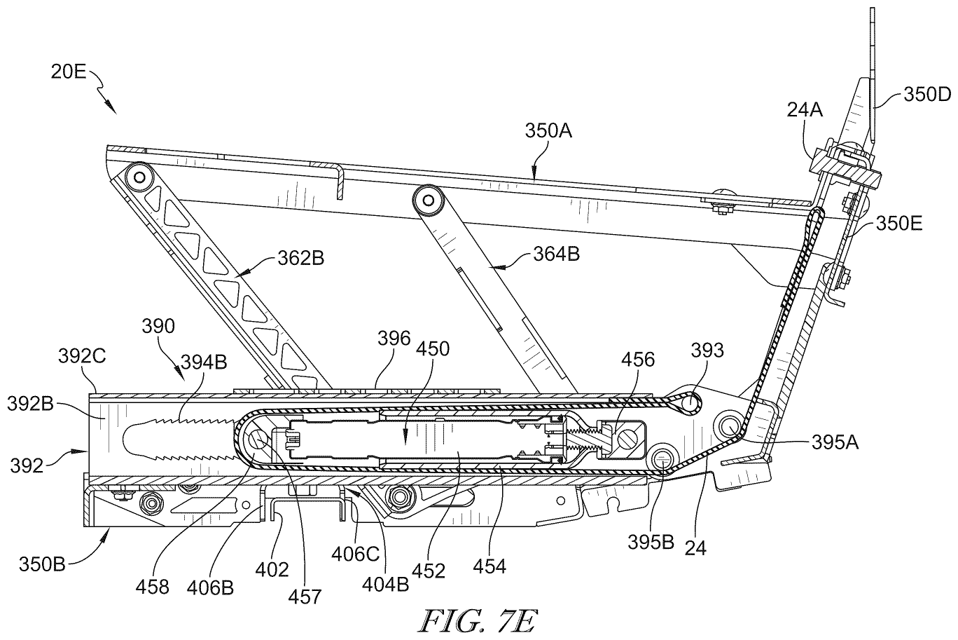

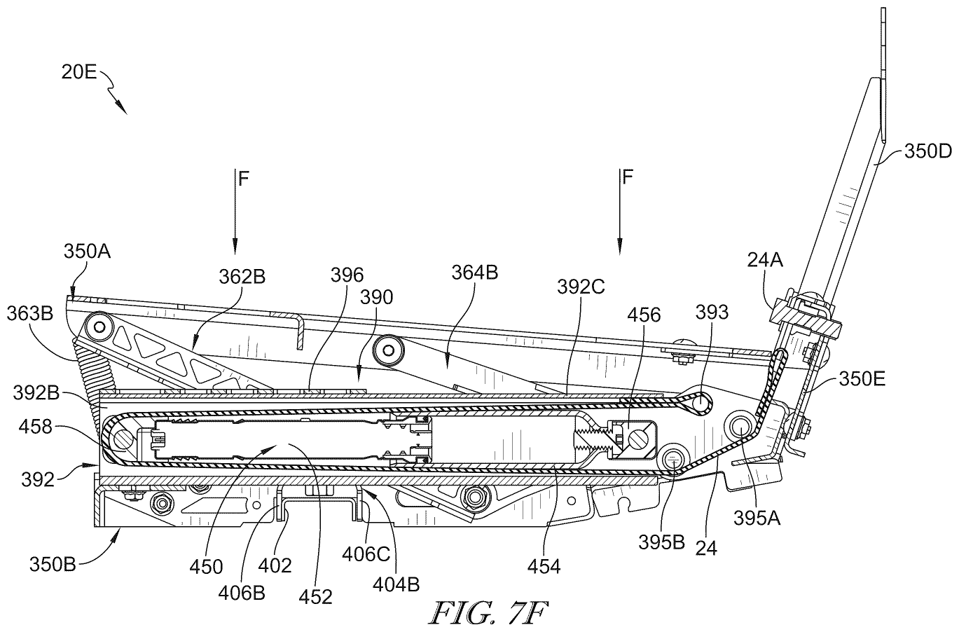

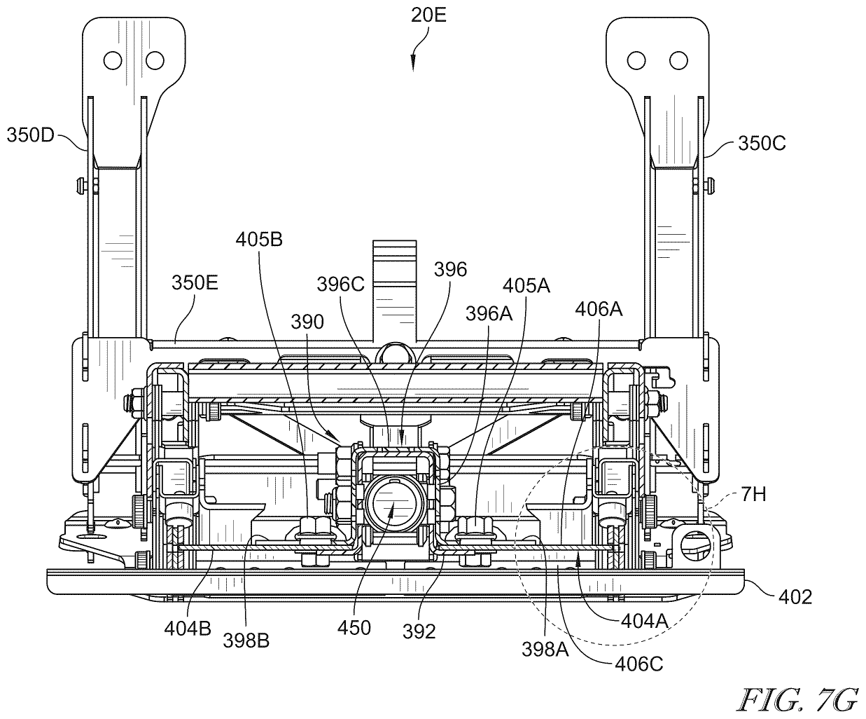

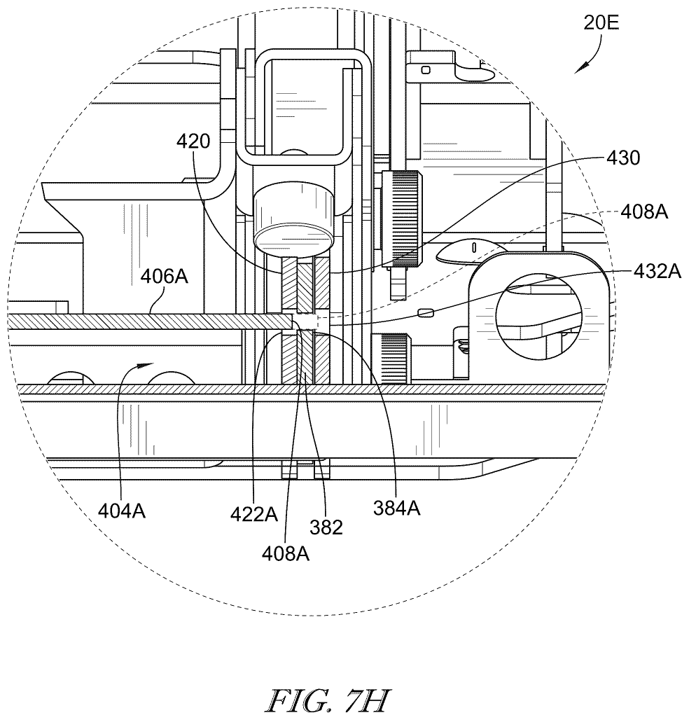

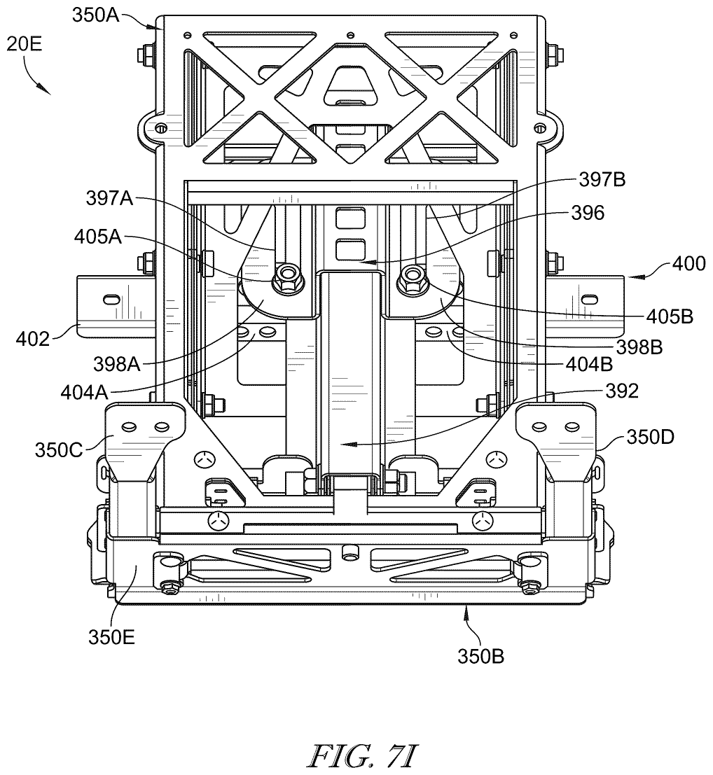

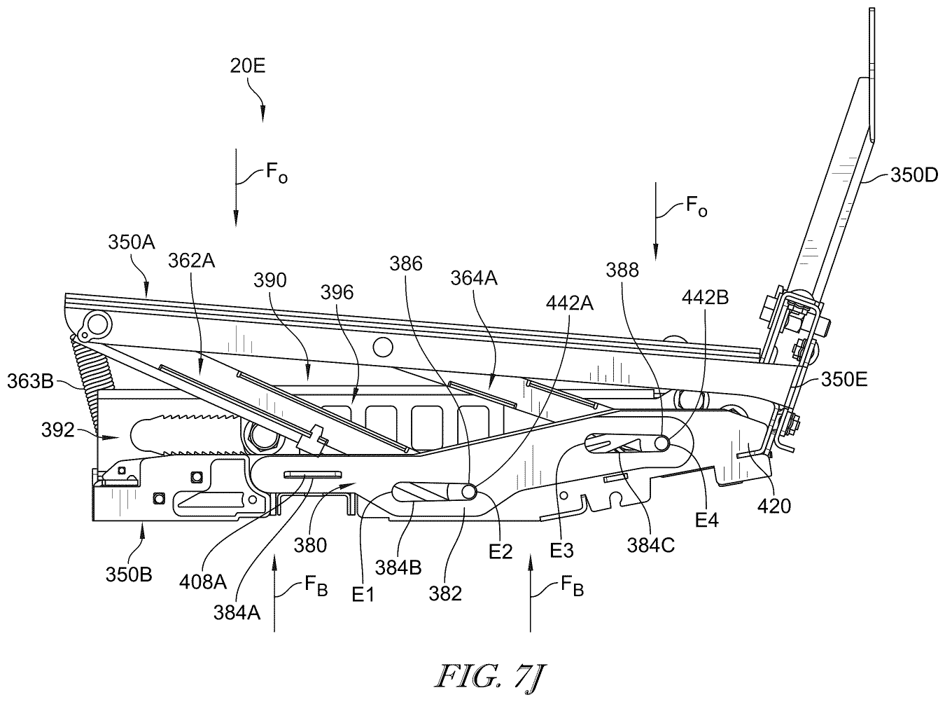

Referring now to FIGS. 7A-7J, yet another embodiment 20E of the seat base 20 of FIGS. 1 and 2 is shown. In the illustrated embodiment, the seat base 20E includes a top frame assembly 350A configured to be coupled directly to the seat frame 15 beneath the seat bottom 14, or to the seat bottom 14 in embodiments in which the seat frame 15 is integral with the seat bottom 14. In some alternate embodiments, the top frame assembly 350A may be indirectly coupled to the seat frame 15 and/or seat bottom 14 via one or more intermediate structures, e.g., one or more additional seat bases, a seat height adjustment structure, a seat pivoting or other structure, and/or the like. In any case, it will be understood that the top frame assembly 350A is shown only by way of example, and that in alternate embodiments the top frame assembly 350A may take the form of any conventional top member 350A configured to operatively couple to one or more blast attenuation structures and to operatively couple to a seat pulldown structure as described below.

A bottom frame assembly 350B is vertically spaced apart from the top frame assembly 350A, and the bottom frame assembly 350B is configured to be coupled directly to the floor F of the motor vehicle (see, e.g., FIGS. 1 and 2). It will be understood that the bottom frame assembly 350B is shown only by way of example, and that in alternate embodiments the bottom frame assembly 350B may take the form of any conventional bottom member 350B configured to operatively couple to one or more blast attenuation structures and to operatively couple to a seat pulldown structure as described below.

In the illustrated embodiment, the top and bottom frame assemblies 350A, 350B are substantially parallel with one another, although in alternate embodiments the frame assemblies 350A, 350B may not be parallel with one another. The seat base 20E formed by the top and bottom frame assemblies 350A, 350B together have a front, rear left side and right side as illustrated and described above with respect to one or more of the embodiments illustrated in the attached figures and described above. In the embodiment illustrated in FIGS. 7A-7J, the rear side of the seat base 20E includes two seat mounting structures 350D, 350C each mounted at one end to the bottom frame assembly 350B and extending upwardly away from the seat base 20E at or near opposite sides of the seat base 20E. The seat mounting structures 350D, 350E are each configured to mount the seat base to a raised and forwardly-facing surface of the floor of the motor vehicle. In some embodiments, the seat base 20E is intended to mount rear, passenger seats in the motor vehicle, although it will be understood that the seat base 20E is not strictly limited to such mounting locations. In any case, the seat base 20E further includes a rear cross-member, e.g., a frame structure, fixed to the rear of the top frame assembly 350A, and slidably movable relative to the seat mounting structures 350C, 350D, such that the top frame assembly 350A and the rear cross-member 350E move together relative to the bottom frame assembly 350B between raised and lowered or compressed positions as will be described below. As best seen in FIGS. 7A, 7C, 7E, and 7F, one end of a flexible web or tether 24 is mounted via at least one fixation member 24A to the rear cross-member 350E to provide an anchor point for pulling the top frame assembly 350A downwardly toward the bottom frame assembly in the seat pulldown mode as will be described below.

The bottom frame assembly 350B includes two bottom side frame assemblies 355A, 355B each disposed along opposite sides of the bottom frame member 350B, and the top frame assembly 350A includes two top side frame assemblies each extending along a respective side of the top frame assembly 350A. As illustrated by example in FIG. 7A, the top side frame assemblies each include a front ear 352A and a flange 354A rearwardly of the ear 352A. The bottom side frame assembly 355A is configured to operatively mount to one end of a front pair of scissor arms 362A and also to one end of a rear pair of scissor arms 364A. The bottom side frame assembly 355B is likewise configured to operatively mount to one end of a front pair of scissor arms 362A and also to one end of a rear pair of scissor arms 364A. As will be described in further detail below, the bottom side frame assemblies 355A and 355B define slots therethrough, and the scissor arms 362A, 362B, 364A, 364B are configured to mount to the top ears 352A and the flanges 352B respective of the top side frame assemblies, and also to the bottom side frame assemblies 355A, 355B such that the respective top ends of the scissor arms 362A, 362B pivot relative to the top ears 352A and the top ends of the scissor arms 364A, 364B pivot relative to the flanges 352B, and such that the respective bottom ends of the scissor arms 362A, 362B, 364A, 364B slide along respective ones of the slots, as the top frame assembly 350A is pulled or forced downwardly toward the bottom frame assembly 350B in the seat pulldown mode or blast attenuation mode respectively. As depicted by example in FIG. 7A, coil springs 363A, 363B illustratively extend between the top frame assembly 350A and the bottom frame assembly 350B on opposite sides of the seat base 20E along the front edge thereof. The springs 363A, 363B are illustratively in tension in the extended or up position of the seat base 20E so as to provide a downward bias to assist in the pulldown or collapse of the seat base 20E during the seat pulldown and blast attenuation modes, respectively. In some embodiments, the springs 363A, 363B may be omitted. One or both of the springs 363A, 363B are not shown in the remaining FIGS. 7B-7J so as not to obscure other components of the seat base 20E.

As best seen in FIG. C, the components of the bottom side frame assembly 355A are shown in exploded view, and it will be understood that the bottom side frame assembly 355B is identical in structure and function. The bottom side frame assembly 355A includes a frame member 420 fixedly coupled to the front and rear frame components of the bottom frame assembly 350B. The frame member 420 defines a slot 422A therethrough toward the front end of the frame member 420. The frame member 420 also defines two additional slots 422B and 422C, wherein the slot 422C is spaced apart from the rear end of the bottom frame assembly 355A, and the slot 422B is positioned between the slots 422A and 422C.

The slot 422A defined through the frame member 420 is sized to receive therethrough a tongue member 408A extending from an end of a movable frame component 404A which forms part of a mode control assembly 390. The movable frame component 404A rides on a sleeve 402 which extends laterally through the bottom side frame assemblies 355A, 355B, and an identical movable frame component 404B likewise rides on the sleeve 402 toward and away from a frame member 420 of the bottom side frame assembly 355B such that an identical tongue member 408A is received through an identical slot 422A of the bottom side frame assembly 355B.

As best seen in FIGS. 7A, 7B, and 7E-7G, the movable frame components 404A, 404B are each illustratively C-shaped in cross-section, and include a generally horizontal top wall 406A and side walls 406B, 406B extending downwardly away from respective sides of the top wall 406A. The sleeve 402 is similarly configured but smaller in cross-sectional area such that the movable frame components 404A, 404B fit over and onto the sleeve 402 adjacent to each respective bottom side frame assembly 355A, 355B as depicted by example in FIG. 7F. The sleeve 402 and the movable frame components 404A, 404B together form an actuator arm assembly 400 of the mode control assembly 390 as will be described further below.

The bottom side frame assembly 355A includes another frame member 430 spaced apart from the frame member 420 and defining slots 432A, 432B, and 432C therethrough which align with the slots 422A, 422B, and 422C respectively of the frame member 420. A blast attenuation structure 380 is provided in the form of another frame member 382 defining slots 384A, 384B, and 384C which align with the slots 422A, 432A, slots 422B, 432B, and slots 422C, 432C respectively of the frame members 420 and 430, respectively. The slot 348B has a front terminal end E1 and a rear terminal end E2, and the slot 348B has a portion 386 near the rear terminal end E2 that tapers downwardly to define tapered upper and lower walls. The slot 348C likewise has a front terminal end E3 and a rear terminal end E4, and the slot 348B has a portion 388 near the rear terminal end E4 that tapers downwardly to define tapered upper and lower walls. The frame member 382 is positioned between the two frame members 420 and 430 such that all of the aforementioned slots align with one another, and a two fixation members 442A, 442B extend through a stabilization plate 440 and into engagement with the frames 430, 832, 420 and the two pairs of scissor arms 362A, 362B. As further depicted by example in FIGS. 7A and 7B, the fixation member 442A, illustratively in the form of a threaded bolt, extends through an outer one of the scissor arms 362A, then through the stabilization plate 440, then through the slot 432B, then through the slot 384B, then through the slot 422B, and then into engagement with an inner one of the scissor arms 362A. The fixation member 442B illustratively in the form of another threaded bolt, similarly extends through an outer one of the scissor arms 364A, then through the stabilization plate 440, then through the slot 432C, then through the slot 384C, then through the slot 422C, and then into engagement with an inner one of the scissor arms 364A.

As the top frame member 350A is pulled down or collapses toward the bottom frame member 350B, the scissor arm 362A simultaneously rotates relative to the ear 352A of the top frame member 350A and slides rearwardly, on the body of the fixation element 442A, along the aligned slots 432B and 422B, and the scissor arm 364A simultaneously rotates relative to the flange 352B of the top frame member 350A and slides rearwardly, on the body of the fixation element 442B, along the aligned slots 432C and 422C. As depicted by example in FIGS. 7A, 7B, 7H, and 7J, with the tongue members 408A of the movable frame components 404A, 404B of the actuator arm assembly 400 extending into the slot 384A of the frame member 382 defining the blast attenuation structure 380, the fixation elements 442A, 442B also slide along the slots 384B, 384C and are forced into the deformable tapered end portions 386, 388 of the of the frame member 382, thereby deforming the tapered end portions 386, 388 causing them, in the process, to absorb energy from the blast. The tongue member 408A extending into the slot 384A, as best seen in FIG. 7H, thus represents the position of the actuator arm assembly 400 in the blast attenuation mode of the mode control assembly 390. In contrast, and as depicted by example in FIGS. 7C and 7E-7I, with the tongue members 408A pulled free of the slot 384A of the frame member 382 defining the blast attenuation structure 380, the fixation elements 442A, 442B sliding along the slots 384B, 384C push the frame member 382 rearwardly as the fixation elements 442A, 442B reach the tapered end portions 386, 388, thus allowing the fixation elements 442A, 442 to travel, unimpeded by the tapered slots 384B, 384C, to the rear ends of the slots 422B, 432B and 422C, 432C. The tongue member 408A drawn away from and out of the slot 384A, as also best seen in FIG. 7H, thus represents the position of the actuator arm assembly 400 in the seat pulldown mode of the mode control assembly 390.

Referring now specifically to FIGS. 7A, 7B, 7D, and 7G-7I, the mode control assembly 390 further includes, in addition to the actuator arm assembly 400 described above, an actuator chamber or housing 392 and an actuator sleeve 396 operatively coupled to and between the actuator arm assembly 400 and an electrically controlled actuator 450 carried by the actuator chamber or housing 392. The actuator chamber or housing 392 is secured to the bottom frame assembly 350B such that the position of the actuator chamber or housing 392 is fixed relative to the bottom frame assembly 350B. The actuator chamber or housing 392 is an elongated chamber or housing which is illustratively square or rectangular cross-section so as to define spaced-apart upstanding side walls 392A, 392B joined at their top ends by a top wall 392C, wherein the side walls 392A, 392B and the top wall 392C together define an interior space in which the actuator 450 is housed (see, e.g., FIGS. 7E and 7F and described in detail below). The side walls 392A, 392B each define a respective elongated slot 394A, 394B therethrough extending toward a front end of the chamber or housing 392.

The actuator sleeve 396 is also illustratively an elongated chamber or housing having spaced-apart upstanding side walls 396A, 396B joined at their top ends by a top wall 396C so as to define an interior space in which sized slightly larger than the exterior profile of the actuator chamber or housing 390 such that the actuator sleeve 396 is positioned over and onto the actuator chamber or housing 390, i.e., such that the side walls 392A, 392B and the top wall 392C of the actuator chamber or housing 392 are received within the space defined by the side walls 396A, 396B and the top wall 396C of the actuator sleeve 306. The actuator sleeve 396 secured to the actuator 450 via a fixation member 457 which extends through the actuator sleeve 396, through the elongate slots 394A, 394B, and through one end of the actuator 450 (see, e.g., FIG. 7E), such that the actuator sleeve 396 is movable by the actuator 450 axially along the actuator chamber or housing 392 between the opposite terminal ends of the slots 394A, 394B. In the illustrated embodiment, the slots 394A, 394B are toothed or otherwise profiled along their edges in a manner which prevents or impedes reverse movement of the actuator 450, i.e., toward the rear of the seat base 20E. In some alternate embodiments, depending upon the type and configuration of the actuator 450 used, such profiled edges may not be necessary and may be omitted.

As best seen in FIGS. 7A, 7D, and 7I, flanges 398A and 398B extend laterally away from the bottom ends of each respective side of the actuator sleeve 396. The flanges 398A, 398B each define profiled channels or slot 397A, 397B respectively therethrough. A fixation element 405A extends through the channel or slot 397A and secures the flange 398A to the top wall 406A of the movable frame component 404A while also allowing for travel of the fixation element 405A along the channel or slot 397A as the actuator sleeve 396 moves axially along the actuator chamber or housing 392 under force of the actuator 450 as briefly described above. Another fixation element 405B extends through the channel or slot 397B and secures the flange 398B to the top wall 406A of the movable frame component 404B while also allowing for travel of the fixation element 405B along the channel or slot 397B as the actuator sleeve 396 moves axially along the actuator chamber or housing 392 under force of the actuator 450. In one embodiment, the fixation elements 405A, 405B are nut and bolt combinations, although in alternate embodiments other conventional fixation elements or members may be used. In any case, as best seen in FIG. 7D, the channels or slots 397A, 397B are generally linear toward the rear of the seat base 20E, but then flare outwardly toward the respective bottom side frame assemblies 355A, 355B at respective forward sections 399A, 399B of the slots 397A, 397B.

As the movable frame components 404A, 404B are movable laterally along the sleeve 402 as previously described, it is the position of the fixation elements 405A, 405B within the channels or slot 397A, 397B which determine the position of the tongue members 408A of the movable frame components 404A, 404B, i.e., whether the tongue members 408A are positioned within the slots 384A of the blast attenuation structures 380 or are withdrawn or drawn away from the slots 384A of the blast attenuation structures 380, as briefly described above. In FIG. 7D, for example, the seat base 20E is in the up or raised position (normal seating position) illustrated in FIGS. 7A, 7B, and 7E, and in this position the actuator 450 is in an unactuated or deactuated state such that the actuator sleeve 396 is in its most rearward position. In this position of the actuator sleeve 396, the fixation elements 405A, 405B are positioned at or adjacent to the most forward terminal ends of the channels or slots 397A, 397B so as to each reside in the most forward portions of the outwardly flared sections 399A, 399B of the channels or slots 397A, 397B. This position of the fixation elements 405A, 405B forces the movable frame components 404A, 404B laterally outwardly toward the respective bottom side frame members 355A, 355B and forces the respective tongue members 408A through the slots 422A of the frame members 420 and into the slots 384a of the blast attenuation structures 380 (see, e.g., dashed line representation of tongue members 408A in FIGS. 7G and 7H). In FIG. 7I, in contrast, the seat base 20E is in the lowered position illustrated in FIGS. 7F-7I), and in which this lowered position results from actuation of the actuator 450 when operating in the seat pulldown mode. As the actuator 450 is actuated, the actuator sleeve 396 is forced forwardly by the force of the actuator 450 acting on the fixation member 457 as briefly described above. The resulting forward motion of the actuator sleeve 396 moves the fixation elements 405A, 405B from the flared sections 399A, 399A into the linear sections of the channels or slots 397A, 397B and, eventually to or adjacent to the rear terminal ends of the channels or slots 397A, 397B as illustrated by example in FIG. 7I. Such movement of the fixation elements 405A, 405B rearwardly along the channels or slots 397A, 397B forces the movable frame components 404A, 404B laterally inwardly away from the respective bottom side frame members 355A, 355B and forces the respective tongue members 408A away from and out of the slots 384a of the blast attenuation structures 380 (see, e.g., solid line representation of tongue members 408A in FIGS. 7G and 7H), which effectively disables the deformation capabilities of the blast attenuation structures 380 in the seat pulldown mode, as described above.

Referring now specifically to FIGS. 7E and 7F, further details of the mode control assembly 390 are shown; specifically, the actuator assembly including the actuator 450 carried by the actuator chamber or housing 392 and operative coupling of the actuator 450 to the actuator chamber or housing 392, to the actuator sleeve 396, and to the web or tether 24. In the illustrated embodiment, the actuator 450 is provided in the form of a conventional linear, pyrotechnic actuator controllable, via one or more electrical control signals, from an unactuated state (illustrated by example in FIG. 7E) to an actuated state (illustrated by example in FIG. 7F). It will be understood that the linear, pyrotechnic actuator 450 illustrated in FIGS. 7E and 7F represents only one example embodiment, and that in alternate embodiments one or more other conventional actuators, linear, rotational, or other configuration, and/or non-pyrotechnic, and/or resettable or non-resettable, may be implemented in the seat base 20E. It will be further understood that the actuator 450 is part of the seat pulldown device 22 described above with respect to the previous embodiments illustrated in FIGS. 3A-6J, and in this regard it will be still further understood that, although not specifically illustrated in FIGS. 7A-7J, electrical or electronic control components that are also part of the seat pulldown device 22 and configured for controlling, i.e., actuating, the actuator 450 will be operatively coupled to the actuator 450 as described above with respect to FIGS. 1A and/or 1B, and further illustrated and described in FIGS. 3A-6J.

As illustrated by example in FIGS. 7E and 7F, the actuator 450 illustratively includes a gas-filled piston 452 carried and sealed within an actuator housing 454, and the housing is fixedly attached to the actuator chamber or housing 392 (and thus to the bottom frame assembly 350B) at a rearwardly-facing end 456 of the actuator 450. A nose piece 458 is attached to the forwardly-facing end of the piston 452, and the nose piece 458 illustratively carries the electrically controllable pyrotechnic actuator for actuating the actuator 450. As best shown in FIG. 7E, the fixation member 457 (also illustrated in FIG. 7B) extends through the nose piece 458. Upon actuation of the actuator 450, gas is expelled from the piston 452 which forces the piston 452 out of and away from the housing 454 and toward the forwardly-facing end of the actuator chamber or housing 392 as illustrated by example in FIG. 7F, and such forward movement of the piston 452 carries the fixation member 457, and thus the actuator sleeve 396, along the elongated slots 394A, 394B as described above and as also illustrated in FIG. 7F. As further illustrated in FIGS. 7E and 7F, the web or tether 24 extends from fixation member 24A the around two web guides 395A, 395B, around the nose piece 458, and then secured to a securement member 393 mounted to the actuator chamber or housing 392. The web or tether 24 is thus anchored at one end to the cross-member 350E of the top frame member 350A, and at an opposite end to the actuator chamber or housing 392 that is fixed to the bottom frame member 350B, and between the two anchored ends the web or tether 24 wraps at least partially about, and thus engages, the nose piece 458 of the actuator 450.

As described above, the seat base 20E is normally in the up or raised position (normal seating position) illustrated in FIGS. 7A, 7B, and 7E, and in this position the actuator 450 is in an unactuated or deactuated state such that the actuator sleeve 396 is in its most rearward position. As described above, with the actuator sleeve 396 in its most rearward position (illustrated by example in FIGS. 7A, 7B, 7D, and 7E), the fixation elements 405A, 405B are positioned within the flared sections 399A, 399B of the channels or slots 397A, 397B formed in the respective flanges 398A, 398B of the actuator sleeve 396, thus forcing the tongue members 408A of the movable frame components 404A, 404B into the slots 384A of the blast attenuation structures 380. The seat base 20E is thus normally in the blast attenuation or mitigation mode during normal operating conditions of the motor vehicle in which the seat base 20E and the seat 12 are mounted; i.e., during conditions in which no under-vehicle explosion is present, in which a rollover and/or impact of the motor vehicle is not occurring or imminent, wherein the latter two conditions are illustratively determined by the control circuit 26 based on signals produced by the sensor 30 as described above. In the blast attenuation or mitigation mode, the blast attenuation structures 380 are engaged as just described.

In the event of an under-vehicle explosion, the blast attenuation structures 380 are configured to deform in a manner which absorbs energy from the explosion as briefly described above. As illustrated by example in FIG. 7J, in response to an under-vehicle explosion, blast forces FB acting upwardly against the bottom frame assembly 350B and occupant forces FO acting downwardly against the top frame assembly 350A will force the top and top and bottom frame assemblies 350A, 350B toward one another, thereby causing the scissor pairs 392A, 392B and 394A, 394B to likewise collapse and compress and, in turn, move the fixation members 442A, 442B along the slots 384B, 384B toward and into engagement with the tapered portions 386, 388 so as to absorb energy from the blast as described above. The amount or degree of deformation of the blast attenuation structures 380 and resultant compression of the seat base 20E will generally depend on, and thus be a function of, a number of factors as also described above. In the example depicted in FIG. 7J, the under-vehicle explosion resulted in full and complete compression of the seat base 20E, although it will be understood that other under-vehicle explosions may result a lesser amount of compression of the seat base 20E. It will be understood that whereas the example of FIG. 7J depicts uniform compression of the seat base 20E, this depiction is provided only by way of example, and some under-vehicle explosions, depending on their distance from and angle relative to the seat base 20E, may non-uniformly deform the blast attenuation structures 380. The structure and operation of the scissor structures 392A, 392B and 394A, 394B, with the inclusion of the stabilization plates 440, are intended mitigate any such non-uniform compression by forcing the two frame assemblies 350A, 350B of the seat base 20E to compress somewhat more uniformly. As also illustrated by example in FIG. 7J, the coiled spring 363B (one of two) further assists in pulldown of the seat base 20E during blast-related compression of the seat base 20E.

Referring now specifically to FIGS. 7A, 7B, and 7D-7I, reconfiguration of the seat base 20E from the blast attenuation or mitigation operating mode to the seat pulldown operating mode and subsequent operation of the seat base 20E during the seat pulldown operating mode is shown. With the seat base 20E in the blast attenuation or mitigation operating mode as just described, the control circuit 26 is continually operable to execute instructions stored in the memory unit 28 to monitor the signal(s) produced by the sensor 30. Upon detection of a sufficiently imminent rollover and/or vehicle impact event, the instructions stored in the memory unit 28 include instructions executable by the control circuit 26 to produce an activation signal to activate the seat pulldown device 22, i.e., to actuate the actuator 450 described above. Actuation, i.e., firing, of the actuator 450 forces the piston 452 outwardly and away from the housing 452, which causes the fixation member 457, and thus the actuator sleeve 396, to travel forwardly along the slots 394A, 394B. As the actuator sleeve 396 moves forwardly with the piston 452, the fixation elements 405A, 405B are forced out of the flared sections 399A, 399B and into and rearwardly along the linear portions of the channels or slots 397A, 397B. This, in turn, forces the tongue members 408A, 408B outwardly and away from the slots 384A of the blast attenuation structures 380, thereby disengaging the blast attenuation structures 380 from the frame member 420 of the bottom frame members 355A, 355B. The forward force of the nose piece 458 of the piston 452 acting on the web or tether 24 forces the scissor pairs 392A, 392B and 394A, 394B to collapse and, in turn, move the fixation members 442A, 442B along the slots 384B, 384B along the slots 422B, 432B and 422C, 422C of the bottom side frame assemblies 355A, 355B which draws the top frame assembly 350A downwardly toward and to the bottom frame assembly 350B, as illustrated in FIG. 7F.

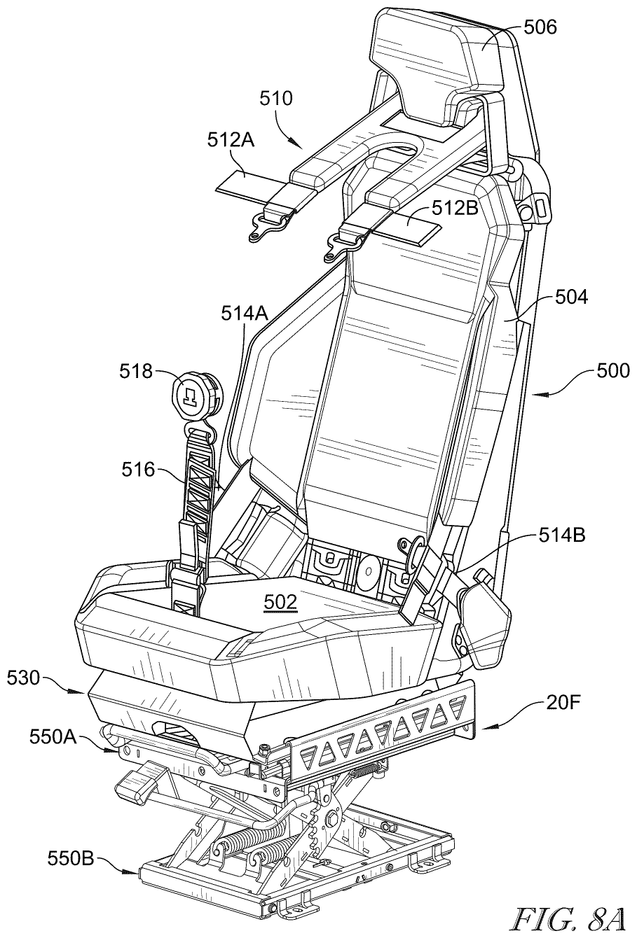

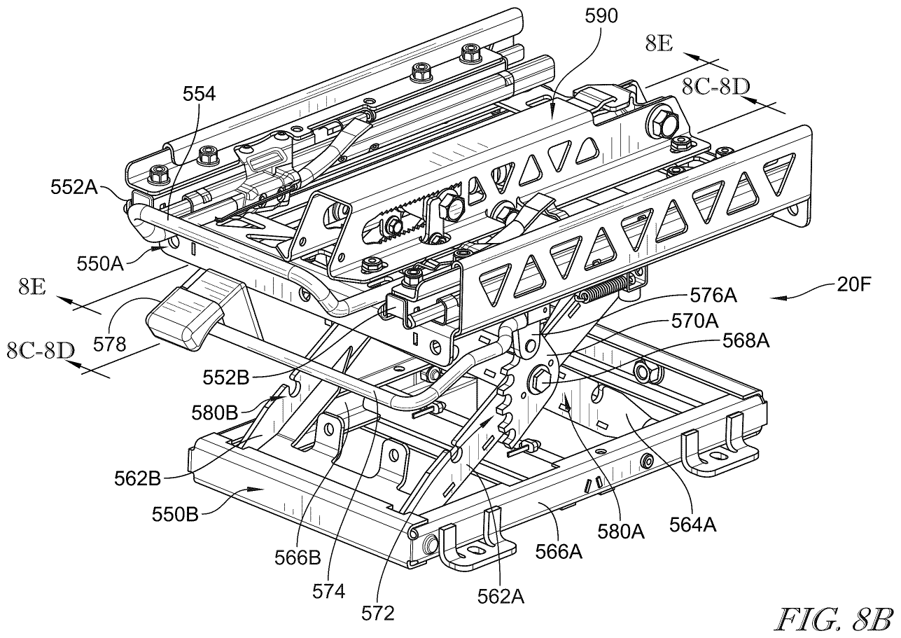

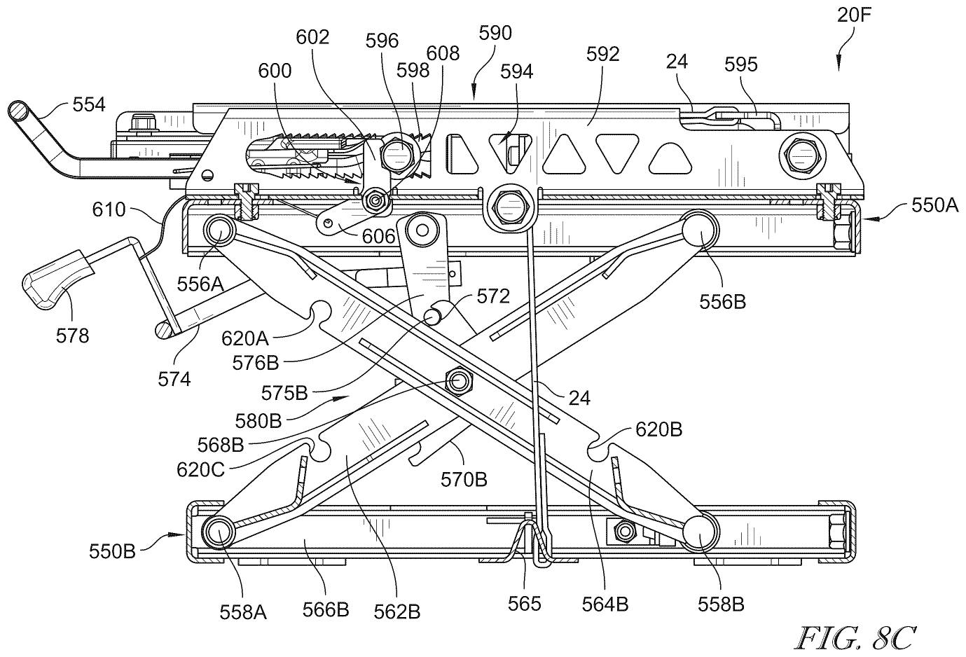

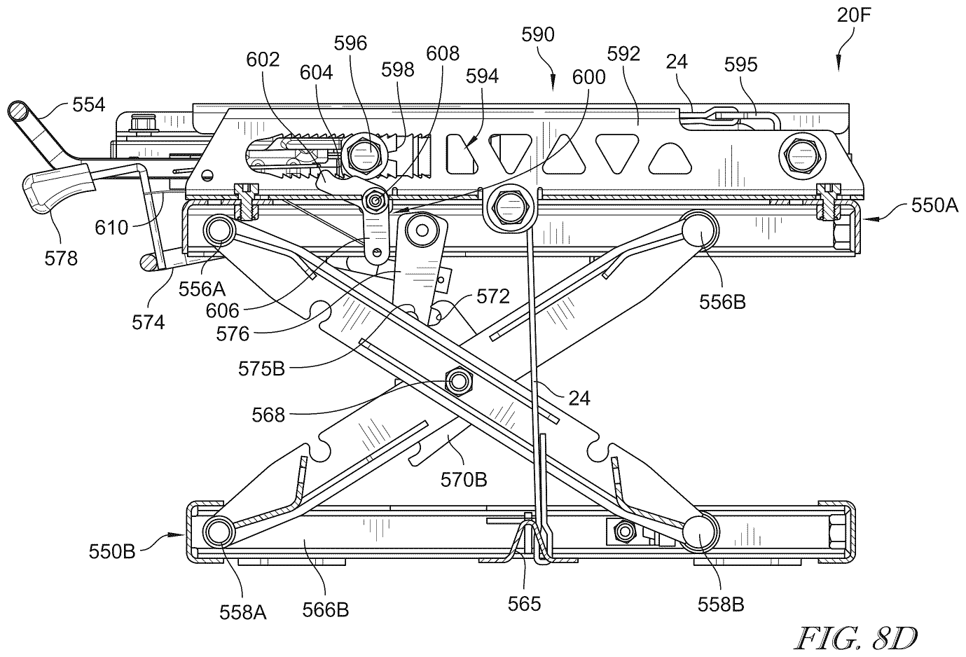

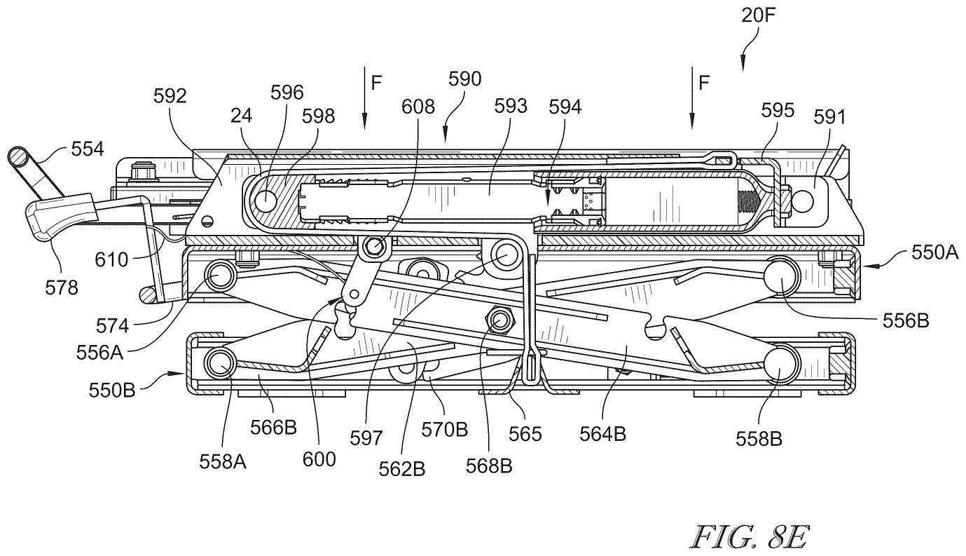

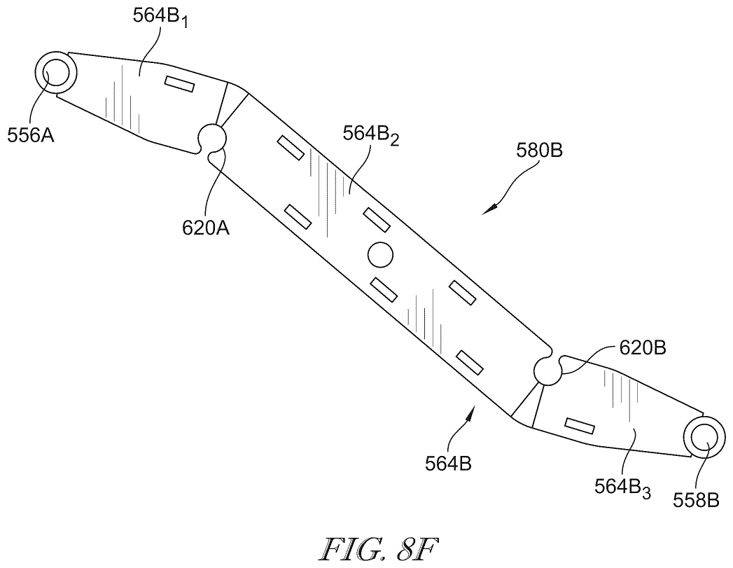

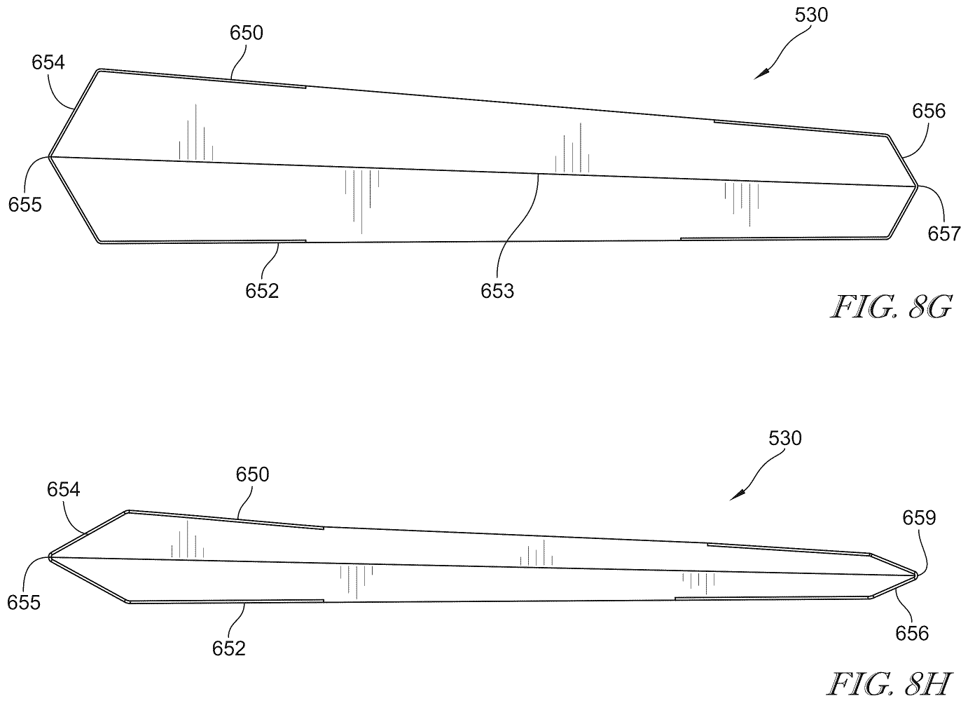

Referring now to FIGS. 8A-8H, still another embodiment 20F of the seat base 20 of FIGS. 1 and 2 is shown along with a vehicle seat 500 mounted thereto. In the illustrated embodiment, the seat base 20F incorporates a conventional fore and aft adjustment assembly as well as a conventional seat height adjustment assembly. With the inclusion of such assemblies the seat base 20F may, in some embodiments, be unable to be compressed sufficiently under blast conditions described above, and in some embodiments an energy-absorbing, crushable or deformable seat pan 530 may be positioned between the seat base 20F and the vehicle seat 500 as illustrated by example in FIG. 8A. In some alternate embodiments, the crushable or deformable seat pan 530 may be omitted.

In the example illustrated in FIG. 8A, the vehicle seat 500 is shown mounted to the seat pan 530 which is, in turn, mounted to a top frame assembly 550A of the seat base 20F. The vehicle seat 500 is illustratively conventional, and includes a seat bottom 502 mounted to the seat pan 530 (or directly to the top frame assembly 550A of the seat base 20F in embodiments in which the seat pan 530 is omitted). A seat back 504 is mounted to and extends upwardly away from the seat bottom 502, and in some embodiments a headrest 506 extends upwardly away from, or is integral with, the top of the seat back 504. An occupant restraint harness is secured to the vehicle seat 500, and in the example embodiment illustrated in FIG. 8A the occupant restraint system illustratively includes a pair of shoulder webs 512A, 512A extending through (or over) the seat back 504, a pair of lap webs 514A, 514B operatively coupled to the seat 500, a center web 516 mounted centrally to a forward position on the seat bottom 502, and a releasable connector 518 configured to releasably engage conventional connectors mounted to each of the webs 512A, 512B, 514A, 514B. In some embodiments, the shoulder webs 512A, 512B may extend through a collar 510 positioned near the headrest 506. The collar 510 is illustratively not fixed or otherwise attached to the vehicle seat 500, but instead is movable axially along the shoulder webs 512A, 512B. In some embodiments, the collar 510 illustratively includes one or more deployable and inflatable air bladders. An example embodiment of such a collar 510 is disclosed in co-pending U.S. Patent Application Pub. No. US2024/0294135A1, the disclosure of which is incorporated herein by reference in its entirety. While not specifically shown in FIG. 8A, it will be understood that the seat 500 may further include one or any combination of additional and conventional deployable or activatable occupant restraint features.

Referring now specifically to FIGS. 8A and 8B, the seat base 20F illustratively includes a bottom frame assembly 550B operatively coupled to the top frame assembly 550A via a pair of scissor arms 562A, 564A on one side of the seat base 20F, and a pair of scissor arms 562B, 564B on an opposite side of the seat base 20F. The scissor arms 562A, 562B, 564A, 564B illustratively have conventional rollers mounted at opposite ends thereof, and the side frame members of the top and bottom frame assemblies define respective conventional channels along which the rollers travel as the scissor arms 562A, 562B, 564A, 564B move up and down to increase and decrease the height of the top frame assembly 550A relative to the bottom frame assembly 550B. By way of example, rollers 556A and 556B are shown in FIGS. 80-8E mounted to opposite ends of the scissor arm 564B, and rollers 558A and 558B are likewise shown mounted to opposite ends of the scissor arm 562B. The bottom side frame members 566A, 566B define channels configured to receive and guide movement of the rollers 558A, 558B, as illustrated by the channels defined by the bottom side frame member 556B in FIGS. 8B-8E. The top side frame members similarly define channels configured to receive and guide movement of the rollers 556A, 556B, as also illustrated in FIGS. 8B-8E. In some embodiments, one or more of the rollers 556A, 556B, 558A, 558B may alternatively be slidable structures configured to slide rather than roll along the respective channels.

The top frame assembly 550A includes conventional sliding rails 552A, 552B operatively coupled to an articulating lever or handle 554, e.g., movable upwardly from a biased, lower position, which together form the conventional fore and aft adjustment assembly for movably adjusting, in a conventional manner, the fore/aft position of the vehicle seat 500 relative to the seat base 20F. The height adjustment assembly illustratively includes a height adjustment plate 570A mounted via a fixation member 568A to the scissor arms 562A, 564A at an intersection thereof, such that the scissor arms 562A, 564A both pivot about the fixation member 568A and the height adjustment plate 570A moves upwardly and downwardly with the fixation member 568A in response to movement of the scissor arms 562A, 564A. Illustratively, the height adjustment plate 570A defines a number of spaced apart teeth along the forwardly-facing surface thereof and grooves or channels 572 between adjacent teeth. One end of an articulating handle 574, e.g., movable upwardly from a biased, lower position, is mounted to a height adjustment lever 576A that is pivotably mounted to the top frame assembly 550A. A set pin 575A extends from or through the height adjustment lever 576A, and is sized to be selectively received within one of the grooves or channels 572 of the height adjustment lever 576A to set the height of the top seat frame 550A relative to the bottom seat frame 550B.

Another height adjustment plate 570B is mounted via a fixation member 568B to the scissor arms 562B, 564B at an intersection thereof, such that the scissor arms 562B, 564B both pivot about the fixation member 568B and the height adjustment plate 570B moves upwardly and downwardly with the fixation member 568B in response to movement of the scissor arms 562B, 564B. Illustratively, the height adjustment plate 570A defines a number of spaced apart teeth along the forwardly-facing surface thereof and grooves or channels 572 between adjacent teeth. An opposite end of the articulating handle 574 is mounted to another height adjustment lever 576B that is pivotably mounted to the top frame assembly 550A on an opposite side of the top frame assembly 550A to which the height adjustment lever 576A is mounted. A set pin 575B extends from or through the height adjustment lever 576B, and is sized to be selectively received within one of the grooves or channels 572 of the height adjustment lever 576B to set the height of the top seat frame 550A relative to the bottom seat frame 550B. Illustratively, a grab handle 578 is mounted to the handle 574 and oriented to provide for access by an occupant of the seat 500. Upward force applied to the grab handle 578 moves the handle 574 upwardly, thereby forcing the set pins 575A, 575B out and away from the grooves 572 and allowing the scissor arms 562A, 562B, 564A, 564B to freely move to set the height of the top frame assembly 550A relative to the bottom frame assembly 550B. At a suitably acceptable height of the top frame assembly 550A relative to the bottom frame assembly 550B, the grab handle 578 is released, which lowers the handle 574 and guides the set pins 575A, 575B into respective grooves of the height adjustment levers 576A, 576B with which they are aligned. Illustratively, biasing members, e.g., springs, bias the handle to the lower position. The fore and aft and height adjustment assemblies described thus far are conventional.

The seat base 20F illustratively includes a mode control assembly 590 similar in structure and function to the mode control assembly 390 illustrated in FIGS. 7A-7J and described above. For example, an actuator chamber or housing 592 is mounted to the top frame member 550A, e.g., via at least one fixation member 597, and to which an actuator 594 is operatively mounted. The actuator 594, like the actuator 450 of the embodiment illustrated in FIGS. 7A-7J and described above, forms part of the seat pulldown device 22 illustrated in FIGS. 1-6J and described above. In one embodiment, the actuator 594 is provided in the form of a pyrotechnic linear actuator controllable as described above, although in alternate embodiments the actuator 594 may be non-pyrotechnic and/or non-linear, also as described above. Like the actuator 450 described above, the actuator 594 includes a piston 593 positioned within a housing, and a nose piece 598 mounted to a front end of the piston 593, wherein the nose piece 598 illustratively carries the pyrotechnic actuating structure. A fixation member 596 extends through slots in the actuator chamber or housing 592 and through the nose piece 598, wherein, upon actuation of the actuator 594, the fixation member 596 moves with the piston 593 toward the front end of the actuator chamber or housing 592 as described above. A bracket 595 is attached to a rear portion of the piston housing, and the respective end 591 of the piston housing is secured to the actuator chamber or housing 592. One end of a web or tether 24 extends forwardly from the bracket 595, wraps around the nose piece 598, and is then guided over and by the fixation member 597 where an opposite end of the web or tether 24 is attached to an anchor structure 565 secured to the bottom frame member 550B. The web or tether 24 is thus attached to and between the top frame member 550A and the bottom frame member 550B, and between the two ends the web or tether engages the nose piece 598 of the piston 593.

The mode control assembly 590 further illustratively includes height adjustment release lever 600 controllable, in the seat pulldown mode, by movement of the piston 593 to articulate the seat height adjustment handle 574 so as to draw the set pins 575A, 575B outwardly away from the grooves 572 of the height adjustment plates 570A, 570B to allow the top seat frame assembly to be pulled down toward and to the bottom seat frame assembly 550B. The height adjustment release lever 600 is illustratively a generally L-shaped body rotatably mounted to the top frame assembly 550A by a fixation member 568 extending through release lever body 600 at the junction of two arms 602, 606 each extending away from the junction to form an angle between the two arms 602, 606. In the illustrated embodiment, the angle formed between the two arms 602, 606 is an obtuse angle, e.g., approximately 110 degrees, although in alternate embodiments the angle may be any angle, acute, obtuse, or right angle, without limitation. A notch 604 is formed at the free end of the arm 602 and is shaped complementarily to the fixation element 596 to as to form a mating engagement between the two structures. One end of a tether 610 is attached to the free end of the arm 606, and an opposite end of the tether 610 is attached to the grab handle 578 or to the articulating handle 574.

Blast attenuation structures 580A, 580B of the seat base 20F are illustratively provided in the form of cutouts formed along edges of the scissor arms 562A, 562B, 564A, 564B. As best seen in FIG. 8D, for example, a downwardly-facing cutout 620A is formed in the downwardly-facing edge of the scissor arm 564B between the roller 556A and the fixation member 568B, and an upwardly-facing cutout is formed in the upwardly-facing edge of the scissor arm 564B between the roller 558B and the fixation member 568B. Another upwardly-facing cutout 620C is illustratively formed in the upwardly-facing edge of the scissor arm 562B between the roller 558A and the fixation member 568B. The scissor arms 562A, 564A illustratively define identical cutouts as just described.

The seat base 20F is normally in the up or raised position (normal seating position) illustrated in FIGS. 8A-8D, and in this position the actuator 594 is in an unactuated or deactuated state such that the height adjustment release lever 600 is likewise in the unactuated state with the notch 604 formed in the arm 602 of the height adjustment release lever 600 in contact with the fixation member 596, as illustrated by example in FIGS. 8B and 8C. In this position, the height adjustment release lever 600 does not exert an actuating force on the articulating handle 574 or on the grab handle 578 via the tether 610, and the height of the top seat frame assembly 550A relative to the bottom seat frame assembly 550B is thus fixed by engagement of the set pins 575A, 575B with respective grooves or channels 572 formed in the height adjustment plates 570A, 570B. The seat base 20F is thus normally in the blast attenuation or mitigation mode during normal operating conditions of the motor vehicle in which the seat base 20F and the seat 500 are mounted; i.e., during conditions in which no under-vehicle explosion is present, in which a rollover and/or impact of the motor vehicle is not occurring or imminent, wherein the latter two conditions are illustratively determined by the control circuit 26 based on signals produced by the sensor 30 as described above. In the blast attenuation or mitigation mode, the blast attenuation structures 580 are as illustrated in FIGS. 8C and 8D.

In the event of an under-vehicle explosion, the blast attenuation structures 580A, 580B are configured to deform in a manner which absorbs energy from the explosion. As illustrated by example in FIG. 7J, in response to an under-vehicle explosion, blast forces FB acting upwardly against the bottom frame assembly 350B and occupant forces FO acting downwardly against the top frame assembly 350A, blast forces FB and occupant forces FO acting against the bottom and top frame assemblies 550B, 550A respectively will force the top and top and bottom frame assemblies 550A, 550B toward one another, thereby causing the scissor arms 562A, 562B and 564A, 564B to deform and compress, as illustrated by the scissor arm 564B illustrated in FIG. 8F, so as to absorb energy from the blast as described above. In the example illustrated in FIG. 8F, deformation of the cutouts 620A, 620B, and 620C cause the scissor arm 564B to deform into a modified S-shape between the sections 564B1, 564B2, and 564B3. In embodiments which include the collapsible seat pan 530 illustrated by example in FIG. 8A, blast and occupant forces FB and FO also act on the seat pan 530 to collapse the top 650 and bottom portions toward one another by folding the sides, front 654, and rear 656 along preformed fold lines 653, 655, 657, as illustrated by example in FIGS. 8G and 8H.

The amount or degree of deformation of the blast attenuation structures 580 and resultant compression of the seat base 20F will generally depend on, and thus be a function of, a number of factors as also described above. In some embodiments, the seat pan 530 may be included to provide for additional compression.

Referring now specifically to FIGS. 8C-8E, reconfiguration of the seat base 20F from the blast attenuation or mitigation operating mode to the seat pulldown operating mode and subsequent operation of the seat base 20F during the seat pulldown operating mode is shown. With the seat base 20F in the blast attenuation or mitigation operating mode as just described, the control circuit 26 is continually operable to execute instructions stored in the memory unit 28 to monitor the signal(s) produced by the sensor 30. Upon detection of a sufficiently imminent rollover and/or vehicle impact event, the instructions stored in the memory unit 28 include instructions executable by the control circuit 26 to produce an activation signal to activate the seat pulldown device 22, i.e., to actuate the actuator 594 described above. Actuation, i.e., firing, of the actuator 594 forces the piston 593 outwardly and away from the piston housing, which causes the fixation member 596 to travel forwardly along the slots formed in the actuator chamber or housing 592. As the piston 593 moves forwardly, the fixation member 596 forces the arm 602 of the height adjustment release lever downwardly, as best seen in FIG. 8D. Resultant rotation of the height adjustment release lever 600 causes the arm 606 to apply an upward force via the tether 610 to the articulating handle 574 or grab handle 578 that is sufficient to draw the set pins 575A, 575B outwardly away from the respective grooves or channels 572 of the height adjustment plates 570A, 570B. With the set pins 575A, 575B released, continued forward force of the nose piece 598 of the piston 593 acting on the web or tether 24 forces the scissor arms 562A, 562B, 564A, 564B to collapse which draws the top frame assembly 550A downwardly toward and to the bottom frame assembly 550B, as illustrated by example in FIG. 8E.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A seat base for mounting a vehicle seat to a floor of a motor vehicle, the seat base comprising:
a top member or frame assembly configured to be coupled directly or indirectly to the vehicle seat,
a bottom member or frame assembly configured to be coupled directly or indirectly to the floor of the motor vehicle,
at least one blast attenuation structure coupled to and between the top and bottom members or frame assemblies, the at least one blast attenuation structure configured to be responsive to an under-vehicle explosion to deform and collapse at least one of the top and bottom members or frame assemblies toward the other,
a seat pulldown device configured to be responsive to an activation signal to apply a force to the top member or frame assembly in a direction toward the bottom member or frame assembly, and
means responsive to the force applied by the seat pulldown device to disable or bypass the at least one blast attenuation structure so that the force applied by the seat pulldown device pulls the top member or frame assembly toward the bottom member or frame assembly.

2. The seat base of claim 1, wherein the at least one blast attenuation structure comprises two or more blast attenuation structures.

3. The seat base of claim 1, wherein the seat pulldown device comprises:
at least one actuator, and
at least one web or tether having one end secured to the top member or frame assembly, and an opposite end secured to at least one of the at least one actuator and the bottom member or frame assembly,
wherein the at least one actuator is responsive to the activation signal to cause the at least one web or tether to apply the force of the seat pulldown device.

4. The seat base of claim 3, further comprising means for producing the activation signal.

5. The seat base of claim 4, further comprising at least one sensor mounted to the motor vehicle,
wherein the means for producing the activation signal is configured to responsive to a sensor signal produced by the at least one sensor to produce the activation signal.

6. The seat base of claim 1, wherein the vehicle seat includes a height adjustment assembly configured to be responsive to manual actuation to fix a height of the top member or frame assembly relative to the bottom member or frame assembly,
and wherein the means responsive to the force applied by the seat pulldown device to disable or bypass the at least one blast attenuation structure is applied to disengage the height adjustment assembly so that the top member or frame assembly is movable toward the bottom member or frame assembly.

7. A seat base for mounting a vehicle seat to a floor of a motor vehicle, the seat base comprising:
a top frame assembly configured to be coupled directly or indirectly to the vehicle seat,
a bottom frame assembly configured to be coupled directly or indirectly to the floor of the motor vehicle,
at least one blast attenuation structure coupled to and between the top and bottom frame assemblies, the at least one blast attenuation structure configured to be responsive to an under-vehicle explosion to deform and collapse at least one of the top and bottom frame assemblies toward the other,
at least one web or tether having one end secured to the top frame assembly and an opposite end secured to the bottom frame assembly,
an actuator configured to be responsive to an activation signal to apply a force to the at least one web or tether between the one end and the opposite end of the at least one web or tether, and
a control assembly responsive to the force applied by the actuator to disable or bypass the at least one blast attenuation structure so that the force applied by the actuator to the at least one web or tether pulls the top frame assembly toward the bottom frame assembly.

8. The seat base of claim 7, further comprising means for producing the activation signal.

9. The seat base of claim 8, further comprising at least one sensor mounted to the motor vehicle,
wherein the means for producing the activation signal is configured to responsive to a sensor signal produced by the at least one sensor to produce the activation signal.

10. The seat base of claim 7, wherein the actuator is a linear actuator.

11. The seat base of claim 8, wherein the actuator is a pyrotechnic actuator.

12. The seat base of claim 7, wherein the actuator comprises a piston responsive to the activation signal to move along a linear path and apply the force to the at least one web or tether,
and wherein control assembly comprises an actuator sleeve movable with the piston, and at least one movable frame component operatively coupled to the actuator sleeve,
and wherein, in an absence of the activation signal, the actuator sleeve positions the at least one movable frame component to enable the at least one blast attenuation structure to be responsive to an under-vehicle explosion to deform and collapse at least one of the top and bottom frame assemblies toward the other,
and wherein, upon movement of the piston in response to the activation signal, the actuator sleeve positions the at least one movable frame component to disable or bypass the at least one blast attenuation structure so that the force applied by the actuator to the at least one web or tether pulls the top frame assembly toward the bottom frame assembly.

13. The seat base of claim 12, wherein, in the absence of the activation signal, the actuator sleeve positions the at least one movable frame component to engage the at least one blast attenuation structure,
and wherein, upon movement of the piston in response to the activation signal, the actuator sleeve disengages the at least one movable frame component from the at least one blast attenuation structure.

14. The seat base of claim 7, further comprising scissor arms operatively coupled to and between the top frame assembly and the bottom frame assembly, the scissor arms actuatable to raise and lower the top frame assembly relative to the bottom frame assembly.

15. The seat base of claim 14, wherein the seat base is operable in a blast attenuation mode in which the scissor arms engage the at least one blast attenuation structure to allow the at least one blast attenuation structure to be responsive to an under-vehicle explosion to deform and collapse at least one of the top and bottom frame assemblies toward the other,
and wherein the seat base is operable in a seat pulldown mode in which the scissor arms disengage the at least one blast attenuation structure to disable or bypass the at least one blast attenuation structure so that the force applied by the actuator to the at least one web or tether pulls the top frame assembly toward the bottom frame assembly.

16. The seat base of claim 7, wherein the actuator comprises a piston responsive to the activation signal to move along a linear path and apply the force to the at least one web or tether,
and wherein the vehicle seat includes a height adjustment assembly configured to be responsive to manual actuation to fix a height of the top frame assembly relative to the bottom frame assembly,
and wherein control assembly comprises a height adjustment release lever movable with the piston,
and wherein, in an absence of the activation signal, height adjustment assembly maintains the height of the top frame assembly fixed relative to the bottom frame assembly so as to enable the at least one blast attenuation structure to be responsive to an under-vehicle explosion to deform and collapse at least one of the top and bottom frame assemblies toward the other,
and wherein, upon movement of the piston in response to the activation signal, the height adjustment release lever disengages the height adjustment assembly so that the top frame assembly is movable toward the bottom frame assembly under the force applied by the actuator to the at least one web or tether.

17. The seat base of claim 16, wherein the actuator is a pyrotechnic actuator.

18. The seat base of claim 16, further comprising scissor arms operatively coupled to and between the top frame assembly and the bottom frame assembly, the scissor arms actuatable to raise and lower the top frame assembly relative to the bottom frame assembly.

19. The seat base of claim 17, wherein the at least one blast attenuation structure is incorporated into the scissor arms.

20. The seat base of claim 19, wherein the seat base is operable in a blast attenuation mode in which the height adjustment assembly fixes the height of the top frame assembly relative to the bottom frame assembly to allow the at least one blast attenuation structure incorporated into the scissor arms to be responsive to an under-vehicle explosion to deform and collapse at least one of the top and bottom frame assemblies toward the other,
and wherein the seat base is operable in a seat pulldown mode in which the height adjustment assembly is disengaged to thereby disable or bypass the at least one blast attenuation structure incorporated into the scissor arms such that the force applied by the actuator to the at least one web or tether collapses the scissor arms and pulls the top frame assembly toward the bottom frame assembly.
